(19) United States
(12) Patent Application Publication
(10) Pub. No.: US 2011/0194698 A1
(43) Pub. Date: Aug. 11, 2011

(54) Key Sharing System

(76) Inventors: Tomoyuki Asano, Kanagawa (JP); Hye-won Park, Daejeon (KR)

(21) Appl. No.: 13/122,233

(22) PCT Filed: Oct. 21, 2009
(86) PCT No.: PCT/JP2009/068147

§ 371 Date: Apr. 27, 2011

(30) Foreign Application Priority Data
Oct. 22, 2008 (JP) 2008-272201

(51) Int. Cl. H04L 9/08

(52) U.S. Cl. 380/282

(57) ABSTRACT

When each apparatus generates session information needed for calculating a session key used in a simultaneous communication, an encrypting apparatus and a key processing apparatus according to the present invention causes each piece of session information to include a value dependent upon a private key unique to each apparatus, which is assigned to each apparatus in advance. Therefore, this provides protection against spoofing attempt by a member within a group.

### TECHNICAL FIELD

The present invention relates to an encrypting apparatus, a key processing apparatus, an encrypting method, a key processing method, a program, and a key sharing system.

### BACKGROUND ART

With the recent progress made in communication technology, simultaneous communication, e.g., telephone conference and chat, is often made between a plurality of participants. This communication may be sometimes made over a non-secure communication path such as the Internet. In such case, the contents of communication are usually encrypted to protect the contents of communication such as the contents of conference from being compromised by those other than the participants in the simultaneous communication.

One of the most common methods in cryptographic technology is a symmetrical-key cryptography in which a sender and a receiver share the same key called a common key, and the contents are encrypted and decrypted using this common key. Further, there is a Group Key Agreement (GKA) technique in which a plurality of entities (in particular, three or more entities) share the same key called a session key (for example, see non-patent Literatures 1 to 3 below.).

### CITATION LIST

### Non-Patent Literature

Non-Patent Literature 1: M. Burmester and Y. Desmedt, “A Secure and Efficient Conference Key Distribution Systems”, In Advances in Cryptology-EUROCRYPT '94, volume 950 of Lecture Notes in Computer Science, pages 275-286, Springer, May 1994.
Non-Patent Literature 2: L. Zhou, W. Susilo and Y. Mu, “Efficient ID-based Authenticated Group Key Agreement from Bilinear Pairings”, Mobile Ad-hoc and Sensor Networks-MSN 2006, LNCS 4325, pp. 521-532, Springer-Verlag, 2006.
Non-Patent Literature 3: C. Boyd and J. M. Gonzalez Nieto, “Round-optimal Contributory Conference Key Agreement”, PKC 2003, LNCS 2567, pp. 161-174, Springer, 2003.

### SUMMARY OF INVENTION

### Technical Problem

The method described in Non-Patent Literature 1 has a problem in that the amount of calculation performed by members of simultaneous communication increases. In the method described in Non-Patent Literature 2, the amount of calculation is less than that in the method described in Non-Patent Literature 1. However, the inventors of the present application have studied the method in detail, and have found that it is possible for the group members to spoof their identities in this method.

On the other hand, the inventors of the present application have studied Non-Patent Literature 2 and Non-Patent Literature 3, and have found that the methods described in Non-Patent Literature 2 and Non-Patent Literature 3 have a problem in that there is a possibility that a particular user in a group may be excluded from sharing a group key which is expected to be shared by members of a simultaneous communication.

Accordingly, the present invention is made in view of the above problems, and it is an object of the present invention to provide an encrypting apparatus, a key processing apparatus, an encrypting method, a key processing method, a program, and a key sharing system, which are novel and improved, and capable of further improving the security of the Group Key Agreement technique.

### Solution to Problem

According to an aspect of the present invention in order to achieve the above-mentioned object, there is provided an encrypting apparatus including: a parameter selection unit for selecting a parameter used for sharing a session key with another information processing apparatus with which a simultaneous communication, in which a message protected with the session key is exchanged, is performed after the session key is shared, wherein the parameter selection unit selects the parameter as a procedure for sharing the session key in the simultaneous communication; a member information generation unit for generating member information for transmitting the parameter used as a temporary key by a participating apparatus, i.e., an information processing apparatus participating in the simultaneous communication, by using the parameter selected by the parameter selection unit, a published parameter published in advance, a private key assigned to the encrypting apparatus in advance, and a public key assigned to the participating apparatus in advance; a session information generation unit for generating session information used for identifying the simultaneous communication and generating the session key for the simultaneous communication, by using the member information, the parameter selected by the parameter selection unit, the published parameter, and the private key; a session information obtaining unit for respectively obtaining other session information generated by the participating apparatus from the participating apparatus; and a session key generation unit for generating the session key by using the session information generated by the encrypting apparatus and the session information generated by the participating apparatus.

The parameter selection unit may select a parameter δε_{R}Z_{q}*, a parameter k₁ε_{R}Z_{q}*, and a parameter r having a predetermined number of bits.

The published parameter includes two groups G₁, G₂ of an order q which are different from each other, a bilinear map e for mapping a combination of elements in the group G₁ to the group G₂, a plurality of different hash functions, and two parameters P, P_{pub}, and the member information generation unit may respectively generate member information Pᵢ each corresponding to the participating apparatus according to Expression 1 below.

In Expression 1 below, H_{A} denotes one of the published hash functions, S₁ denotes the private key assigned to the encrypting apparatus, Qᵢ denotes a public key each assigned to the participating apparatus in advance, and i denotes an integer from 2 to n.

[Numerical expression 1]

Pᵢ=r|H_{A}(e(S₁,δQᵢ)) (Expression 1)

The session information generation unit may calculate a value X₁ represented by Expression 2 below and a value Y₁ represented by Expression 3, and generate session information D₁ represented by Expression 4 below:

In Expression 2 and Expression 3, H_{B} denotes one of the published hash functions, and wherein, in Expression 4, P₂ to Pₙ denote the member information corresponding to each participating apparatus, and L denotes information about correspondence between the member information P₂ to Pₙ and the participating apparatuses.

[Numerical expression 2]

X₁=H_{B}(r∥L)˜k₁P (Expression 2)=

Y₁=k₁P_{pub}+H_{B}(r∥L)·S₁ (Expression 3)

D₁= [symbol] δ,P₂, . . . Pₙ,X₁,Y₁,L [symbol] (Expression 4)

The encrypting apparatus further includes a member verification unit for verifying validity of an apparatus participating in the simultaneous communication by using the session information generated by the encrypting apparatus and each of the session information Dᵢ (i=2, n), represented by Expression 5, obtained from the participating apparatus, and the member verification unit may calculate a verification parameter z represented by Expression 6 below, and verify validity of the apparatus participating in the simultaneous communication based on whether Expression 7 below holds or not.

$$\begin{matrix}[ Numerical expression 3 ] & \\ \begin{matrix}{D}_{i} = 〈 {X}_{i} , {Y}_{i} 〉 \\ = 〈 {H}_{B} ( r \vert \vert L ) \cdot {k}_{i} P , {k}_{i} {P}_{pub} + {H}_{B} ( r \vert \vert L ) \cdot {S}_{i} 〉\end{matrix} & ( Expression 5 ) \\ z = {{H}_{B} ( r \vert \vert L )}^{- 1} \cdot {\sum }_{j = 1}^{n} {X}_{j} = {\sum }_{j = 1}^{n} {k}_{j} P & ( Expression 6 ) \\ e ( P , {\sum }_{j = 1}^{n} {Y}_{j} ) = e ( {P}_{pub} , z + {H}_{B} ( r \vert \vert L ) \cdot {\sum }_{j = 1}^{n} {Q}_{j} ) & ( Expression 7 )\end{matrix}$$

When Expression 7 holds, the member verification unit may determine that the participating apparatus is constituted by a valid apparatus, and accordingly, the session key generation unit may calculate session key K based on Expression 8 below. In Expression 8, H_{C} denotes one of the published hash functions.

[Numerical expression 4]

K=H_{C}(z) (Expression 8)

The published parameter includes two groups G₁, G₂ of an order q which are different from each other, a bilinear map e for mapping a combination of elements in the group G₁ to the group G₂, a plurality of different hash functions, and two parameters P, P_{pub}, the parameter selection unit may select a parameter δᵢε_{R}Z_{q}*; and a parameter kᵢε_{R}Z_{q}*, and a parameter rᵢ having a predetermined number of bits, and the member information generation unit may respectively generate the member information Pᵢ each corresponding to the participating apparatus according to Expression 9 below.

In Expression 9, H₂ denotes one of the published hash functions, Sᵢ denotes the private key assigned to the encrypting apparatus, and Qⱼ denotes a public key each assigned to the participating apparatus in advance.

[Numerical expression 5]

Pᵢ^{j}=H₂(e(Sᵢ,Qⱼ)·δᵢ)⊕rᵢ (Expression 9)

The session information generation unit may calculate a value Vᵢ represented by Expression 10 below and a value Wᵢ represented by Expression 11 below, and generate session information Dᵢ represented by Expression 12 below.

Each of H₃ in Expression 10 below and H₄ in Expression 11 below denotes one of the published hash functions, wherein in Expression 11 below, SIGᵢ(x) denotes a digital signature generated for information x using a predetermined signature generation key, and wherein in Expression 12 below, P₂ to Pₙ denote the member information corresponding to each participating apparatus, and L denotes information about correspondence between the member information and the participating apparatuses.

[Numerical expression 6]

Vᵢ=H₃(rᵢ)⊕kᵢ (Expression 10)

Wᵢ=SIGᵢ(H₄(kᵢ)) (Expression 11)

Dᵢ= [symbol] δᵢ,Pᵢ¹, . . . Pᵢⁱ⁻¹,Pᵢⁱ⁺¹, . . . , Pᵢⁿ,Vᵢ,Wᵢ,L [symbol] (Expression 12)

The encrypting apparatus further includes a member verification unit for verifying validity of an apparatus participating in the simultaneous communication by using the session information Dᵢ generated by the encrypting apparatus and each of the session information Dᵢ obtained from the participating apparatus, which are represented by Expression 12, the member verification unit may calculate a parameter kⱼ′(j=1, . . . n, j≠i) represented by Expression 13 below, and verify validity of the apparatus participating in the simultaneous communication based on the calculated parameter kⱼ′ and the session information Dᵢ.

[Numerical expression 7]

k′ⱼ=H₃(H₂(e(Qⱼ,Sᵢ)·δⱼ)⊕Pⱼⁱ)⊕Vⱼ (Expression 13)

When the member verification unit successfully verifies the validity of the apparatus, the session key generation unit may calculate session key K based on Expression 14 below.

[Numerical expression 8]

K=Kᵢ=k₁′⊕k₂′⊕ . . . kᵢ₋₁′kᵢ₊₁′⊕ . . . . ⊕kₙ′ (Expression 14)

The published parameter includes an encryption function E for encrypting predetermined information, a decryption function D for decrypting encrypted information, a signature generation function S for attaching a digital signature to predetermined information, a signature verification function V for verifying the digital signature, and hash functions, the parameter selection unit may select a parameter Nᵢ having a predetermined number of bits, and the session information generation unit may generate a message D having a digital signature represented by Expression 15 below and a cipher text E (eᵢ, N₁) (i=2, n).

In Expression 15 below, S(s, x) denotes a digital signature generated for information x using a predetermined signature generation key s, and E(e, x) denotes a cipher text obtained by encrypting the information x using the public key e.

[Numerical expression 9]

S(s₁,(E(e₂,N₁), . . . , E(eₙ,N₁),h(N₁))) (Expression 15)

The session key generation unit may calculate session key K_{U} based on Expression 16 below, by using a parameter Nᵢ having a predetermined number of bits obtained from another participating apparatus and a parameter N₁ selected by the parameter selection unit.

[Numerical expression 10]

K_{U}=h(N₁∥N₂∥ . . . ∥Nₙ) (Expression 16)

According to another aspect of the present invention in order to achieve the above-mentioned object, there is provided a key processing apparatus including: a session information obtaining unit for obtaining session information transmitted from an encrypting apparatus for transmitting a parameter used as a temporary key by a participating apparatus participating in a simultaneous communication, wherein the session information is used for generating a session key for the simultaneous communication and identifying the simultaneous communication which is performed with the encrypting apparatus after the session key is shared and in which a message protected with the session key is exchanged, and wherein the session information obtaining unit also obtains session information transmitted from another participating apparatus participating in the simultaneous communication, which is different from the session information transmitted from the encrypting apparatus; a temporary key calculation unit for calculating a temporary key by using the session information transmitted from the encrypting apparatus, a public key assigned to the encrypting apparatus in advance, and a private key assigned to the key processing apparatus in advance, and a published parameter published in advance, wherein the temporary key is set by the encrypting apparatus to be used in the simultaneous communication; a parameter selection unit for selecting a parameter used for calculating the session information generated by the key processing apparatus to be transmitted to the encrypting apparatus; a session information generation unit for generating the session information transmitted to the encrypting apparatus and the another participating apparatus, by using the parameter selected by the parameter selection unit, the published parameter, the private key, and the session information transmitted from the encrypting apparatus; and a session key generation unit for generating the session key by using the session information generated by the key processing apparatus, the session information transmitted from the encrypting apparatus, and the session information transmitted from the another participating apparatus.

The published parameter includes two groups G₁, G₂ of an order q which are different from each other, a bilinear map e for mapping a combination of elements in the group G₁ to the group G₂, a plurality of different hash functions, and two parameters P, P_{pub}, the session key obtaining unit may obtain the session information D₁ represented by Expression 17 below from the encrypting apparatus, and the temporary key calculation unit may calculate a temporary key r′ based on Expression 18 below, by using member information Pᵢ and a parameter δ corresponding to the encrypting apparatus included in the session information D₁ transmitted from the encrypting apparatus, the private key, and the public key assigned to the encrypting apparatus in advance, and the published parameter.

Each of H_{B} in Expression 17 and H_{A} in Expression 10 denotes one of the published hash functions.

[Numerical expression 11]

D₁= [symbol] δ,P₂, . . . Pₙ,H_{B}(r∥L)·k₁P,k₁P_{pub}+H_{B}(r∥L)·S₁,L [symbol] (Expression 17)

r′=H_{A}(e(Sᵢ,δQ₁))⊕P=r (Expression 18)

The session key generation unit may generate the session information Dᵢ represented by Expression 19 below. In Expression 19, kᵢ represents a parameter used for calculating the session information.

[Numerical expression 12]

Dⱼ= [symbol] Xᵢ,Yᵢ [symbol] [symbol] ₌ [symbol] _{H}_{B}(r∥L)·kᵢP,kᵢP_{pub}+H_{B}(r∥L)·Sᵢ [symbol] (Expression 19)

The session information obtaining unit may obtain the session information represented by Expression 19 from the another participating apparatus participating in the simultaneous communication, the key processing apparatus may further include a member verification unit for verifying validity of an apparatus participating in the simultaneous communication by using the session information generated by the key processing apparatus, the session information D₁ represented by Expression 17 obtained from the encrypting apparatus, and the session information obtained from the another participating apparatus, and the member verification unit may calculate a verification parameter z represented by Expression 20 below, and verify validity of the apparatus participating in the simultaneous communication based on whether Expression 21 below holds or not.

In Expression 20 and Expression 21, a variable n represents a summation of the number of encrypting apparatuses, the number of key processing apparatuses, and the number of other participating apparatuses.

$$\begin{matrix}[ Numerical expression 13 ] & \\ z = {{H}_{B} ( r \vert \vert L )}^{- 1} \cdot {\sum }_{j = 1}^{n} {X}_{j} = {\sum }_{j = 1}^{n} {k}_{j} P & ( Expression 20 ) \\ e ( P , {\sum }_{j = 1}^{n} {Y}_{j} ) = e ( {P}_{pub} , z + {H}_{B} ( r \vert \vert L ) \cdot {\sum }_{j = 1}^{n} {Q}_{j} ) & ( Expression 21 )\end{matrix}$$

When Expression 21 holds, the member verification unit may determine that the apparatus participating in the simultaneous communication is constituted by a valid apparatus, and accordingly, the session key generation unit may calculate session key K based on Expression 22 below. In Expression 22, H_{C} denotes one of the published hash functions.

[Numerical expression 14]

K=H_{C}(z) (Expression 22)

The published parameter includes an encryption function E for encrypting predetermined information, a decryption function D for decrypting encrypted information, a signature generation function S for attaching a digital signature to predetermined information, a signature verification function V for verifying the digital signature, and hash functions, the key processing apparatus may further include a member verification unit for verifying validity of the encrypting apparatus by using the session information represented by Expression 23 below obtained from the encrypting apparatus and the temporary key calculated by the temporary key calculation unit, the temporary key calculation unit may use the private key held in the key processing apparatus to decrypt a cipher text E (eᵢ, N₁) transmitted from the encrypting apparatus, and calculate a parameter N₁ as the temporary key, and the member verification unit may verify the encrypting apparatus based on a verification result of the digital signature attached to the session information represented by Expression 23 below and h(N₁) calculated using the hash functions and the parameter N₁.

In Expression 23, S(s, x) denotes a digital signature generated for information x using a predetermined signature generation key s, and E(e, x) denotes a cipher text obtained by encrypting the information x using the public key e.

[Numerical expression 15]

S(s₁,(E(e₂,N₁), . . . , E(eₙ,N₁),h(N₁))) (Expression 23),

When the member verification unit successfully verifies the validity of the apparatus, the parameter selection unit may select a parameter Nᵢ having a predetermined number of bits, and the session information generation unit may adopt the parameter Nᵢ selected by the parameter selection unit as the session information, and transmit the session information to the encrypting apparatus and the another participating apparatus.

The session key generation unit may calculate session key K_{U} based on Expression 24 below, by using the parameter N₁ calculated by the temporary key calculation unit, the parameter Nᵢ selected by the parameter selection unit, and the parameter Nᵢ obtained from the another participating apparatus.

[Numerical expression 16]

K_{U}=h(N₁∥N₂∥ . . . ∥Nₙ) (Expression 24)

According to still another aspect of the present invention in order to achieve the above-mentioned object, there is provided an encrypting method including the steps of selecting a parameter used for sharing a session key with another information processing apparatus with which a simultaneous communication, in which a message protected with the session key is exchanged, is performed after the session key is shared, wherein the parameter is selected as a procedure for sharing the session key in the simultaneous communication; generating member information for transmitting the parameter used as a temporary key by a participating apparatus, i.e., an information processing apparatus participating in the simultaneous communication, by using the parameter selected by the parameter selection unit, a published parameter published in advance, a private key assigned to an apparatus carrying out the encrypting method in advance, and a public key assigned to the participating apparatus in advance; generating session information used for identifying the simultaneous communication and generating the session key for the simultaneous communication, by using the member information, the parameter selected by the parameter selection unit, the published parameter, and the private key; obtaining other session information generated by the participating apparatus from the participating apparatus; and generating the session key by using the session information generated by the apparatus carrying out the encrypting method and the session information generated by the participating apparatus.

According to still another aspect of the present invention in order to achieve the above-mentioned object, there is provided a key processing method including the steps of obtaining session information transmitted from an encrypting apparatus for transmitting a parameter used as a temporary key by a participating apparatus participating in a simultaneous communication, wherein the session information is used for generating a session key for the simultaneous communication, and identifying the simultaneous communication, in which a message protected with the session key is exchanged, performed with the encrypting apparatus after the session key is shared; calculating a temporary key by using the session information transmitted from the encrypting apparatus, a public key assigned to the encrypting apparatus in advance, and a private key assigned to an apparatus carrying out the key processing method in advance, and a published parameter published in advance, wherein the temporary key is set by the encrypting apparatus to be used in the simultaneous communication; selecting a parameter used for calculating the session information generated by the apparatus carrying out the key processing method to be transmitted to the encrypting apparatus; session information generation step for generating the session information transmitted to the encrypting apparatus and the another participating apparatus, by using the selected parameter, the published parameter, the private key, and the session information transmitted from the encrypting apparatus; obtaining session information transmitted from another participating apparatus participating in the simultaneous communication, which is different from the session information transmitted from the encrypting apparatus; and generating the session key by using the session information generated by the apparatus carrying out the key processing method, the session information transmitted from the encrypting apparatus, and the session information transmitted from the another participating apparatus.

According to still another aspect of the present invention in order to achieve the above-mentioned object, there is provided a program for a computer capable of performing a simultaneous communication, in which a message protected with a session key is exchanged, with another information processing apparatus after the session key is shared, wherein the program causes the computer to achieve: a parameter selection function for selecting a parameter used for sharing the session key, wherein parameter selection function selects the parameter as a procedure for sharing the session key in the simultaneous communication; a member information generation function for generating member information for transmitting the parameter used as a temporary key by a participating apparatus, i.e., the information processing apparatus participating in the simultaneous communication, by using the parameter selected by the parameter selection unit, a published parameter published in advance, a private key assigned to the computer in advance, and a public key assigned to the participating apparatus in advance; a session information generation function for generating session information used for identifying the simultaneous communication and generating the session key for the simultaneous communication, by using the member information, the parameter selected by the parameter selection unit, the published parameter, and the private key; a session information obtaining function for respectively obtaining other session information generated by the participating apparatus from the participating apparatus; and a session key generation function for generating the session key by using the session information generated by the program and the session information generated by the participating apparatus.

According to still another aspect of the present invention in order to achieve the above-mentioned object, there is provided a program for a computer capable of performing a simultaneous communication, in which a message protected with a session key is exchanged, with an encrypting apparatus and another information processing apparatus after the session key is shared, wherein the program causes the computer to achieve: a session information obtaining function for obtaining session information transmitted from an encrypting apparatus for transmitting the parameter used as a temporary key by a participating apparatus participating in a simultaneous communication, wherein the session information is used for generating a session key for the simultaneous communication and identifying the simultaneous communication which is performed with the encrypting apparatus, and wherein the session information obtaining unit also obtains session information transmitted from another participating apparatus participating in the simultaneous communication, which is different from the session information transmitted from the encrypting apparatus; a temporary key calculation function for calculating a temporary key by using the session information transmitted from the encrypting apparatus, a public key assigned to the encrypting apparatus in advance, and a private key assigned in advance, and a published parameter published in advance, wherein the temporary key is set by the encrypting apparatus to be used in the simultaneous communication; a parameter selection function for selecting a parameter used for calculating the session information generated by the computer to be transmitted to the encrypting apparatus; a session information generation function for generating the session information transmitted to the encrypting apparatus and the another participating apparatus, by using the selected parameter, the published parameter, the private key, and the session information transmitted from the encrypting apparatus; and a session key generation function for generating the session key by using the session information generated by the computer, the session information transmitted from the encrypting apparatus, and the session information transmitted from the another participating apparatus.

In order to solve the above problems, according to still another aspect of the present invention, a key sharing system including the encrypting apparatus and the key processing apparatus is provided.

### Advantageous Effects of Invention

As described above, according to the present invention, security of Group Key Agreement technique can be further improved.

### BRIEF DESCRIPTION OF DRAWINGS

FIG. 1 is an explanatory diagram illustrating a key sharing system according to a first embodiment of the present invention.

FIG. 2 is a block diagram illustrating a configuration of a key generation apparatus according to the embodiment.

FIG. 3 is a block diagram illustrating a configuration of an encrypting apparatus according to the embodiment.

FIG. 4 is a block diagram illustrating a configuration of a key processing apparatus according to the embodiment.

FIG. 5 is a flow diagram illustrating a flow of a key generation method according to the embodiment.

FIG. 6 is a flow diagram illustrating session key generation processing according to the embodiment.

FIG. 7 is a flow diagram illustrating session key generation processing according to the embodiment.

FIG. 8 is a flow diagram illustrating session key generation processing according to the embodiment.

FIG. 9 is a block diagram illustrating a configuration of an encrypting apparatus according to a second embodiment of the present invention.

FIG. 10 is a block diagram illustrating a configuration of a key processing apparatus according to the embodiment.

FIG. 11 is a flow diagram illustrating session key generation processing according to the embodiment.

FIG. 12 is an explanatory diagram illustrating a key sharing system according to a third embodiment of the present invention.

FIG. 13 is a block diagram illustrating a configuration of a key processing apparatus according to the embodiment.

FIG. 14 is a block diagram illustrating a configuration of an encrypting apparatus according to the embodiment.

FIG. 15 is a flow diagram illustrating key generation processing according to the embodiment.

FIG. 16 is a flow diagram illustrating session key generation processing according to the embodiment.

FIG. 17 is a block diagram illustrating a hardware configuration of an encrypting apparatus according to each embodiment of the present invention.

FIG. 18 is a flow diagram illustrating key generation processing in the method described in Non-Patent Literature 2.

FIG. 19 is a flow diagram illustrating session key generation processing in the method described in Non-Patent Literature 2.

FIG. 20 is a flow diagram illustrating session key generation processing in the method described in Non-Patent Literature 2.

FIG. 21 is a flow diagram illustrating key generation processing in the second method described in Non-Patent Literature 2.

FIG. 22 is a flow diagram illustrating session key generation processing in the second method described in Non-Patent Literature 2.

FIG. 23 is a flow diagram illustrating session key generation processing in the method described in Non-Patent Literature 3.

### REFERENCE SIGNS LIST

1 key sharing system
3 communication network
10 key generation apparatus
11 member information management unit
13 parameter selection unit
15 published information generation unit
17 key generation unit
19 public key generation unit
21 private key generation unit
22 signature key generation unit
23 information providing unit
25 communication control unit
27 storage unit
100 encrypting apparatus
101, 201 individual key obtaining unit
103, 203 group key generation unit
105, 121, 131, 209, 229 parameter selection unit
107, 123, 133 member information generation unit
109, 125, 135, 211, 227 session information generation unit
111, 127, 137, 205, 221 session information obtaining unit
113, 139, 213, 225 member verification unit
115, 129, 141, 215, 231 session key generation unit
117, 217 communication control unit
119, 219 storage unit
200 key processing apparatus
207, 223 temporary key calculation unit

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

The following explanation will be made in the order listed below.

### (1) Purpose

Method described in Non-Patent Literature 1

Method described in Non-Patent Literature 2

Problems associated with the method described in Non-Patent Literature 2

Second method described in Non-Patent Literature 2

Method described in Non-Patent Literature 3

Problems associated with the second method described in Non-Patent Literature 2 and the method described in Non-Patent Literature 3

### (2) First Embodiment

(2-1) Key sharing system

(2-2) Configuration of key generation apparatus

(2-3) Configuration of encrypting apparatus

(2-4) Configuration of key processing apparatus

(2-5) Key generation method

(2-6) Method for generating session key

(2-7) The amount of calculation in the method for generating session key

### (3) Second Embodiment

(3-1) Configuration of encrypting apparatus

(3-2) Configuration of key processing apparatus

(3-3) Key generation method

(3-4) Method for generating session key

### (4) Third Embodiment

(4-1) Key sharing system

(4-2) Configuration of key generation apparatus

(4-3) Configuration of encrypting apparatus

(4-4) Method for generating session key

(5) Hardware configuration of encrypting apparatus and key processing apparatus according to each embodiment of the present invention

### (6) Conclusion

### (Purpose)

Before explaining an encrypting apparatus and a key processing apparatus according to the present invention, conventional Group Key Agreement technique will be explained first in order to explain the purpose of the present invention.

### <Method Described in Non-Patent Literature 1>

The method described in Non-Patent Literature 1 is a method for allowing n members (U₀, . . . Uₙ₋₁) to share a session key K using a broadcast communication path with the following protocol. The following protocol can be executed any number of times. It is considered that, before execution, the members agree to a system setup for defining prime numbers p and q having appropriate sizes and an original αεZₚ of an order q. It should be noted that, in the following protocol, the number i of each member is considered as mod n.

First, each member Uᵢ selects a parameter rᵢε_{R}Z_{q}, and broadcasts zᵢ calculated using the following expression 901 to the other members. It should be noted that aε_{R}Z means that an element a is randomly selected from a set Z.

[Numerical expression 17]

zᵢ=αⁿ^{₁} mod p (Expression 901)

Subsequently, each member Uᵢ uses zᵢ₊₁ and zᵢ₋₁ to calculate Xᵢ=(zᵢ₊₁/zᵢ₋₁)^{ri} mod p, and transmits the calculated Xᵢ to the members.

Subsequently, each member U₁ uses the following Expression 902 to calculate Kᵢ. With the above protocol, each member Uᵢ obtains Kᵢ. The relationship between the session key K and Kᵢ of each member is represented by Expression 903 below. Therefore, the members can share the session key K.

[Numerical expression 18]

Kᵢ=zᵢ₋₁^{nr}^{₁}Xᵢⁿ⁻¹Xᵢ₊₁ⁿ⁻² . . . Xᵢ₋₂ mod p (Expression 902)

K=Kᵢ=α^{r}^{₁}^{r}^{₂}^{+r}^{₂}^{r}^{₃}^{+ . . . +r}^{ₙ}^{r}^{₁} mod p (Expression 903)

However, in the method described in Non-Patent Literature 1, it is necessary to perform multiplication O(n²) times in the calculation of mod p in order to calculate Kᵢ. Therefore, there is a problem in that the amount of calculation of each member increases.

### <Method Described in Non-Patent Literature 2>

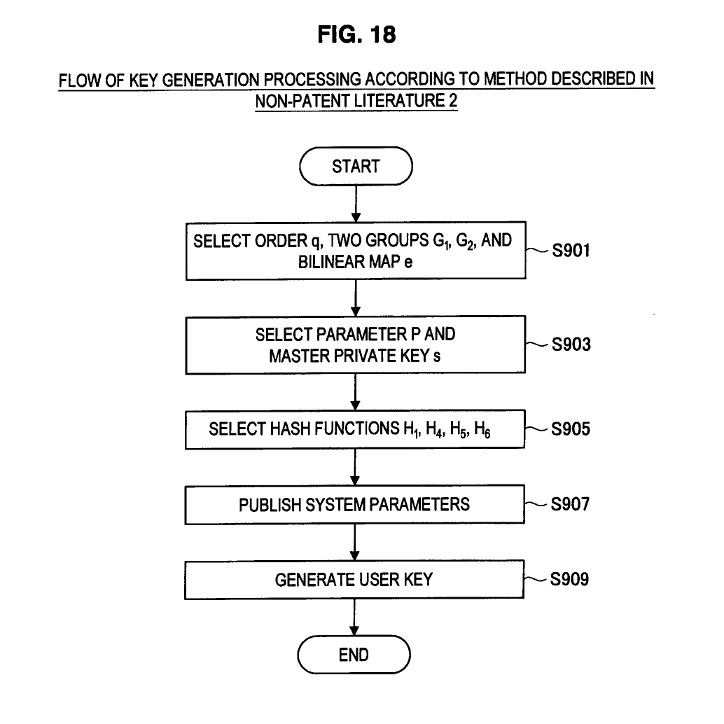

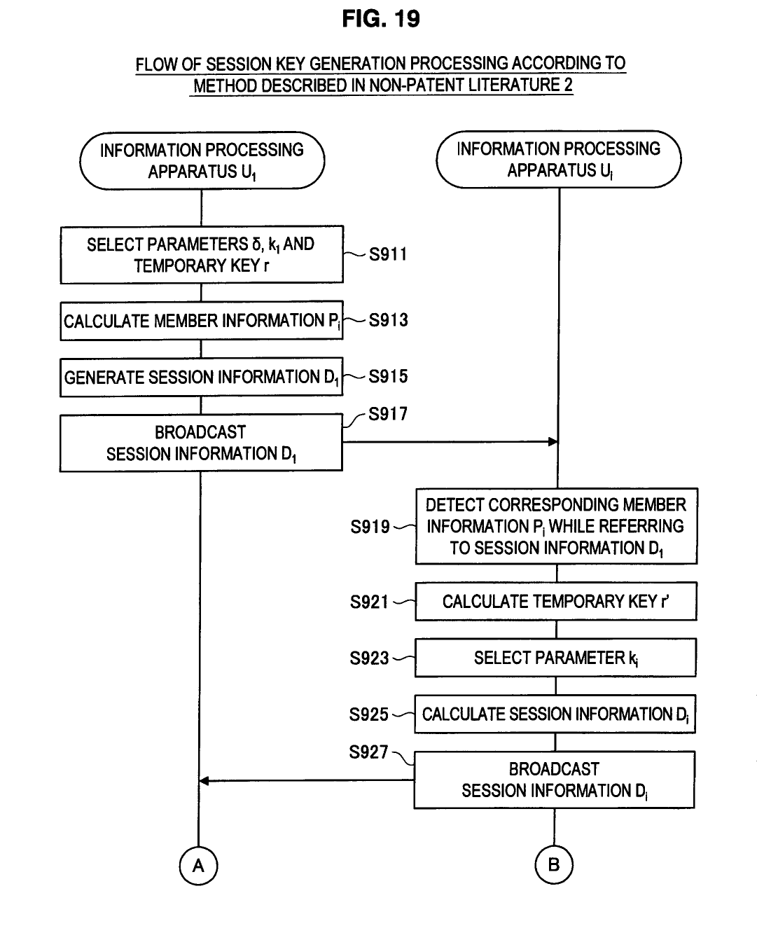

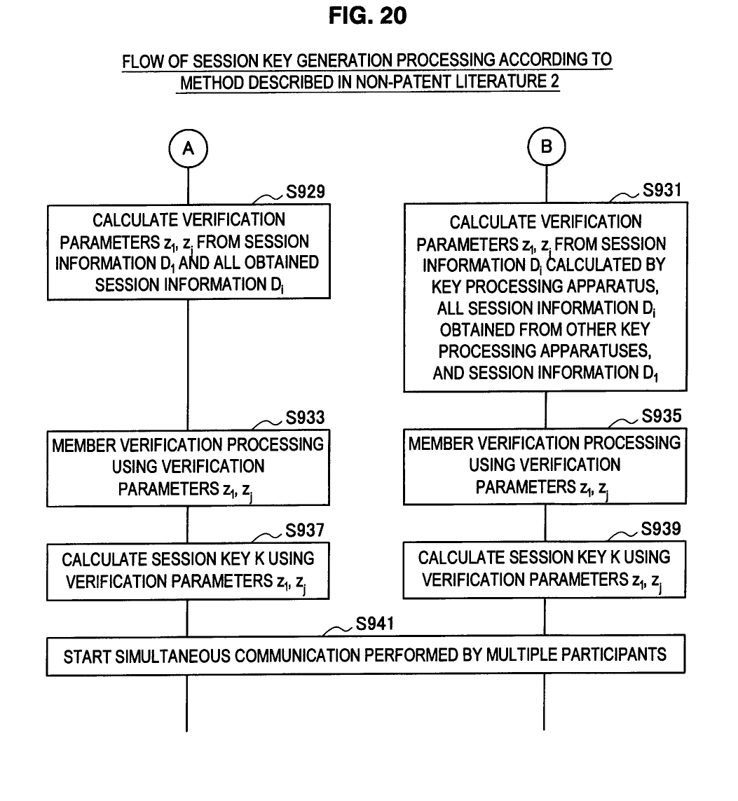

The method described in Non-Patent Literature 2 is a method relating to the Group Key Agreement for reducing the amount of calculation of each member. In the following explanation, the method described in Non-Patent Literature 2 will be explained in detail with reference to FIGS. 18 to 20. FIG. 18 is a flow diagram illustrating key generation processing in the method described in Non-Patent Literature 2. FIGS. 19 and 20 are flow diagrams illustrating session key generation processing in the method described in Non-Patent Literature 2.

The method described in Non-Patent Literature 2 uses a bilinear map technique. This bilinear map is represented as “e”. Bilinear map e:G₁×G₁→G₂ means that two sets of elements in a group G₁ of an order q are mapped to another group G₂ having the same order q. This mapping is characterized in having bilinear and nondegenerate properties.

1. Bilinear property: e(u^{a}, v^{b})=e(u, v)^{ab} is satisfied with respect to any give u, vεG₁, and a, bεZ_{q}*
2. Nondegenerate property: e(g, g)≠1 with respect to a generator g of G₁

### [Key Generation Processing]

In the method described in Non-Patent Literature 2, first, a center in a key sharing system generates various kinds of system parameters of this method and an individual key (i.e., a user key including a public key and a private key) for each member. Key generation processing performed by the center will be hereinafter explained in detail with reference to FIG. 18.

First, the center in the key sharing system selects an order q, two groups G₁, G₂ of the order q, and a bilinear map e, according to a predetermined method (step S901).

Subsequently, the center selects a parameter Pε_{R}G₁ and a parameter sε_{R}Z_{q}*; (step S903), and uses these parameters to calculate P_{pub}=sP. This parameter P may also be called a random generator. On the other hand, the parameter s is secretly saved as a master private key.

Subsequently, the center selects four kinds of hash functions, i.e., H₁, H₄, H₅, H₆ (step S905). These hash functions respectively have the following features.

### H₁: {0, 1}*→G₁

### H₄: G₂→{0, 1}ⁿ

H₅: {0, 1}ⁿ→Z_{q}*

### H₆: G₁→>{0, 1}ⁿ

Subsequently, the center publishes, as system parameters, some of various setting values generated in the above step that are allowed to be published (step S907). For example, the published system parameters include <e, G₁, G₂, q, P, P_{pub}/H₁, H₄, H₅, H₆>.

Subsequently, when the member Uᵢ having an ID (IDᵢ) for distinguishing the user such as a user ID number and a mail address joins this key sharing system, the center generates a public key Qᵢ and a private key Sᵢ of the user Uᵢ according to the following method (step S909).

public key Qᵢ=H₁(IDᵢ)
private key Sᵢ=sQᵢ

The center transmits the generated individual key (i.e., the public key Qᵢ and the private key Sᵢ) of the user Uᵢ to the corresponding user U. Further, the center can also publish the generated public key Qᵢ of the user Uᵢ.

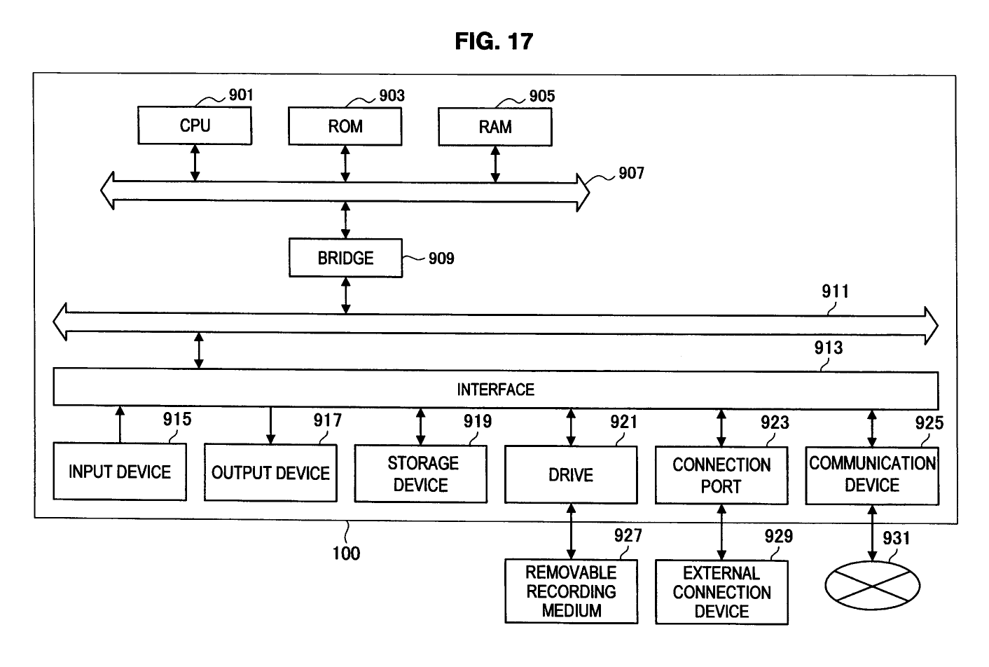

When a new user requests the center to generate an individual key, the center executes only step S909 as shown in FIG. 17, thereby generating a new individual key.

As described above, the public key Qᵢ of the user can be generated from the published ID of the user and the hash function H₁, i.e., a published parameter. Therefore, not only the center but also any user can calculate the public key Qᵢ. On the other hand, the private key Sᵢ of the user is generated using the master key s secretly stored in the center. Therefore, only the center can generate the private key Sᵢ.

When a plurality of information processing apparatuses try to execute simultaneous communication according to the method described in Non-Patent Literature 2, each of the information processing apparatuses generates a session key from the thus published system parameters and the public key and the private key of the user, and the information processing apparatuses share the generated session key used for the simultaneous communication according to the following method.

### [Method for Generating Session Key]

Subsequently, a method for generating a session key used during simultaneous communication between the plurality of information processing apparatuses will be explained in detail with reference to FIGS. 19 and 20. In the explanation below, it is assumed that totally n sets of information processing apparatuses try to achieve simultaneous communication therebetween. In the method described in Non-Patent Literature 2, any one of n members U₁, U₂, . . . , Uₙ is a protocol initiator (which may be hereinafter also referred to as an initiator). In the explanation below, the member U₁ is assumed to be the initiator for the sake of brevity.

### [Round 1]

First, the information processing apparatus owned by the member U₁ serving as the initiator selects a parameter δε_{R}G₂ and a parameter k₁ε_{R}Z_{q}*, i.e., parameters used in a simultaneous communication, in which messages protected by the session key are exchanged after the session key is shared (step S911). The information processing apparatus owned by the member U₁ also selects a parameter rε_{R}{0, 1}ⁿ (step S911). This parameter r is selected as a procedure for sharing the session key in the simultaneous communication.

Subsequently, the information processing apparatus owned by the member U₁ generates member information Pᵢ (i=2, . . . , n) for the members U₂ to Uₙ participating in the simultaneous communication, i.e., information for transmitting a parameter used as a temporary key to the apparatuses participating in the simultaneous communication (step S913). This member information Pᵢ is a value represented by the Expression 911 below. [Numerical expression 19]

Pᵢ=r⊕H₄(e(S₁,Qᵢ)·δ) (Expression 911)

In the above Expression 911, H₄ is one of the hash functions published as the system parameters, and e is the bilinear map published as the system parameter. In the above Expression 911, r and δ are parameters selected by the information processing apparatus owned by the member U₁. In the above Expression 911, S₁ is the private key assigned to the member U₁, and Qᵢ is the public keys assigned to the members U₂ to Uₙ participating in the simultaneous communication.

Subsequently, the information processing apparatus owned by the member U₁ uses the published system parameters and the selected parameters to calculate the following values X₁, Y₁. When the calculation of X₁, Y₁ is finished, the information processing apparatus owned by the member U₁ generates session information D₁ represented by Expression 914 below (step S915).

[Numerical expression 20]

X₁=H₅(r)·kᵢP (Expression 912)

Y₁=k₁P_{pub} (Expression 913)

D₁= [symbol] δ,P₂, . . . , Pₙ,X₁,Y₁,L [symbol] (Expression 914)

It should be noted that the information processing apparatus owned by the member U₁ calculates (n−1) pieces of Pᵢ according to Expression 911. For example, the member information corresponding to the member U₂ is not necessarily P₂. Accordingly, the information processing apparatus owned by the member U₁ attaches information L representing correspondence between each member and P₂ to Pₙ to the session information represented by Expression 914.

When the session information D₁ has been generated, the information processing apparatus owned by the member U₁ broadcasts the generated session information D₁ (step S917).

### [Round 2]

After the information processing apparatuses owned by the members U₂ to Uₙ receive the session information D₁, the information processing apparatuses first refers to the information L included in the session information D₁, and determines which of P₂ to Pₙ the member information of the information processing apparatus in question corresponds to (step S919).

Subsequently, each of the information processing apparatuses owned by the members U₂ to Uₙ calculates a temporary key r′ according to Expression 915 below using the member information Pᵢ of the information processing apparatus in question, the session information D₁, the public key Q₁ of the member U₁, i.e., the initiator, and the private key Sᵢ of the information processing apparatus in question (step S921). [Numerical expression 21]

r′=H₄(e(Q₁,Sᵢ)·δ)⊕Pᵢ (Expression 915)

In this case, when the session information D₁ is correctly generated by the member U₁, the temporary key r′ calculated by the information processing apparatuses owned by the members U₂ to Uₙ is equal to the temporary key r selected by the information processing apparatus owned by the member U₁. In other words, r′=r holds.

Subsequently, the information processing apparatuses owned by the members U₂ to Uₙ select a parameter kᵢε_{R}Z_{q}* (step S923). Thereafter, the information processing apparatuses owned by the members U₂ to Uₙ generate session information Dᵢ, which is transmitted to the information processing apparatus owned by the member U₁, according to Expression 916 below using the selected parameter the calculated temporary key r′, and the published system parameter (step S925). It should be noted that Expression 916 is formulated on the assumption that r′=r holds.

[Numerical expression 22]

Dᵢ= [symbol] Xᵢ,Yᵢ [symbol] [symbol] _{=<H}₅(r)·kᵢP,kᵢP_{pub} [symbol] (Expression 916)=

When the session information Dᵢ has been generated, each of the information processing apparatuses owned by the members U₂ to Uₙ broadcasts the generated session information Dᵢ to the information processing apparatuses other than the information processing apparatus in question (step S927).

### [Generation of Session Key]

The information processing apparatus owned by the member U₁ obtains all the transmitted session information Dᵢ from the information processing apparatuses owned by the members U₂ to Uₙ. As a result, the information processing apparatus obtains totally n pieces of session information, i.e., session information D₁ to Dₙ including the session information D₁ generated by the information processing apparatus owned by the member U₁. The information processing apparatus owned by the member U₁ uses the session information D₁ to Dₙ and the published system parameter to calculate parameters used for verification (hereinafter referred to as verification parameters) z₁ and zⱼ (step S929).

Likewise, each of the information processing apparatuses owned by the members U₂ to Uₙ obtains totally n pieces of session information, i.e., the session information D₁ to Dₙ, including the session information D₁ and the session information Dᵢ obtained from the information processing apparatuses owned by the members U₂ to Uₙ other than the member U₁. Each of the information processing apparatuses owned by the members U₂ to Uₙ uses the session information D₁ to Dₙ and the published system parameter to calculate the verification parameters z₁ and zⱼ (step S931).

[Numerical expression 23]

z₁=H₅(r)⁻¹·X₁=k₁P (Expression 917)

zⱼ=H₅(r)⁻¹·Xⱼ=kⱼP (Expression 918)

In Expression 918, 2≦j≦n holds.

Subsequently, the information processing apparatus owned by the member U₁ performs calculation using the calculated verification parameters z₁, zⱼ to determine whether Expression 919 below holds or not (step S933). Likewise, each of the information processing apparatuses owned by the members U₂ to Uₙ performs calculation using the calculated verification parameters z₁, zⱼ to determine whether Expression 919 below holds or not (step S935). When it is determined that Expression 919 holds, each of the information processing apparatuses determines that the n members who participated in to establish the session key K are all valid members. In other words, step S933 and step S935 in which a determination is made as to whether Expression 919 holds or not are steps for verifying the validity of the members.

$$\begin{matrix}[ Numerical expression 24 ] & \\ e ( P , {\sum }_{j = 1}^{n} {Y}_{j} ) = e ( {P}_{pub} , {\sum }_{j = 1}^{n} {z}_{j} ) & ( Expression 919 )\end{matrix}$$

Only when Expression 919 holds, the information processing apparatus owned by the member U₁ calculates the session key K according to Expression 920 below (step S937). Likewise, only when Expression 919 holds, each of the information processing apparatuses owned by the members U₂ to Uₙ calculates the session key K according to Expression 920 below (step S939).

[Numerical expression 25]

K=Kᵢ=H₆(z₁)⊕ . . . ⊕H₆(zₙ) (Expression 920)

Each of the information processing apparatuses can calculate the session key K. This means that the information processing apparatuses share the session key K used in the simultaneous communication, whereby the plurality of participants can start the simultaneous communication (step S941).

<Problems Associated with the Method Described in Non-Patent Literature 2>

As described above, the above method described in Non-Patent Literature 2 is a method for causing each member to verify, at a time, the broadcast messages transmitted from the members in [Round 2] in order to prevent any third party other than the members from accessing the session key K.

However, the inventors of the present application have thoroughly studied the above method described in Non-Patent Literature 2 in detail, and have found that it is possible for the group members to spoof their identities in the following case.

More specifically, the verification in [Round 2] in the method described in Non-Patent Literature 2 does not use any information unique to senders. Therefore, the inventors of the present application have conceived that a member who can obtain the value of the temporary key r transmitted from the initiator in [Round 1] can generate a value to slip through this verification.

Now, it is supposed that a member Uᵢ intentionally avoids participating in the above Group Key Agreement protocol, or fails to participate therein due to communication error and the like. In this case, the session information Dᵢ is not transmitted from the member Uᵢ, which makes it impossible to collect the session information for all of the n members. Therefore, the session key K is not expected to be established in this case.

In the above method, however, another member Uⱼ who can obtain the value r can disguise as the member Uᵢ to transmit session information Dᵢ other than the session information Dⱼ of the member Uⱼ. In other words, in the above method, the member uⱼ may abuse r′ generated by Expression 915 using the private key Sⱼ of the member Uⱼ to use the generated r′ for other calculations. In the calculation of the session information with Expression 916, session information can be freely calculated using the calculated temporary key and the published parameters. Therefore, when the parameter kⱼ is selected in step S923, another parameter kᵢ other than kⱼ may also be selected, so that two pieces of session information Dⱼ, Dᵢ can be obtained. As a result, even though the member Uᵢ is not actually participating, the members other than Uⱼ incorrectly recognizes that the session key is successfully shared by the n members including Uᵢ.

If the above situation occurs when a session key is generated during, e.g., an important conference, this has a significant impact. Therefore, it is an object of the method according to the first embodiment of the present invention to provide a more secure Group Key Agreement technique for preventing members from spoofing their identities, which may occur in the above method described in Non-Patent Literature 2.

### <Second Method Described in Non-Patent Literature 2>

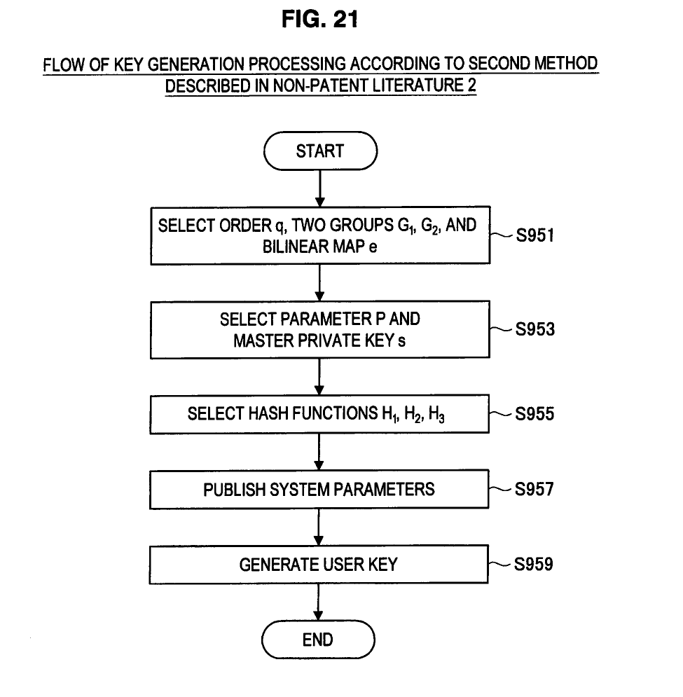

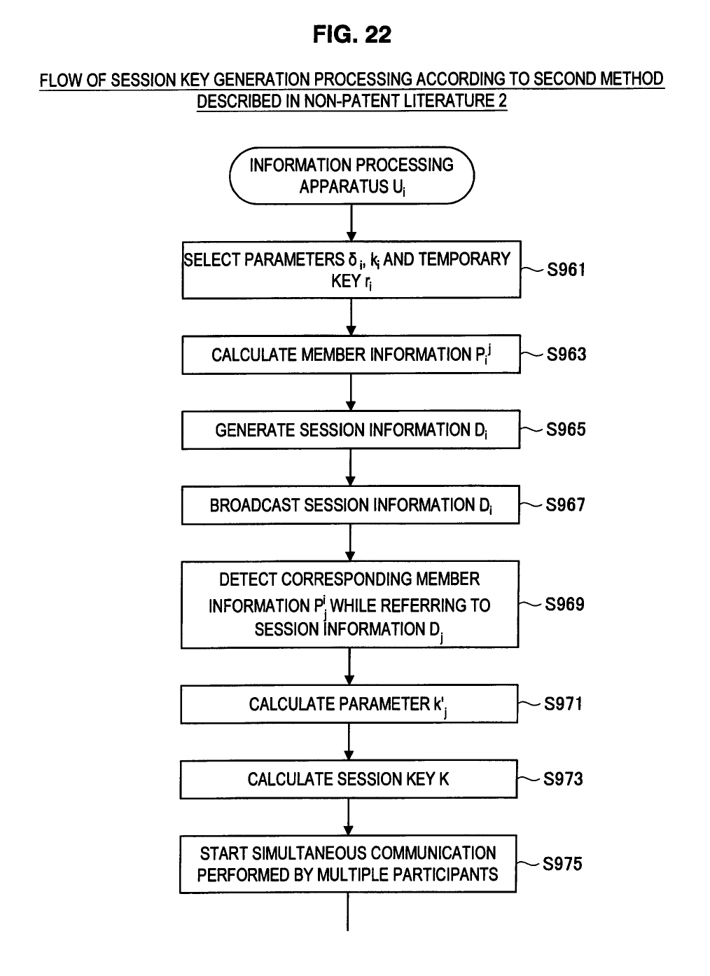

Non-Patent Literature 2 also describes not only the above method but also a second method as explained below. The second method described in Non-Patent Literature 2 will be hereinafter explained in detail with reference to FIGS. 21 and 22. FIG. 21 is a flow diagram illustrating key generation processing in the second method described in Non-Patent Literature 2. FIG. 22 is a flow diagram illustrating session key generation processing in the second method described in Non-Patent Literature 2.

### [Key Generation Processing]

In the second method described in Non-Patent Literature 2, a center in a key sharing system first generates various kinds of system parameters of this method and an individual key (i.e., a user key including a public key and a private key) for each member. Key generation processing performed by the center will be hereinafter explained in detail with reference to FIG. 21.

First, the center in the key sharing system selects an order q, two groups G₁, G₂ of the order q, and a bilinear map e, according to a predetermined method (step S951).

Subsequently, the center selects a parameter Pε_{R}G₁ and a parameter sε_{R}Z_{q}* (step S953), and uses these parameters to calculate P_{pub}=sP. This parameter P may also be called a random generator. On the other hand, the parameter s is secretly saved as a master private key.

Subsequently, the center selects three kinds of hash functions, i.e., H₁, H₂, H₃ (step S955). These hash functions respectively have the following features.

### H₁:{0, 1}*→G₁

### H₂:G₂→{0, 1}ⁿ

H₃:{0, 1}ⁿ→{0, 1}ⁿ

Subsequently, the center publishes, as system parameters, some of various setting values generated in the above step that are allowed to be published (step S957). For example, the published system parameters include <e, G₁, G₂, q, P, P_{pub}, H₁, H₂, H₃>.

Subsequently, when the member Uᵢ having an ID (IDᵢ) for distinguishing the user such as a user ID number and a mail address joins this key sharing system, the center generates a public key Qᵢ and a private key Sᵢ of the user Uᵢ according to the following method (step S959).

public key Qᵢ=H₁(IDᵢ)

private key Sᵢ=sQᵢ

The center transmits the generated individual key (i.e., the public key Qᵢ and the private key Sᵢ) of the user Uᵢ to the corresponding user Uᵢ. Further, the center can also publish the generated public key Qᵢ of the user Uᵢ.

When a new user requests the center to generate an individual key, the center executes only step S959 as shown in FIG. 20, thereby generating a new individual key.

As described above, the public key Qᵢ of the user can be generated from the published ID of the user and the hash function H₁, i.e., a published parameter. Therefore, not only the center but also any user can calculate the public key Qᵢ. On the other hand, the private key Sᵢ of the user is generated using the master key s secretly stored in the center. Therefore, only the center can generate the private key Sᵢ.

When a plurality of information processing apparatuses try to execute simultaneous communication using the second method described in Non-Patent Literature 2, each of the information processing apparatuses generates a session key from the thus published system parameters and the public key and the private key of the user, and the information processing apparatuses share the generated session key used for the simultaneous communication according to the following method.

### [Method for Generating Session Key]

Subsequently, a method for generating a session key used during simultaneous communication between the plurality of information processing apparatuses will be explained in detail with reference to FIG. 22. In the explanation below, it is assumed that totally n sets of information processing apparatuses try to achieve a simultaneous communication therebetween.

First, the information processing apparatus owned by each member Uᵢ selects a parameter δᵢε_{R}G₂ and a parameter kᵢε_{R}Z_{q}* (step S961). In this case, the parameter δᵢ is a parameter used for sharing the session key. On the other hand, the information processing apparatus owned by each member Uᵢ selects a parameter rᵢε_{R}{0, 1}ⁿ (step S961). This parameter rᵢ is selected as a procedure for sharing the session key in the simultaneous communication.

Subsequently, the information processing apparatus owned by each member Uᵢ generates member information Pᵢ^{j} for the members Uⱼ(1≦j≦n, j≠i) other than the member in question participating in the simultaneous communication, i.e., information for transmitting parameters used as temporary keys to the apparatuses participating in the simultaneous communication (step S963). This member information Pᵢ^{j} is a value represented by the Expression 921 below.

[Numerical expression 26]

Pᵢ^{j}=H₂(e(Sᵢ,Qⱼ)δᵢ)⊕rⱼ (Expression 921)

In the above Expression 921, H₂ is one of the hash functions published as the system parameters, and e is the bilinear map published as the system parameter. In the above Expression 921, rᵢ and δᵢ are parameters selected by the information processing apparatus owned by the member Uᵢ. In the above Expression 921, Sᵢ is the private key assigned to the member Uᵢ and Qⱼ is the public key assigned to the member Uⱼ participating in the simultaneous communication.

Subsequently, the information processing apparatus owned by each member Uᵢ calculates a value Vᵢ represented by Expression 922 using the published system parameters and the selected parameters. When Vᵢ has been calculated, the information processing apparatus owned by each member Uᵢ generates session information Dᵢ represented by Expression 923 below (step S965).

[Numerical expression 27]

Vᵢ=H₃(rᵢ)⊕kᵢ (Expression 922)

Dᵢ= [symbol] δ,Pᵢ¹, . . . , Pᵢⁱ⁻¹,Pᵢⁱ⁺¹, . . . , Pᵢⁿ,Vᵢ, L [symbol] (Expression 923)

It should be noted that the information processing apparatus owned by each member Uᵢ calculates (n−1) pieces of Pᵢ^{j} according to Expression 921. For example, the member information corresponding to the member U₂ is not necessarily Pᵢ². Accordingly, the information processing apparatus owned by each member Uᵢ attaches information L representing correspondence between each member and Pᵢ^{j} to the session information represented by Expression 923.

When the session information D₁ has been generated, the information processing apparatus owned by each member Uᵢ broadcasts the generated session information Dᵢ to the information processing apparatuses (step S967).

First, when the information processing apparatus owned by the member Uᵢ has received the session information Dⱼ(1≦j≦n, j≠i) from another information processing apparatus, the information processing apparatus owned by the member Uᵢ refers to the information L included in the session information Dⱼ to detect the member information Pⱼⁱ corresponding to the information processing apparatus owned by the member Uᵢ (step S969).

Subsequently, the information processing apparatus owned by each member Uᵢ calculates a parameter kⱼ′ according to Expression 924 below by using the member information Pⱼⁱ corresponding to the information processing apparatus owned by the member Uᵢ, the session information Dⱼ, and the public key Qⱼ of the member Uⱼ, and the private key Sᵢ corresponding to the information processing apparatus owned by the member Uᵢ (step S971).

[Numerical expression 28]

k′ⱼ=H₃(H₂(e(Qⱼ,Sᵢ))·δⱼ⊕Pⱼⁱ)⊕Vⱼ (Expression 924)

Subsequently, the information processing apparatus owned by each member Uᵢ calculates the session key K according to Expression 925 below using the calculated parameter kⱼ′ and the selected parameter kᵢ (step S973). [Numerical expression 29]

K=Kᵢ=k₁′⊕k₂′⊕ . . . ⊕kᵢ₋′⊕kᵢ⊕kᵢ₊₁′⊕ . . . ⊕kₙ′ (Expression 925)

Each of the information processing apparatuses calculates the session key K. Therefore, this means that the information processing apparatuses share the session key K used in the simultaneous communication, whereby the plurality of participants can start the simultaneous communication (step S975).

### <Method Described in Non-Patent Literature 3>

### [Method for Generating Session Key]

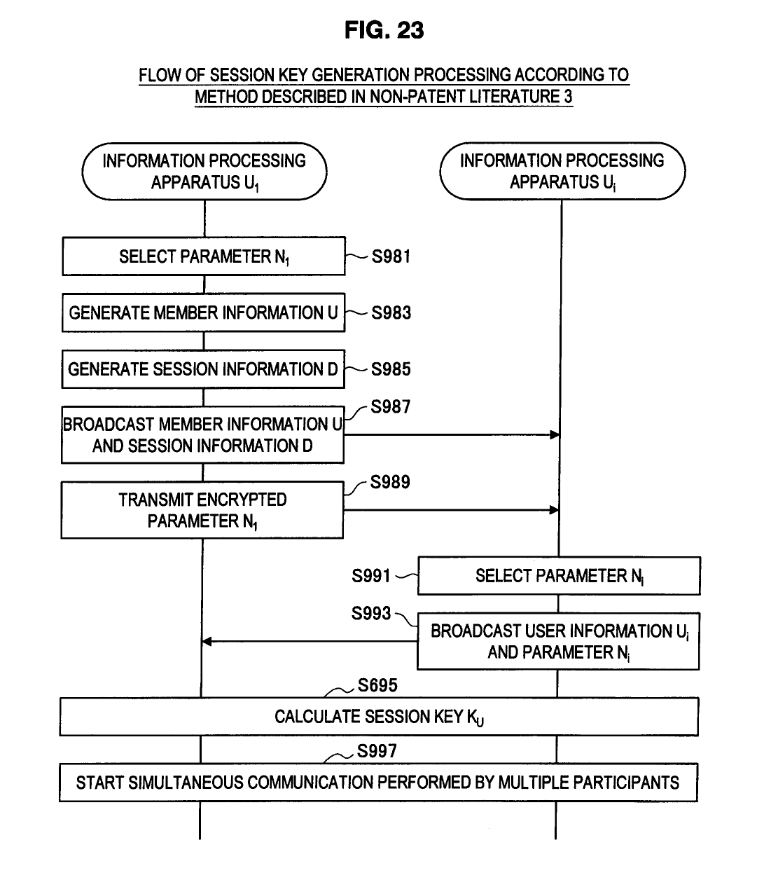

The method described in Non-Patent Literature 3 is a method for achieving one-round method in which each information processing apparatus participating in simultaneous communication transmits a message only once in order to reduce the overhead of communication. In the following explanation, the method described in Non-Patent Literature 3 will be explained in detail with reference to FIG. 23. FIG. 23 is a flow diagram illustrating session key generation processing in the method described in Non-Patent Literature 3.

In the method described in Non-Patent Literature 3, a center in a key sharing system uses a key generation apparatus to generate various kinds of system parameters of this method and an individual key (i.e., a user key including a public key and a private key and a user key for signature) for each member, before the session key generation processing. Therefore, a hash function, an encryption function E and a decryption function D of a public key cryptographic method, and a signature generation function S and a signature verification function V of a digital signature method are disclosed as system parameters. Further, the information processing apparatus owned by each user Uᵢ stores a published encryption key eᵢ, a secret decryption key dᵢ, a secret signature generation key sᵢ, and a published signature verification key vᵢ of a user Uᵢ. The published encryption key eᵢ and the published signature verification key vᵢ are assumed to be shared by each member Uᵢ.

In the explanation below, it is assumed that totally n sets of information processing apparatuses try to achieve simultaneous communication therebetween. In the method described in Non-Patent Literature 3, any one of n members U₁, U₂, . . . , Uₙ is a protocol initiator (which may be hereinafter also referred to as an initiator). In the explanation below, the member U₁ is assumed to be the initiator for the sake of brevity.

First, the information processing apparatus owned by the initiator U₁ generates a random number, and adopts the generated random number as a parameter N₁ (step S981). Subsequently, the information processing apparatus owned by the initiator U₁ generates, as member information, a list U including users who share a key (step S983). Subsequently, the information processing apparatus owned by the initiator U₁ generates session information D represented by Expression 926 below using the published encryption keys eᵢ of the other members Uᵢ, the secret signature generation key sᵢ of the information processing apparatus owned by the initiator U₁, and the selected parameter N₁, and the published parameter (step S985). In this case, i=2, . . . , n. [Numerical expression 30]

D=S(sᵢ,(E(e₂,N₁), . . . , E(eₙ,N₁))) (Expression 926)

In this case, in Expression 926, E(A, B) denotes a cipher text obtained by encrypting a message B using a key A, and S(A, B) denotes a digital signature applied to the message B using the key A.

Subsequently, the information processing apparatus owned by the initiator U₁ broadcasts the generated member information U and the session information D to the other members Uᵢ (step S987).

Subsequently, the information processing apparatus owned by the initiator U₁ encrypts the parameter N₁ using the published encryption key eᵢ of each user Uᵢ (i=2, . . . n) to generate a cipher text E (eᵢ, N₁). Thereafter, the information processing apparatus owned by the initiator U₁ transmits the generated cipher text E (eᵢ, N₁) to the information processing apparatus of each member Uᵢ (step S989).

When the information processing apparatus of each member Uᵢ receives each piece of information transmitted from the information processing apparatus of the initiator U₁, the information processing apparatus of each member Uᵢ decrypts the cipher text E (eᵢ, N₁) to obtain the parameter N₁. Further, the information processing apparatus of each member Uᵢ randomly selects a parameter N₁ (step S991), and broadcasts the user information Uᵢ and the parameter Nᵢ to the other information processing apparatuses (step S993). Therefore, each information processing apparatus participating in the simultaneous communication can obtain the parameters N₁ to Nₙ.

Subsequently, the information processing apparatus of each member Uᵢ including the initiator calculates a session key K_{U} according to Expression 927 below using the obtained parameter Nᵢ and the hash function h, i.e., a published parameter (step S995).

[Numerical expression 31]

K_{U}=h(N₁∥N₂∥ . . . ∥Nₙ) (Expression 927)

Each of the information processing apparatuses calculates the session key K_{U}. Therefore, this means that the information processing apparatuses share the session key K_{U} used in the simultaneous communication, whereby the plurality of participants can start the simultaneous communication (step S997).

<Problems Associated with the Second Method Described in Non-Patent Literature 2 and the Method Described in Non-Patent Literature 3>

As described above, the above second method described in Non-Patent Literature 2 and the method described in Non-Patent Literature 3 relate to the Group Key Agreement methods achieving one-round methods. However, the inventors of the present application have studied these methods in detail, and have found that both of these methods have a common problem as follows.

The problem is that, when a certain user (e.g., user A) transmits, to another user (e.g., user B), a value different from a value sent to the users other than the user B, the user A can exclude the user B from sharing a group key shared by a group including n people.

More specifically, a group including four people (U₁, U₂, U₃, U₄) is assumed. In the second method described in Non-Patent Literature 2, U₂ can deceive U₃ by using a value other than the correct r, in the calculation of P₂³ as described above, whereby the value k₂′ derived by U₃ from P₂³ is a value different from the correct value obtained by the other users. As a result, U₃ is unable to correctly share the group key.

On the other hand, in the method described in Non-Patent Literature 3, it is only the initiator U₁ that can carry out the above cheating. In other words, when E(eᵢ, N₁) is generated for each user Uᵢ, U₁ can use a value other than N₁ only for a particular user, whereby the particular user is unable to obtain the N₁, and as a result, the group key cannot be correctly shared.

Further, each member other than the above adversary has no way to know this attack being carried out, and thinks that the group key has been successfully shared by the members. Accordingly, each member may perform a target processing (for example, processing using the group key). This problem is not desired in terms of the security of the system.

Accordingly, it is an object of a method according to the second embodiment of the present invention described below to provide a more secure Group Key Agreement technique for preventing exclusion of a member, which may occur in the above method described in Non-Patent Literature 3. It is an object of a method according to the third embodiment of the present invention described below to provide a more secure Group Key Agreement technique for preventing exclusion of a member, which may occur in the second method described above in Non-Patent Literature 2.

The method according to each embodiment of the present invention described below is based on the methods described in Non-Patent Literature 2 and Non-Patent Literature 3 as the fundamental techniques, and is configured to obtain significant effects by applying improvements to these fundamental techniques. Therefore, it is the very improvement applied to the techniques that characterizes each embodiment of the present invention. In other words, although each embodiment of the present invention is based on the fundamental concept of the above technical matters, the gist of the present invention is rather concentrated on the improved portion. Therefore, it should be noted that the configuration of the present invention is clearly different, and the effects of the present invention are clearly distinguished from those of the fundamental techniques.

### First Embodiment

### Key Sharing System

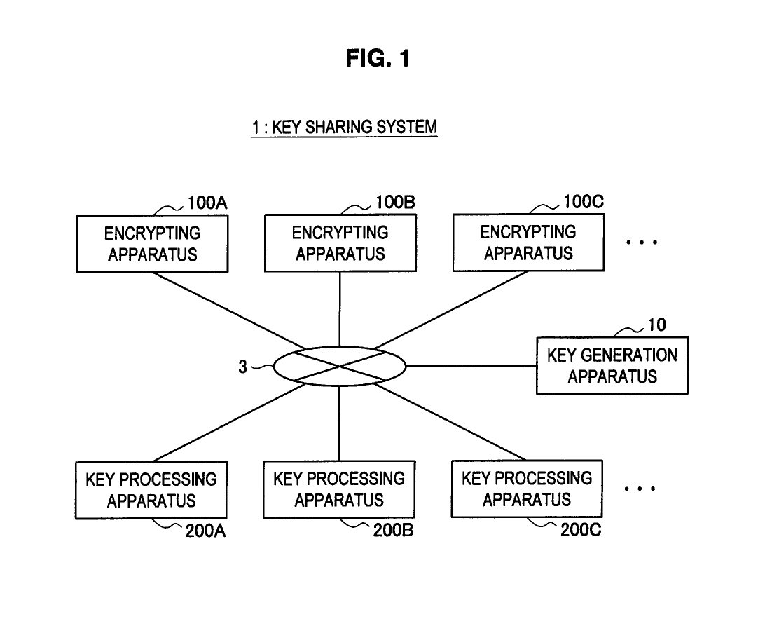

First, a key sharing system according to the first embodiment of the present invention will be explained in detail with reference to FIG. 1. FIG. 1 is an explanatory diagram illustrating the key sharing system according to the present embodiment.

For example, as shown in FIG. 1, a key sharing system 1 according to the present embodiment mainly includes a key generation apparatus 10, a plurality of encrypting apparatuses 100A, 100B, 100C . . . , and a plurality of key processing apparatuses 200A, 200B, 200C . . . . These apparatuses are connected with each other via a communication network 3.

The communication network 3 is a communication circuit network connecting between the key generation apparatus 10, the encrypting apparatuses 100, and the key processing apparatuses 200, so as to enable bidirectional communication or one way communication. This communication network 3 may be constituted by a public circuit network or a dedicated circuit network. Examples of public circuit networks include the Internet, an NGN (Next Generation Network), a telephone circuit network, a satellite communication network, a broadcast communication path, and the like. Examples of dedicated circuit networks include WAN (Wide Area Network), LAN (Local Area Network), IP-VPN (Internet Protocol-Virtual Private Network), Ethernet (registered trademark), wireless LAN, and the like. This communication network 3 may be connected either wirelessly or via a wire.

The key generation apparatus 10 generates a public key and a private key unique to each encrypting apparatus 100 and each key processing apparatus 200. The key generation apparatus 10 publishes the public keys, and distributes the public keys and the private keys to the apparatuses via a secure communication path. Further, the key generation apparatus 10 publishes, as system parameters, parameters which can be published and used in the key sharing system 1 according to the present embodiment. It should be noted that the key generation apparatus 10 may be owned by a center and the like that generates and manages the public keys and the private keys.

The encrypting apparatus 100 uses the public keys, the private keys, the published system parameters, and the like, which are generated by the key generation apparatus 10, to encrypt information for generating a session key required in a simultaneous communication performed between the encrypting apparatus 100 and the plurality of key processing apparatuses 200. Further, the encrypting apparatus 100 transmits the encrypted information for generating the session key to each key processing apparatus 200 via the communication network 3. This encrypting apparatus 100 may be owned by any third party. Alternatively, the encrypting apparatus 100 may be owned by the owner of the key generation apparatus 10 and the owners of the key processing apparatuses 200.

The key processing apparatus 200 uses the encrypted information transmitted from the encrypting apparatus 100 to generate information for generating the session key required for the simultaneous communication. Further, the key processing apparatus 200 transmits the generated information to the encrypting apparatus 100 and the other key processing apparatuses 200 participating in the simultaneous communication via the communication network 3. The key processing apparatus 200 may be owned by any third party. Alternatively, the key processing apparatus 200 may be owned by the owner of the key generation apparatus 10 and the owners of the encrypting apparatuses 100.

Each of the encrypting apparatuses 100 and the key processing apparatuses 200 may be a computer device (it may be either a notebook type or a desktop type) such as a personal computer (PC). Alternatively, each of the encrypting apparatuses 100 and the key processing apparatuses 200 may be any apparatus as long as it has a communication function by way of a network. Examples of these apparatuses include an information appliance such as a PDA (Personal Digital Assistant), a home game machine, a DVD/HDD recorder, and a television receiver, and a tuner and a recorder for television broadcast. Examples of these apparatuses further include a portable device that can be carried by a subscriber, such as a potable game machine, a portable telephone, a portable video/audio player, a PDA, and a PHS.

In FIG. 1, only three encrypting apparatuses 100 and three key processing apparatuses 200 are shown. However, in the key sharing system 1 according to the present embodiment, the numbers of apparatuses are not limited to the example as shown in FIG. 1.

### <Configuration of Key Generation Apparatus>

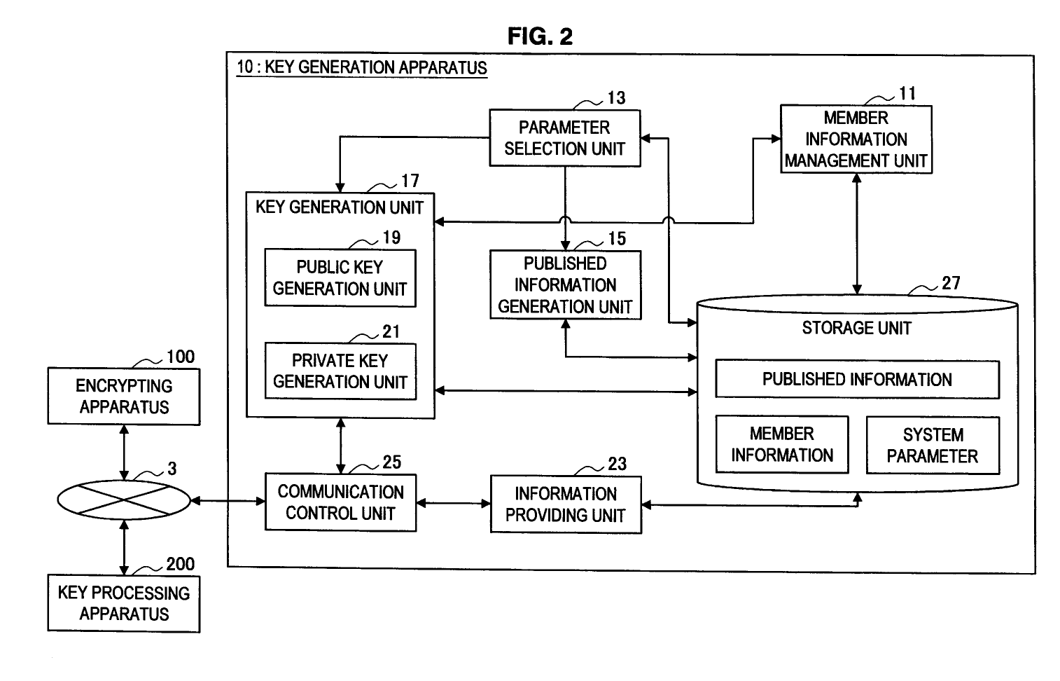

Subsequently, a configuration of the key generation apparatus 10 according to the present embodiment will be explained in detail with reference to FIG. 2. FIG. 2 is a block diagram illustrating functions of the key generation apparatus according to the present embodiment.

For example, as shown in FIG. 2, the key generation apparatus 10 according to the present embodiment mainly includes a member information management unit 11, a parameter selection unit 13, a published information generation unit 15, a key generation unit 17, an information providing unit 23, a communication control unit 25, and a storage unit 27.

The member information management unit 11 is achieved with, for example, a CPU (Central Processing Unit), a ROM (Read Only Memory), a RAM (Random Access Memory), and the like. The member information management unit 11 manages the information about the members for which members' individual keys are generated by the key generation apparatus 10 according to the present embodiment, wherein the member's individual key includes a public key and a private key. For example, the member information is recorded to the storage unit 27 explained later.

The parameter selection unit 13 is achieved with, for example, a CPU, a ROM, a RAM, and the like. The parameter selection unit 13 selects an order q, two groups G_{I}, G₂ of the order q, and a bilinear map e, according to a predetermined method. Subsequently, the parameter selection unit 13 selects a parameter Pε_{R}G₁ and a parameter sε_{R}Z_{q}*, and uses these parameters to calculate P_{pub}=sP. This parameter P is also referred to as a random generator. On the other hand, the parameter s is secretly saved as a master private key.

Subsequently, the parameter selection unit 13 selects four kinds of hash functions, i.e., H₁, H_{A}, H_{B}, H_{C}. These hash function respectively have the following features.

### H:{0, 1}*→G₁

H_{A}:G₂→{0, 1}^{|q|}
H_{B}:{0, 1}^{|q|}→Z_{q}*
H_{C}:G₁→{0, 1}^{|q|}

In this case, an expression {0, 1}^{|q|} means data having a size of q bits made of either 0 or 1. By appropriately changing the magnitude of q in accordance with the security level required in the key sharing system 1 according to the present embodiment, the security level can be changed.

The parameter selection unit 13 records these parameters as system parameters to the storage unit 27. Further, these selected parameters are transmitted to the published information generation unit 15 and the key generation unit 17.

The published information generation unit 15 is achieved with, for example, a CPU, a ROM, a RAM, and the like. The published information generation unit 15 selects those that may be published as published information (published system parameters) from among various kinds of parameters and hash functions selected by the parameter selection unit 13, and adopts them as published information. More specifically, the published information generation unit 15 generates a combination of <e, G_{I}, G₂, q, P, P_{pub}, H, H_{A}, H_{B}, H_{c}> as the published information, and stores the published information to the storage unit 27.

The key generation unit 17 is achieved with, for example, a CPU, a ROM, a RAM, and the like. When a member using the key sharing system 1 according to the present embodiment requests the key generation unit 17 to generate a member's individual key including a public key and a private key, the key generation unit 17 generates the individual key. When the key generation unit 17 generates the individual key, the key generation unit 17 obtains IDs of the requesting member (such as a user ID and a mail address) from the member information management unit 11, and generates the key based on the obtained ID and the system parameters selected by the parameter selection unit 13. For example, as shown in FIG. 2, the key generation unit 17 further includes a public key generation unit 19 and a private key generation unit 21.

The public key generation unit 19 is achieved with, for example, a CPU, a ROM, a RAM, and the like. The public key generation unit 19 generates a public key Qᵢ of a member i according to Expression 11 below using the ID (IDᵢ) of the requesting member and the hash functions H serving as the system parameter obtained from the member information management unit 11.

Public key Qᵢ=H(IDᵢ) (Expression 11)

The public key generation unit 19 can associate the generated public key Qᵢ of the member Uᵢ with the corresponding member information of the member Uᵢ, and store the generated public key Qᵢ and the corresponding member information to the storage unit 27.

The private key generation unit 21 is achieved with, for example, a CPU, a ROM, a RAM, and the like. The private key generation unit 21 generates a private key Sᵢ of the member Uᵢ according to Expression 13 below using the master private key s and the public key Qᵢ generated by the public key generation unit 19.

Private key Sᵢ=sQᵢ (Expression 13)

The private key generation unit 21 can associate the generated private key Sᵢ of the member Uᵢ with the corresponding member information of the member Uᵢ, and can store the generated private key Sᵢ and the corresponding member information to the storage unit 27.

As is evident from Expression 11, the public key of the member is generated from the published information and the ID of the member Uᵢ. In the key sharing system 1 according to the present embodiment, the ID of the member Uᵢ is information such as the user ID and the mail address. Therefore, any user can calculate the public key using the published information and the ID of the member Uᵢ. On the other hand, as is evident from Expression 13, the private key of the member Uᵢ is a value calculated using the master private key secretly stored in the key generation apparatus 10. Therefore, only the key generation apparatus 10 can generate the private key of the member Uᵢ.

The information providing unit 23 is achieved with, for example, a CPU, a ROM, a RAM, and the like. In response to requests given by the encrypting apparatuses 100 and the key processing apparatuses 200 according to the present embodiment, the information providing unit 23 provides these apparatuses with various kinds of information such as the published information and the public key of the member. When the information providing unit 23 provides the information, the information providing unit 23 can refer to various kinds of data stored in the storage unit 27.

The communication control unit 25 is achieved with, for example, a CPU, a ROM, a RAM, a communication device, and the like. The communication control unit 25 controls communication between the key generation apparatus 10 and the encrypting apparatus 100 or the key processing apparatus 200.

The storage unit 27 stores the member information managed by the member information management unit 11, the system parameters selected by the parameter selection unit 13, the published information generated by the published information generation unit 15, the individual keys generated by the key generation unit 17, and the like. The storage unit 27 may store, e.g., various parameters or progress of processing that are needed to be stored while the key generation apparatus 10 according to the present embodiment performs certain processing, and may store various kinds of databases and the like as necessary. The storage unit 27 may be freely read and written by the member information management unit 11, the parameter selection unit 13, the published information generation unit 15, the key generation unit 17, the information providing unit 23, the communication control unit 25, and the like.

Examples of the functions of the key generation apparatus 10 according to the present embodiment have been hereinabove explained. Each of the above constituent elements may be structured using a general-purpose member and a circuit, or may be structured by hardware dedicated to the function of each constituent element. Alternatively, the function of each constituent element may be carried out by a CPU and the like. Therefore, the used configuration may be changed as necessary in accordance with the state of the art at the time when the present embodiment is carried out.

It is possible to make a computer program for realizing the functions of the above-described key generation apparatus according to the present embodiment, and the computer program can be implemented on a personal computer and the like. Further, a computer-readable recording medium storing such computer program can be provided. Examples of the recording medium include a magnetic disk, an optical disk, a magneto-optical disk, and a flash memory. Further, the above computer program may be distributed by, for example, a network, without using the recording medium.

### <Configuration of Encrypting Apparatus>

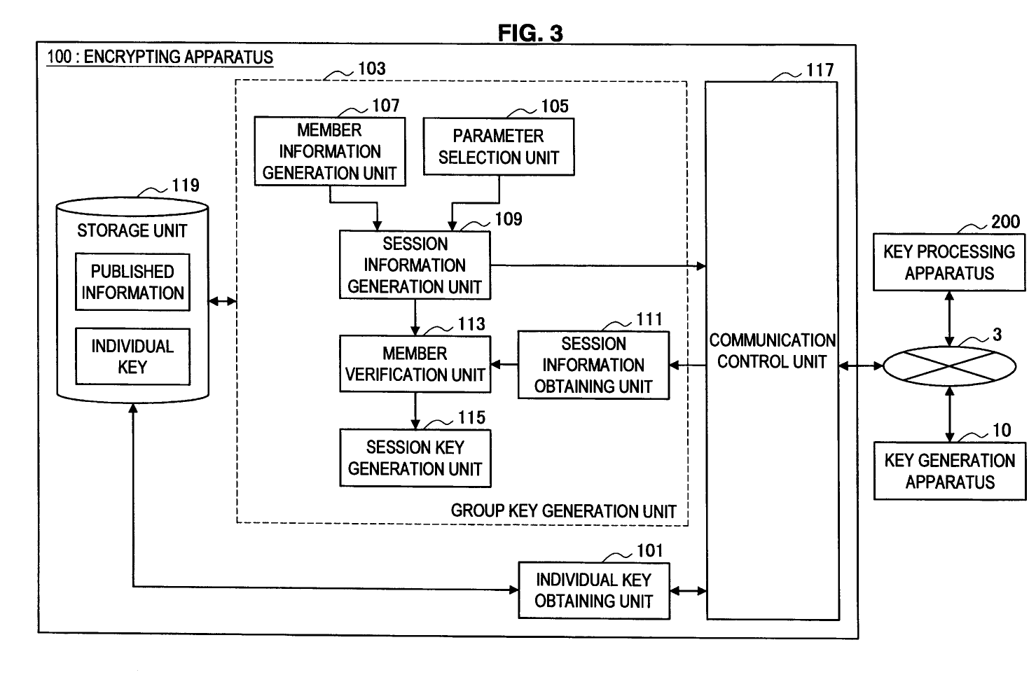

Subsequently, a configuration of the encrypting apparatus 100 according to the present embodiment will be explained in detail with reference to FIG. 3. FIG. 3 is a block diagram illustrating a configuration of the encrypting apparatus according to the present embodiment.

The encrypting apparatus 100 according to the present embodiment is an apparatus operated by the initiator who starts processing for generating a session key used in a simultaneous communication. In the explanation below, the encrypting apparatus 100 is assumed to be owned by the member U₁. For example, as shown in FIG. 3, the encrypting apparatus 100 according to the present embodiment mainly includes an individual key obtaining unit 101, a group key generation unit 103, a communication control unit 117, and a storage unit 119.

The individual key obtaining unit 101 is achieved with, for example, a CPU, a ROM, a RAM, and the like. The individual key obtaining unit 101 obtains an individual key (i.e., a public key and a private key) previously assigned to a member who uses the encrypting apparatus 100 from the key generation apparatus 10 via the communication control unit 117 explained later. Further, when the individual key obtaining unit 101 obtains the individual key, the individual key obtaining unit 101 can also obtain the published information (published system parameters) from the key generation apparatus 10. For example, the individual key obtaining unit 101 can store the individual key and the published information thus obtained to the storage unit 119 explained later.

The group key generation unit 103 is achieved with, for example, a CPU, a ROM, a RAM, and the like. The group key generation unit 103 as well as the key processing apparatus 200 generate a group key used for a simultaneous communication by using the individual key stored in the encrypting apparatus 100, the public key of the member who performs the simultaneous communication, the published information, and the information obtained from the key processing apparatuses 200. For example, as shown in FIG. 3, the group key generation unit 103 further includes a parameter selection unit 105, a member information generation unit 107, and a session information generation unit 109. In addition, the group key generation unit 103 further includes a session information obtaining unit 111, a member verification unit 113, and a session key generation unit 115.

The parameter selection unit 105 is achieved with, for example, a CPU, a ROM, a RAM, and the like. The parameter selection unit 105 selects a parameter δε_{R}Z_{q}* and a parameter k₁ε_{R}Z_{q}* and a parameter r having a predetermined number of bits used as a temporary key in the simultaneous communication. The parameter selection unit 105 transmits the selected parameters to the member information generation unit 107 and the session information generation unit 109.

The parameter selection unit 105 may associate the selected parameters with, e.g., information representing a date/time when the selection is made, and store the selected parameters, the information representing the date/time, together with history information and the like, to the storage unit 119 and the like explained later.

The member information generation unit 107 is achieved with, for example, a CPU, a ROM, a RAM, and the like. The member information generation unit 107 generates member information Pᵢ as shown in Expression 101 below using the public key Qᵢ of the members Uᵢ (i=2, . . . , n) participating in the simultaneous communication, the private key S₁ stored in the encrypting device 100, the temporary key r selected by the parameter selection unit 105, and the published information. The member information Pᵢ is generated for each of (n−1) participating members.

[Numerical expression 32]

Pᵢ=r|H_{A}(e(S₁,δQᵢ)) (Expression 101)

In this case, in the Expression 101, H_{A} denotes one of the published hash functions, and i denotes an integer from 2 to n.

Further, the member information generation unit 107 also generates information L representing the order in which the member information P₂ to Pₙ are arranged so as to clarify the correspondence between the generated member information P₂ to Pₙ and the respective (n−1) members participating in the simultaneous communication. For the sake of brevity, it is assumed that the information L is generated according to a certain rule, in which the same data are obtained no matter which of the n members generates the information L.

The member information generation unit 107 transmits the generated member information Pᵢ and the information L representing the correspondence between the member information and the members to the session information generation unit 109.

The member information generation unit 107 may associate the generated member information and the like with information representing, e.g., a date/time when the member information is generated, and store the generated member information, the information representing the date/time, together with history information and the like, to the storage unit 119 and the like explained later.

The session information generation unit 109 is achieved with, for example, a CPU, a ROM, a RAM, and the like. The session information generation unit 109 generates session information D₁ of the member U₁, on the basis of various kinds of parameters transmitted from the parameter selection unit 105, the member information Pᵢ, the information L about the correspondence transmitted from the member information generation unit 107, and the published information. More specifically, first, the session information generation unit 109 calculates a value X₁ represented by Expression 102 below and a value Y₁ represented by Expression 103 below. Thereafter, the session information generation unit 109 generates the session information D₁ represented by Expression 104 below using the calculated values and the like. This session information identifies simultaneous communication performed between the encrypting apparatus 100 and the plurality of key processing apparatuses 200, and is information used to generate the session key in the simultaneous communication.

[Numerical expression 33]

X₁=H_{B}(r∥L)k₁P (Expression 102)

Y₁=k₁P_{pub}+H_{B}(r∥L)·S₁ (Expression 103)

D₁= [symbol] δ,P₂, . . . Pₙ,X₁,Y₁,L [symbol] (Expression 104)

In Expressions 102 and 103, an expression “a∥b” denotes combining bits of data “a” with bits of data “b”. In Expressions 102 and 103, H_{B} denotes one of the published hash functions.

As shown in Expression 103, the session information generation unit 109 according to the present embodiment generates session information using the private key S₁ of the member U₁. Therefore, members other than the member U₁ are unable to generate the session information D₁ even when they try to generate session information disguised as the session information of the member U₁.

The session information generation unit 109 broadcasts the generated session information D₁ to the key processing apparatuses 200 owned by the member U₂ to member Uₙ via the communication control unit 117. Further, the session information generation unit 109 transmits the generated session information D₁ to the member verification unit 113. The session information generation unit 109 associates the generated session information D₁ with, e.g., information representing a date/time when the session information D₁ is generated, and store the generated session information D₁, the information representing the date/time, together with history information and the like, to the storage unit 119 and the like explained later.

The session information obtaining unit 111 is achieved with, for example, a CPU, a ROM, a RAM, and the like. The session information obtaining unit 111 obtains the session information Dᵢ transmitted from all of the key processing apparatuses 200 via the communication control unit 117. The session information Dᵢ is represented by Expression 201 below.

[Numerical expression 34]

Dᵢ= [symbol] Xᵢ,Yᵢ>H_{B}(r∥L)·kᵢP,kᵢP_{pub}+H_{B}(r∥L)·Sᵢ [symbol] (Expression 201)

The session information obtaining unit 111 transmits all of the obtained session information Dᵢ to the member verification unit 113 explained later. Further, the session information obtaining unit 111 may associate the obtained session information Dᵢ with, e.g., information representing a date/time when the session information Dᵢ is obtained, and store the session information Dᵢ, the information representing the date/time, together with history information and the like, to the storage unit 119 and the like explained later.

The member verification unit 113 is achieved with, for example, a CPU, a ROM, a RAM, and the like. The member verification unit 113 determines whether a member participating in the simultaneous communication is a valid member or not. More specifically, first, the member verification unit 113 calculates a verification parameter z represented by Expression 105 below based on the session information D₁ owned by the member U₁ and the session information Dᵢ obtained from all the key processing apparatuses 200. Subsequently, the member verification unit 113 calculates the values of the left side and the right side of Expression 106 below, and determines whether Expression 106 holds or not to verify the validity of the members who participate in the simultaneous communication. When Expression 106 is determined to hold, the member verification unit 113 determines that the members who perform the simultaneous communication are constituted by only valid members, and requests the session key generation unit 115, explained later, to generate a session key. When Expression 106 is determined not to hold, the member verification unit 113 determines that some of the members who transmitted the session information Dᵢ are invalid, and accordingly, the session key is not generated.

$$\begin{matrix}[ Numerical expression 35 ] & \\ z = {{H}_{B} ( r \vert \vert L )}^{- 1} \cdot {\sum }_{j = 1}^{n} {X}_{j} = {\sum }_{j = 1}^{n} {k}_{j} P & ( Expression 105 ) \\ e ( P , {\sum }_{j = 1}^{n} {Y}_{j} ) = e ( {P}_{pub} , z + {H}_{B} ( r \vert \vert L ) \cdot {\sum }_{j = 1}^{n} {Q}_{j} ) & ( Expression 106 )\end{matrix}$$

In contrast to the fundamental techniques, when the member verification unit 113 according to the present embodiment calculates the verification parameter z, the member verification unit 113 calculates a summation of Xᵢ, i.e., a portion of the session information, for all the session information Dᵢ (i=1, . . . , n). Therefore, when the encrypting apparatus 100 according to the present embodiment calculates the session key explained later, the encrypting apparatus 100 can greatly reduce the number of multiplications in groups, which produces a large calculation load, as compared with the fundamental techniques. In contrast to the fundamental techniques, the member verification unit 113 according to the present embodiment perform verification using the public key Qᵢ of each member. In order to generate session information that can pass this verification, each member needs to use the private key Sᵢ of each member, and it is impossible for another member Uⱼ to disguise as the member Uᵢ. Therefore, this prevents the problem associated with the fundamental techniques described above.

When the member verification unit 113 successfully finishes the verification of the members, the member verification unit 113 transmits the result indicating the successful verification and the calculated verification parameter z to the session key generation unit 115. Further, the member verification unit 113 may associate the calculated verification parameter z with, e.g., information representing a date/time when the verification parameter z is calculated, and store the calculated verification parameter z, the information representing the date/time, together with history information and the like, to the storage unit 119 and the like explained later.

The session key generation unit 115 is achieved with, for example, a CPU, a ROM, a RAM, and the like. In a case where the member verification unit 113 successfully verifies the members participating in the simultaneous communication, the session key generation unit 115 uses the verification parameter z transmitted from the member verification unit 113 to generate a session key K used in the simultaneous communication. The session key K is generated with Expression 107 below. In this case, in the Expression 107 below, H_{C} denotes one of the published hash functions.

[Numerical expression 36]

K=Kᵢ=H_{C}(z) (Expression 107)

By using the session key K thus generated, the encrypting apparatus 100 and the plurality of key processing apparatuses 200 can securely perform the simultaneous communication.

The session key generation unit 115 may associate the generated session key K with, e.g., information representing a date/time when the session key K is generated, and store the session key K, the information representing the date/time, together with history information and the like, to the storage unit 119 and the like explained later.

The communication control unit 117 is constituted by, for example, a CPU, a ROM, a RAM, a communication device, and the like. The communication control unit 117 controls communication between the encrypting apparatus 100 and the key generation apparatus 10 or the key processing apparatuses 200.

The storage unit 119 stores the published information published by the key generation apparatus 10, the individual keys including the public keys and the private keys obtained from the key generation apparatus 10, and the like. The storage unit 119 may store, e.g., various parameters or progress of processing that are needed to be stored while the encrypting apparatus 100 according to the present embodiment performs certain processing, and may store various kinds of databases and the like as necessary. The storage unit 119 may be freely read and written by the individual key obtaining unit 101, the group key generation unit 103, each processing unit included in the group key generation unit 103, and the communication control unit 117, and the like.

Examples of the functions of the encrypting apparatus 100 according to the present embodiment have been hereinabove explained. Each of the above constituent elements may be structured using a general-purpose member and a circuit, or may be structured by hardware dedicated to the function of each constituent element. Alternatively, the function of each constituent element may be carried out by a CPU and the like. Therefore, the used configuration may be changed as necessary in accordance with the state of the art at the time when the present embodiment is carried out.

It is possible to make a computer program for realizing the functions of the above-described encrypting apparatus according to the present embodiment, and the computer program can be implemented on a personal computer and the like.

Further, a computer-readable recording medium storing such computer program can be provided. Examples of the recording medium include a magnetic disk, an optical disk, a magneto-optical disk, and a flash memory. Further, the above computer program may be distributed by, for example, a network, without using the recording medium.

### <Configuration of Key Processing Apparatus>

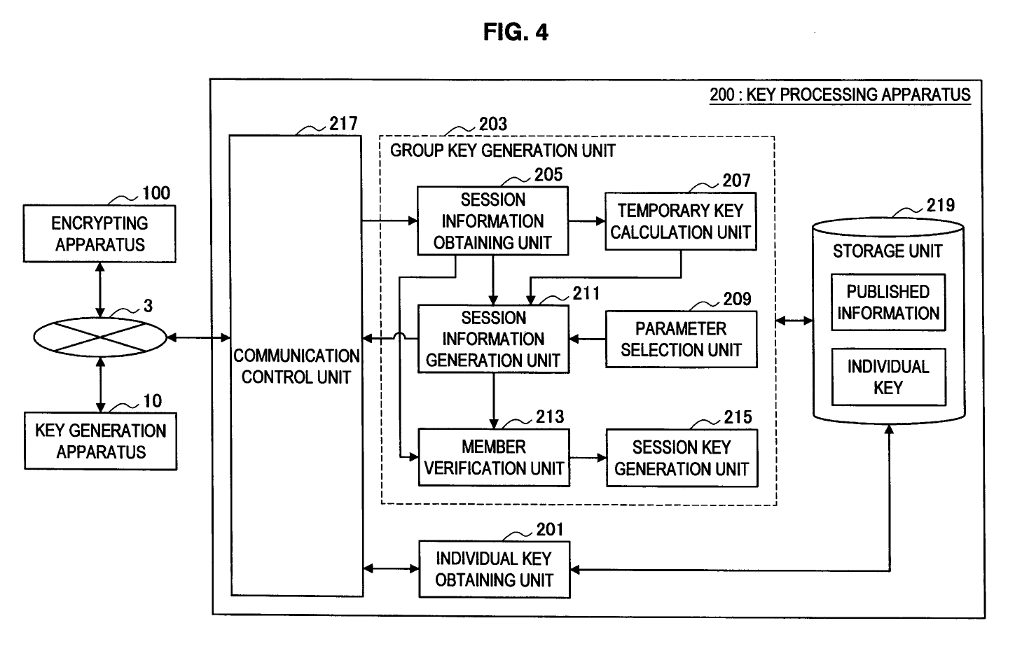

Subsequently, a configuration of the key processing apparatus 200 according to the present embodiment will be explained in detail with reference to FIG. 4. FIG. 4 is a block diagram illustrating the functions of the key processing apparatus according to the present embodiment.

The key processing apparatus 200 according to the present embodiment is an apparatus used by members Uᵢ (i=2, n) other than the user of the encrypting apparatus 100 (member U₁), i.e., the initiator of the simultaneous communication. For example, as shown in FIG. 4, the key processing apparatus 200 according to the present embodiment mainly includes an individual key obtaining unit 201, a group key generation unit 203, a communication control unit 217, and a storage unit 219.

The individual key obtaining unit 201 is achieved with, for example, a CPU, a ROM, a RAM, and the like. The individual key obtaining unit 201 obtains an individual key (i.e., a public key and a private key) previously assigned to a member who uses the key processing apparatus 200 from the key generation apparatus 10 via the communication control unit 217 later explained. Further, when the individual key obtaining unit 201 obtains the individual key, the individual key obtaining unit 201 can also obtain the published information (published system parameters) from the key generation apparatus 10. For example, the individual key obtaining unit 201 can store the individual key and the published information thus obtained to the storage unit 219 explained later.

The group key generation unit 203 is achieved with, for example, a CPU, a ROM, a RAM, and the like. The group key generation unit 203 as well as the above apparatus generate a group key used for a simultaneous communication by using the individual key stored in the key processing apparatus 200, the public key of the member who performs the simultaneous communication, the published information, and the information obtained from the encrypting apparatus 100 and the other key processing apparatuses 200. For example, as shown in FIG. 4, the group key generation unit 203 further includes a session information obtaining unit 205, a temporary key calculation unit 207, a parameter selection unit 209, a session information generation unit 211, a member verification unit 213, and a session key generation unit 215.

The session information obtaining unit 205 is achieved with, for example, a CPU, a ROM, a RAM, and the like. The session information obtaining unit 205 obtains session information D₁ transmitted from the encrypting apparatus 100 and session information Dᵢ transmitted from the other key processing apparatuses 200 participating in the simultaneous communication, which is different from the session information D₁ transmitted from the encrypting apparatus 100. More specifically, the session information obtaining unit 205 obtains the session information D₁ which is transmitted from the encrypting apparatus 100, i.e., the initiator, via the communication control unit 217 explained later and which is represented by Expression 104 below. Likewise, the session information obtaining unit 205 obtains the session information Dᵢ which is transmitted from the other key processing apparatuses 200 participating in the simultaneous communication and which is represented by Expression 201 below.

[Numerical expression 37]

D₁= [symbol] δ,P₂, . . . Pₙ,X₁,Yᵢ,L [symbol] = [symbol] δ,P₂, . . . Pₙ,H_{B}(r∥L)·kₖP,kᵢP_{pub}+H_{B}(r∥L)·S₁,L [symbol] (Expression 104)

Dᵢ= [symbol] Xᵢ,Yᵢ [symbol] [symbol] _{=<H}_{B}(r∥L)·kᵢP,kᵢP_{pub}+H_{B}(r∥L)·Sᵢ [symbol] (Expression 201)

The session information obtaining unit 205 transmits the session information D₁ received from the encrypting apparatus 100 to the temporary key calculation unit 207 and the session information generation unit 211 explained later. Further, the session information obtaining unit 205 transmits the session information Dᵢ received from the other key processing apparatuses 200 to the member verification unit 213 explained later. Further, the session information obtaining unit 205 may associate the obtained session information with, e.g., information representing a date/time when the session information is obtained, and store the session information, the information representing the date/time, together with history information and the like, to the storage unit 219 and the like explained later.

The temporary key calculation unit 207 is achieved with, for example, a CPU, a ROM, a RAM, and the like. The temporary key calculation unit 207 calculates a temporary key temporarily used in the simultaneous communication, on the basis of the session information D₁ transmitted from the session information obtaining unit 205. First, the temporary key calculation unit 207 refers to the information L about the correspondence of the member information Pᵢ included in the session information D₁, and detects the member information Pᵢ corresponding to the key processing apparatus 200. Subsequently, the temporary key calculation unit 207 calculates a temporary key r′ according to Expression 202 below using the member information Pᵢ corresponding to the key processing apparatus 200, the individual key of the key processing apparatus 200, the public key of the member U₁ who uses the encrypting apparatus 100, and the published information. In this case, in Expression 202 below, H_{A} denotes one of the published hash functions.

[Numerical expression 38]

r′=H_{A}(e(Sᵢ,δQ₁))⊕Pᵢ=r (Expression 202)

In this case, when the member U₁ correctly generates the session key D₁, the temporary key r′ calculated by the key processing apparatus 200 owned by the member Uᵢ is the same as the temporary key r selected by the encrypting apparatus owned by the member U₁. In other words, in Expression 202, an equal sign at the right side has equality, and as a result, r′=r holds.

The temporary key calculation unit 207 transmits the calculated temporary key r′ to the session information generation unit 211 explained later. In the explanation below, it is assumed that r′=r holds. Accordingly, r′ is denoted as r. Further, the temporary key calculation unit 207 may associate the calculated temporary key with, e.g., information representing a date/time when the temporary key is calculated, and store the temporary key, the information representing the date/time, together with history information and the like, to the storage unit 219 and the like explained later.

The parameter selection unit 209 is achieved with, for example, a CPU, a ROM, a RAM, and the like. The parameter selection unit 209 selects a parameter kᵢε_{R}Z_{q}* used when the key processing apparatus 200 calculates the session information Dᵢ. The parameter selection unit 209 transmits the selected parameter kᵢ to the session information generation unit 211.

Further, the parameter selection unit 209 may associate the selected parameter with, e.g., information representing a date/time when the parameter is selected, and store the parameter, the information representing the date/time, together with history information and the like, to the storage unit 219 and the like explained later.

The session information generation unit 211 is achieved with, for example, a CPU, a ROM, a RAM, and the like. The session information generation unit 211 generates session information Dᵢ according to Expression 201 using the parameter kᵢ, the private key of the member Uᵢ stored in the key processing apparatus 200, the published information, and the session information D₁ transmitted from the encrypting apparatus 100. The generated session information Di is broadcast via the communication control unit 217 to the encrypting apparatus 100 and the other key processing apparatuses 200 performing the simultaneous communication.

[Numerical expression 39]

Dᵢ= [symbol] Xᵢ,Yᵢ [symbol] [symbol] _{=H}_{B}(r∥L)·kᵢP,kᵢP_{pub}+H_{B}(r∥L)·Sᵢ [symbol] (Expression 201)

As shown in Expression 201, the session information generation unit 211 according to the present embodiment generates session information using the private key Sᵢ of the member Uᵢ. Therefore, members other than the member Uᵢ having the private key Sᵢ are unable to generate the session information Dᵢ even when they try to generate session information disguised as the session information of the member Uᵢ.

The member verification unit 213 is achieved with, for example, a CPU, a ROM, a RAM, and the like. The member verification unit 213 determines whether a member participating in the simultaneous communication is a valid member or not. More specifically, first, the member verification unit 213 calculates a verification parameter z represented by Expression 203 below based on the session information Dᵢ generated by the key processing apparatus 200, the session information D₁ obtained from the encrypting apparatus 100, and the session information Dᵢ obtained from the other key processing apparatuses 200. Subsequently, the member verification unit 213 calculates the values of the left side and the right side of Expression 204 below, and determines whether Expression 204 holds or not to verify the validity of the members who participate in the simultaneous communication. When Expression 204 is determined to hold, the member verification unit 213 determines that the members who perform the simultaneous communication are constituted by only valid members, and requests the session key generation unit 215, explained later, to generate a session key. When Expression 204 is determined not to hold, the member verification unit 213 determines that some of the members who transmitted the obtained session information Dᵢ are invalid, and accordingly, the session key is not generated.

$$\begin{matrix}[ Numerical expression 40 ] & \\ z = {{H}_{B} ( r \vert \vert L )}^{- 1} \cdot {\sum }_{j = 1}^{n} {X}_{j} = {\sum }_{j = 1}^{n} {k}_{j} P & ( Expression 203 ) \\ e ( P , {\sum }_{j = 1}^{n} {Y}_{j} ) = e ( {P}_{pub} , z + {H}_{B} ( r \vert \vert L ) \cdot {\sum }_{j = 1}^{n} {Q}_{j} ) & ( Expression 204 )\end{matrix}$$

In contrast to the fundamental techniques, when the member verification unit 213 according to the present embodiment calculates the verification parameter z, the member verification unit 213 calculates a summation of Xᵢ, i.e., a portion of the session information, for all the session information Dᵢ (i=1, . . . , n). Therefore, when the key processing apparatus 200 according to the present embodiment calculates the session key explained later, the key processing apparatus 200 can greatly reduce the number of multiplications in groups, which produces a large calculation load, as compared with the fundamental techniques. In contrast to the fundamental techniques, the member verification unit 213 according to the present embodiment perform verification using the public key Qᵢ of each member. In order to generate session information that can pass this verification, each member needs to use the private key Sᵢ of each member, and it is impossible for another member Uⱼ to disguise as the member Uᵢ. Therefore, this prevents the problem associated with the fundamental techniques described above.

When the member verification unit 213 successfully finishes the verification of the members, the member verification unit 213 transmits the result indicating the successful verification and the calculated verification parameter z to the session key generation unit 215. Further, the member verification unit 213 may associate the calculated verification parameter z with, e.g., information representing a date/time when the verification parameter z is calculated, and store the calculated verification parameter z, the information representing the date/time, together with history information and the like, to the storage unit 219 and the like explained later.

The session key generation unit 215 is achieved with, for example, a CPU, a ROM, a RAM, and the like. In a case where the member verification unit 213 successfully verifies the members participating in the simultaneous communication, the session key generation unit 215 uses the verification parameter z transmitted from the member verification unit 213 to generate a session key Kᵢ used in the simultaneous communication. The session key Kᵢ is generated with Expression 205 below. In this case, in the Expression 205 below, H_{C} denotes one of the published hash functions.

[Numerical expression 41]

K=Kᵢ=H_{C}(z) (Expression 205)

By using the session key Kᵢ thus generated, the key processing apparatus 200 and the encrypting apparatus 100 can securely perform the simultaneous communication.

Further, the session key generation unit 215 may associate the generated session key K with, e.g., information representing a date/time when the session key K is generated, and store the session key K, the information representing the date/time, together with history information and the like, to the storage unit 219 and the like explained later.

The communication control unit 217 is achieved with, for example, a CPU, a ROM, a RAM, a communication device, and the like. The communication control unit 217 controls communication between the key processing apparatus 200 and the key generation apparatus 10 or the encrypting apparatus 100. Further, the communication control unit 217 can also control communication between the key processing apparatus 200 and the other key processing apparatuses 200.

The storage unit 219 stores the published information published by the key generation apparatus 10, the individual keys including the public keys and the private keys obtained from the key generation apparatus 10, and the like. The storage unit 219 may store, e.g., various parameters or progress of processing that are needed to be stored while the key processing apparatus 200 according to the present embodiment performs certain processing, and may store various kinds of databases and the like as necessary. The storage unit 219 may be freely read and written by the individual key obtaining unit 201, the group key generation unit 203, each processing unit included in the group key generation unit 203, and the communication control unit 217, and the like.

Examples of the functions of the key processing apparatus 200 according to the present embodiment have been hereinabove explained. Each of the above constituent elements may be structured using a general-purpose member and a circuit, or may be structured by hardware dedicated to the function of each constituent element. Alternatively, the function of each constituent element may be carried out by a CPU and the like. Therefore, the used configuration may be changed as necessary in accordance with the state of the art at the time when the present embodiment is carried out.

It is possible to make a computer program for realizing the functions of the above-described key processing apparatus according to the present embodiment, and the computer program can be implemented on a personal computer and the like. Further, a computer-readable recording medium storing such computer program can be provided. Examples of the recording medium include a magnetic disk, an optical disk, a magneto-optical disk, and a flash memory. Further, the above computer program may be distributed by, for example, a network, without using the recording medium.

It should be noted that the encrypting apparatus 100 may also have the functions of the key processing apparatus 200. Alternatively, the key processing apparatus 200 may also have the functions of the encrypting apparatus 100. In a certain a simultaneous communication, the key processing apparatus 200 may also serve as the initiator (i.e., the encrypting apparatus 100) to start the protocol according to the present embodiment. Alternatively, in a certain a simultaneous communication, the encrypting apparatus 100 may also serve as an apparatus used by another participating member to perform the functions of the key processing apparatus 200.

### <Key Generation Processing>

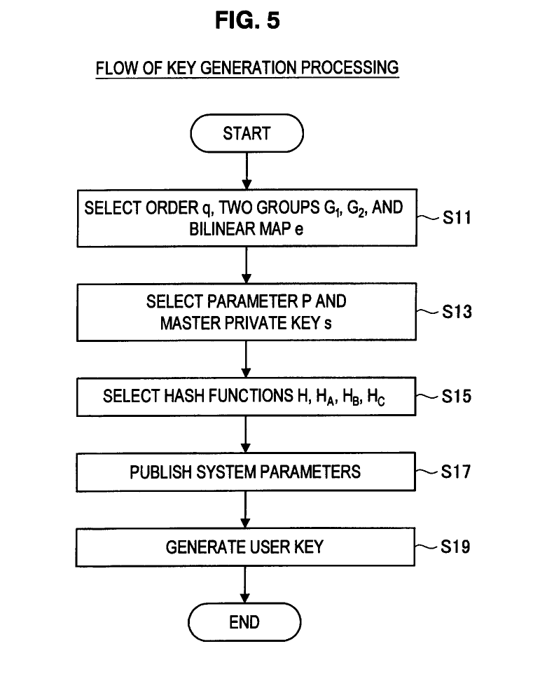

In the key sharing system 1 according to the present embodiment, the key generation apparatus 10 owned by the center generates various kinds of system parameters (i.e., published information) of this method and an individual key (i.e., a user key including a public key and a private key) for each member. Key generation processing performed by the key generation apparatus 10 according to the present embodiment will be hereinafter explained in detail with reference to FIG. 5.

First, the parameter selection unit 13 of the key processing apparatus 10 selects an order q, two groups G₁, G₂ of the order q, and a bilinear map e, according to a predetermined method (step S11).

Subsequently, the parameter selection unit 13 selects a parameter Pε_{R}G₁ and a parameter sε_{R}Z_{q}* (step S13), and uses these parameters to calculate P_{pub}=sP. This parameter P may also be called a random generator. On the other hand, the parameter s is secretly saved as a master private key.

Subsequently, the parameter selection unit 13 selects four kinds of hash functions, i.e., H, H_{A}, H_{B}, H_{C} (step S15). These hash functions respectively have the following features.

### H:{0, 1}*→G₁

H_{A}:G₂→{0, 1}^{|q|}
H_{B}:{0, 1}^{|q|→Z}_{q}*
H_{C}:G₁→{0, 1}^{|q|}

Subsequently, the published information generation unit 15 publishes, as system parameters (published information), some of various setting values generated in the above step that are allowed to be published (step S17). For example, the published system parameters include <e, G₁, G₂, q, P, P_{pub}, H, H_{A}, H_{B}, H_{C}>. He

Subsequently, when the member Uᵢ having an ID (IDᵢ) for distinguishing the user such as a user ID number and a mail address participates in this key sharing system 1, the key generation unit 17 generates a public key Qᵢ and a private key Sᵢ of the user Uᵢ according to the following method (step S19).

More specifically, first, the public key generation unit 19 generates the public key Qᵢ of the member Uᵢ by using the hash function H, i.e., system parameter, and the ID (IDᵢ) of the requesting member obtained from the member information management unit 11.

public key Qᵢ=H(IDᵢ)

Subsequently, the private key generation unit 21 generates the private key Sᵢ of the member Uᵢ by using the public key Qᵢ generated by the public key generation unit 19 and the master private key s.

private key Sᵢ=sQᵢ

The key generation apparatus 10 transmits the generated individual key (i.e., the public key Qᵢ and the private key S) of the user Uᵢ to the corresponding member Uᵢ. Further, the key generation apparatus 10 may also publish the generated public key Qᵢ of the user U.

When apparatuses try to execute simultaneous communication using the key sharing system according to the present embodiment, the apparatuses use the system parameters thus published and the public keys and the private keys of the members to generate and share a session key used for the simultaneous communication according to the following method.

### <Method for Generating Session Key>

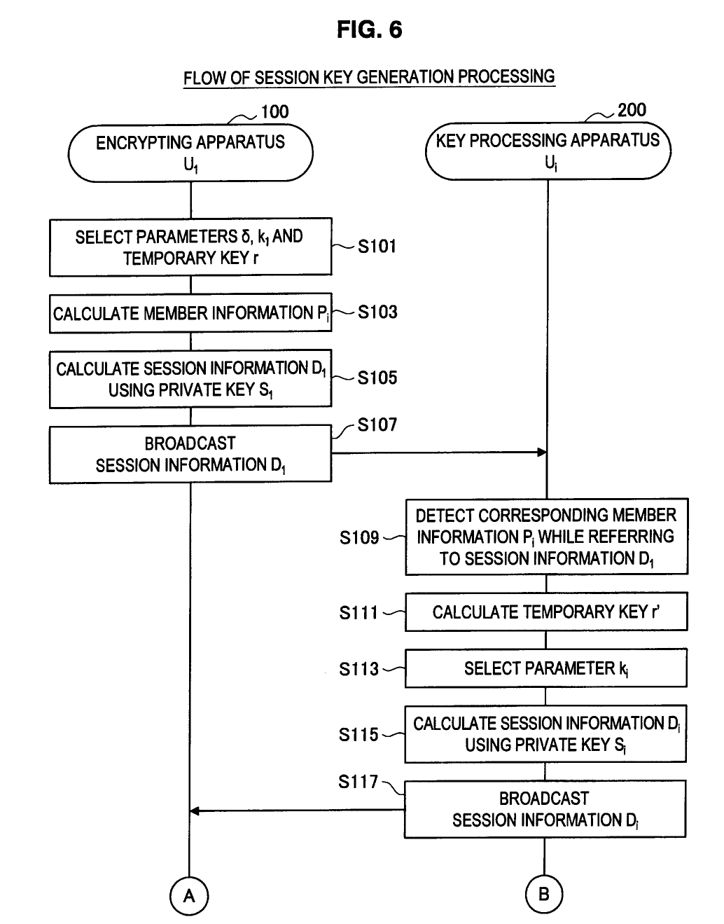

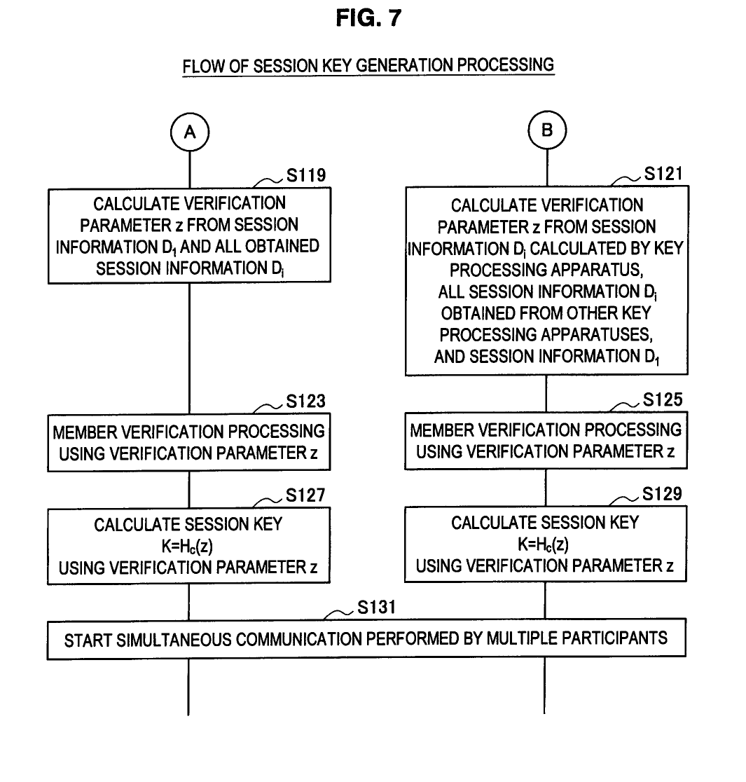

Subsequently, a method for generating session key, including the encrypting method performed by the encrypting apparatus 100 according to the present embodiment and the key processing method performed by the key processing apparatus 200, will be explained in detail with reference to FIGS. 6 and 7. FIGS. 6 and 7 are flow diagrams illustrating session key generation processing according to the present embodiment.

The method for generating session key according to the present embodiment includes three processings, i.e., a processing mainly performed by the encrypting apparatus 100, a processing mainly performed by the key processing apparatus 200, and processing for generating session key respectively performed by the encrypting apparatus 100 and the key processing apparatus 200. In the explanation below, the processing mainly performed by the encrypting apparatus is also called Round 1. On the other hand, the processing mainly performed by the key processing apparatus 200 is also called Round 2.

In the explanation below, it is assumed that one encrypting apparatus 100 and (n−1) key processing apparatuses 200 try to achieve simultaneous communication therebetween. In the method according to the present embodiment, any one of n members U₁, U₂, . . . , Uₙ is a protocol initiator (which may be hereinafter also referred to as an initiator). In the explanation below, the member U₁ is assumed to be the initiator for the sake of brevity.

### [Round 1]

First, the parameter selection unit 105 of the encrypting apparatus 100 owned by the member U₁ serving as the initiator selects a parameter δε_{R}G₂ and a parameter k₁ε_{R}Z_{q}*, i.e., parameters used for sharing a session key (step S101). The information processing apparatus owned by the member U₁ also selects a parameter rε_{R}{0, 1}^{|q|} (step S101). This parameter r is selected as a procedure for sharing the session key in the simultaneous communication.

Subsequently, the member information generation unit 107 of the encrypting apparatus 100 generates member information Pᵢ (i=2, . . . n) for the members U₂ to Uₙ participating in the simultaneous communication, i.e., information for transmitting a parameter used as a temporary key to the apparatuses participating in the simultaneous communication (step S103). This member information Pᵢ is a value represented by Expression 101. Further, when the member information generation unit 107 generates the member information Pᵢ, the member information generation unit 107 generates information L representing correspondence between the member information and the members.

Subsequently, the session information generation unit 109 uses the published information, the selected parameters, and the private key of the member U₁, to calculate the values X₁, Y₁ as shown in Expressions 102 and 103. When the calculation of X₁, Y₁ is finished, the session information generation unit 109 generates session information D₁ represented by Expression 104 (step S105).

When the session information D₁ has been generated, the session information generation unit 109 broadcasts the generated session information D₁ to all the key processing apparatuses 200 via the communication control unit 117 (step S107).

### [Round 2]

After the session information obtaining unit 205 of each of the key processing apparatuses 200 owned by the members U₂ to Uₙ receive the session information D₁, the session information obtaining unit 205 transfers the obtained session information D₁ to the temporary key calculation unit 207. The temporary key calculation unit 207 first refers to the information L included in the session information D₁, and determines which of P₂ to Pₙ the member information of the key processing apparatus 200 in question corresponds to (step S109).

Subsequently, the temporary key calculation unit 207 calculates a temporary key r′ according to Expression 202 using the member information Pᵢ of the key processing apparatus 200 in question, the session information D₁, the public key Qᵢ of the member U₁, i.e., the initiator, and the private key Sᵢ of the key processing apparatus 200 in question (step S111).

In this case, when the session key D₁ is correctly generated by the member U₁, the temporary key r′ calculated by the key processing apparatuses 200 owned by the members U₂ to Uₙ is equal to the temporary key r selected by the encrypting apparatus 100 owned by the member U₁. In other words, r′=r holds.

Subsequently, the parameter selection unit 209 select a parameter kᵢε_{R}Z_{q}* (step S113). Thereafter, the session information generation unit 211 generates session information Dᵢ, which is transmitted to the encrypting apparatus 100 and the key processing apparatuses 200 owned by the other members Uᵢ, using the parameter kᵢ, the temporary key r′, the published information, and the private key Sᵢ of the key processing apparatus 200 (step S115). It should be noted that the session information Dᵢ is generated based on Expression 201 explained above.

When the session information Dᵢ has been generated, the session information generation unit 211 of each of the key processing apparatuses 200 owned by the members U₂ to Uₙ broadcasts the generated session information Dᵢ to the apparatuses other than the key processing apparatuses 200 in question (step S117). As a result, the generated session information Dᵢ is transmitted to the encrypting apparatus 100 and all the other key processing apparatuses 200.

### [Generation of Session Key]

The session information obtaining unit 111 of the encrypting apparatus 100 obtains all the session information Dᵢ transmitted from the key processing apparatuses 200 owned by the members U₂ to U. As a result, the encrypting apparatus 100 obtains totally n pieces of session information, i.e., session information D₁ to Dₙ including the session information D₁ generated by the encrypting apparatus 100. The member verification unit 113 of the encrypting apparatus 100 uses the session information D₁ to Dₙ and the published information to calculate the verification parameter z as shown in Expression 105 (step S119).

Likewise, each of the key processing apparatuses 200 owned by the members U₂ to Uₙ obtains totally n pieces of session information, i.e., the session information D₁ to Dₙ, including the session information D₁ and the session information Dᵢ obtained from the key processing apparatuses 200 owned by the members U₂ to Uₙ other than the member U₁. The member verification unit 213 of each of the key processing apparatuses 200 owned by the members U₂ to Uₙ uses the session information D₁ to Dₙ and the published information to calculate the verification parameter z according to Expression 203 (step S121).

Subsequently, the member verification unit 113 of the encrypting apparatus 100 performs calculation using the calculated verification parameter z to determine whether Expression 106 explained above holds or not (step S123). Likewise, the member verification unit 213 of each of the key processing apparatuses 200 owned by the members U₂ to Uₙ performs calculation using the calculated verification parameter z to determine whether Expression 204 explained above holds or not (step S125). When it is determined that Expression 106 holds, the encrypting apparatus 100 determines that the n members who participated in to establish the session key K are all valid members. Likewise, when it is determined that Expression 204 holds, each of the key processing apparatuses 200 determines that the n members who participated in to establish the session key Kᵢ are all valid members. In other words, step S123 and step S125 in which a determination is made as to whether Expressions 106 and 204 hold or not are steps for verifying the validity of the members.

Only when Expression 106 holds, the session key generation unit 115 of the encrypting apparatus 100 owned by the member U₁ calculates the session key K according to Expression 107 explained above (step S127). Likewise, only when Expression 204 holds, the session key generation unit 215 of each of the key processing apparatuses 200 owned by the members U₂ to Uₙ calculates the session key K according to Expression 205 explained above (step S129).

According to the above procedure, the apparatuses can share the session key K used in the simultaneous communication, whereby the plurality of participants can start the simultaneous communication (step S131).

As described above, in the method for generating session key according to the present embodiment, the session information transmitted from each member includes a value relying on the private key unique to the member. When each apparatus verifies the members, each apparatus verifies the session information using the public keys of the members. Even if the member Uᵢ does not participate in the protocol, the other members can obtain the value of the temporary key r but cannot obtain the private key Sᵢ of the member Uᵢ. Therefore, in the method for generating session key according to the present embodiment, the other members cannot generate session information that can pass the verification using the public key of Uᵢ, as in the methods described in the fundamental techniques. As a result, this prevents attacks from the members, and improve the security.

In the method for generating session key according to the present embodiment, the value using the private key Sᵢ of the member U₁ (i.e., the value Yᵢ as shown in Expression 103) is generated as the value transmitted by the member Uᵢ. Therefore, the members can be verified using the public key Qᵢ of the member Uᵢ. At this occasion, the values to be verified include not only kᵢP_{pub} but also H₂(r∥L). In other words, when any one of the members uses, as the value r, a value different from the other members, the expression used in the above verification does not hold. This enables the members participating in the simultaneous communication to recognize that the session key has not been successfully shared. As described above, the method for generating session key according to the present embodiment not only prevents spoofing of the members but also prevents excluding a particular member from the simultaneous communication.

### <The Amount of Calculation in the Method for Generating Session Key>

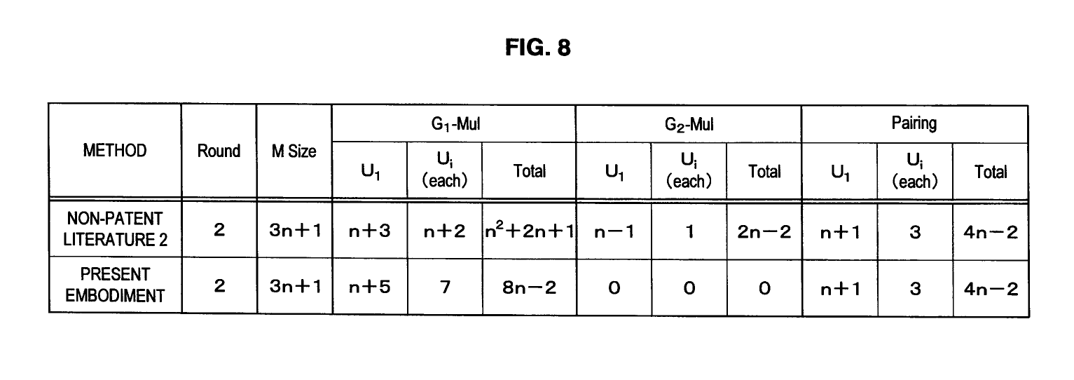

Subsequently, the amount of calculation in the method for generating session key according to the present embodiment will be considered with reference to FIG. 8. FIG. 8 is an explanatory diagram illustrating session key generation processing according the present embodiment.

In FIG. 8, the method for generating session key according to the present embodiment and the method described in Non-Patent Literature 2, i.e., the fundamental technique, are compared in terms of the amount of calculation and the like. In FIG. 8, “M Size” denotes the amount of a message. “G₁-Mul” denotes the number of multiplications in the group G₁. “G₂-Mul” denotes the number of multiplications in the group G₂. In the figure, “n” denotes the number of members. In the figure, “U₁” denotes the amount of calculation of the initiator. “Uᵢ (each)” denotes the amount of calculation needed in each of (n−1) users other than the initiator. In the figure, “Total” denotes the total amount of calculation of all the n members.

As is evident from FIG. 8, the method according to the present embodiment and the method described in Non-Patent Literature 2 are the same in the loads relating to the number of rounds, the amount of a message, and the number of pairings. On the other hand, the method described in Non-Patent Literature 2 requires totally (n²+2n+1) multiplications in the group G₁, whereas the method according to the present embodiment requires only (8n−2) multiplications in the group G₁. This means that, in the method described in Non-Patent Literature 2, the amount of calculation is proportional to the square of the number n of the members, whereas in the method according to the present embodiment, the amount of calculation is proportional to the number n of the members. Therefore, the larger the number n of the members becomes, the more greatly the calculation load is suppressed in the method according to the present embodiment. Likewise, the method described in Non-Patent Literature 2 requires (2n−2) multiplications in the group G₂, whereas the method according to the present embodiment requires no multiplication in the group G₂. Therefore, the calculation load can be reduced in a similar manner.

### Second Embodiment

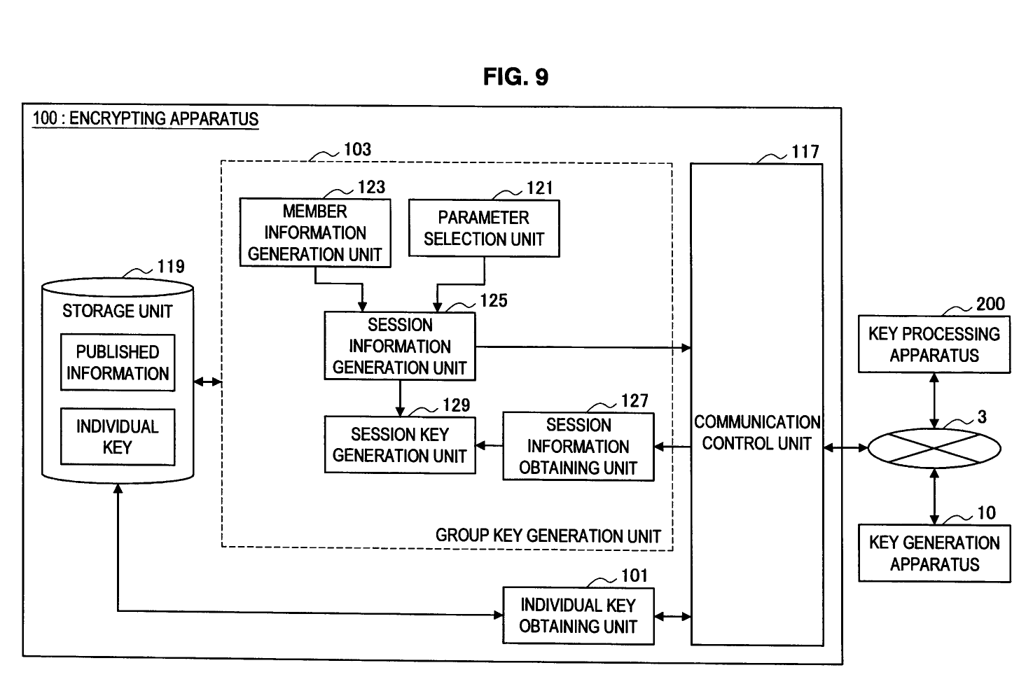

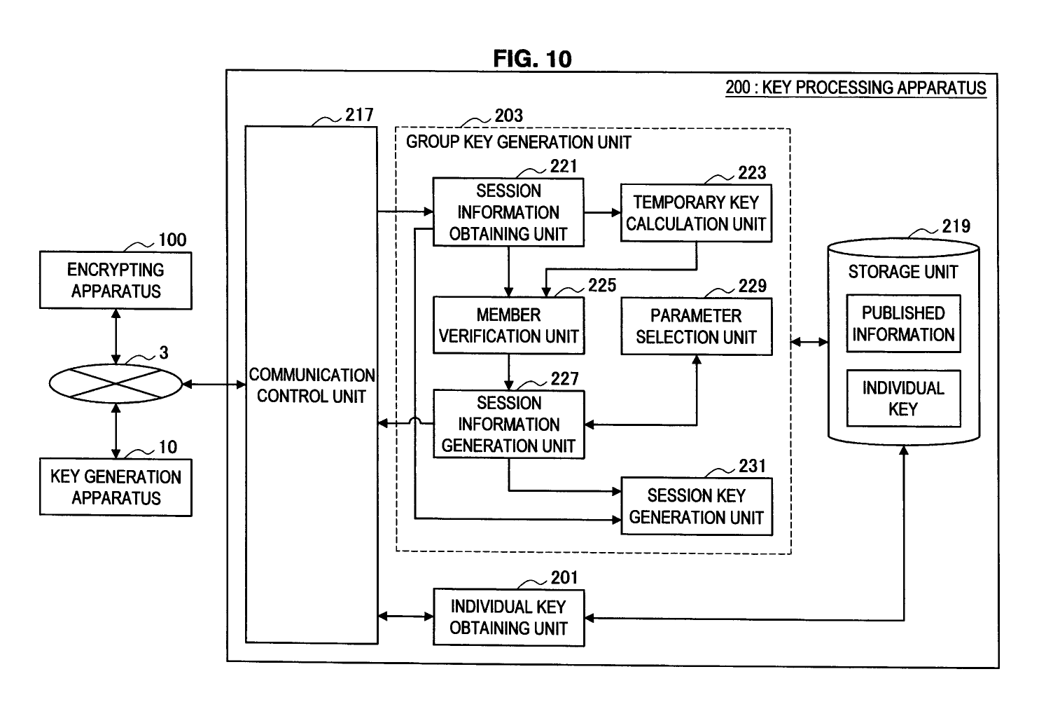

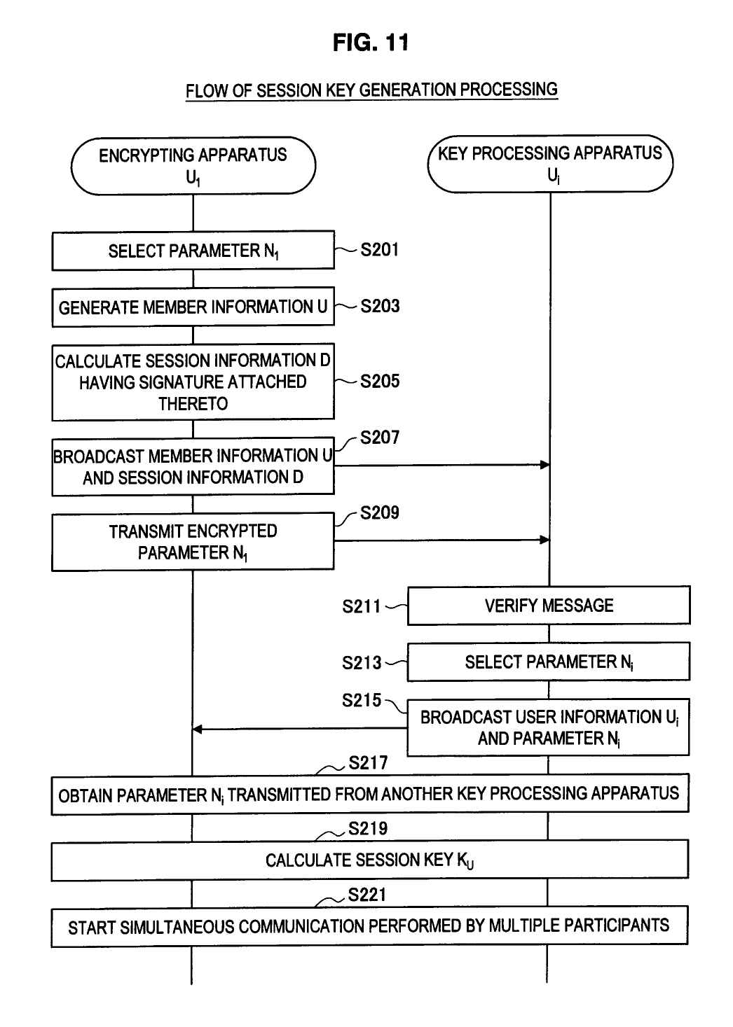

Subsequently, a key sharing system according to the second embodiment of the present invention will be explained in detail with reference to FIGS. 9 to 11. FIG. 9 is a block diagram illustrating a configuration of an encrypting apparatus 100 according to the present embodiment. FIG. 10 is a block diagram illustrating a configuration of a key processing apparatus 200 according to the present embodiment. FIG. 11 is a flow diagram illustrating session key generation processing according to the present embodiment.

Like the method described in Non-Patent Literature 3, it is assumed that the key sharing system according to the present embodiment causes a key generation apparatus 10 in a system to generate various kinds of system parameters and individual keys of members. Accordingly, the key generation apparatus 10 publishes system parameters including hash functions, an encryption function E and a decryption function D of public key cryptographic method, a signature generation function S and a signature verification function V of digital signature method. It is considered that each of the apparatuses owned by the users Uᵢ stores a published encryption key eᵢ, a secret decryption key dᵢ, a secret signature generation key sᵢ, a published signature verification key v₁, and the like of the user Uᵢ, and the published encryption key eᵢ and published signature verification key vᵢ are shared by the members Uᵢ.

### <Configuration of Encrypting Apparatus>

First, the configuration of the encrypting apparatus 100 according to the present embodiment will be explained in detail with reference to FIG. 9.

The encrypting apparatus 100 according to the present embodiment is an apparatus operated by the initiator who starts processing for generating a session key used in a simultaneous communication. In the explanation below, the encrypting apparatus 100 is assumed to be owned by the member U₁. For example, as shown in FIG. 9, the encrypting apparatus 100 according to the present embodiment mainly includes an individual key obtaining unit 101, a group key generation unit 103, a communication control unit 117, and a storage unit 119.

In this case, the individual key obtaining unit 101, the communication control unit 117, and the storage unit 119 according to the present embodiment have the same configurations as the processings units according to the first embodiment of the present invention, and achieve the same effects. Therefore, in the explanation below, the detailed description is omitted.

The group key generation unit 103 is achieved with, for example, a CPU, a ROM, a RAM, and the like. The group key generation unit 103 as well as the key processing apparatus 200 generate a group key used for a simultaneous communication by using the individual key stored in the encrypting apparatus 100, the public key of the member who performs the simultaneous communication, the published information, and the information obtained from the key processing apparatuses 200. For example, as shown in FIG. 9, the group key generation unit 103 further includes a parameter selection unit 121, a member information generation unit 123, and a session information generation unit 125. In addition, the group key generation unit 103 further includes a session information obtaining unit 127 and a session key generation unit 129.

The parameter selection unit 121 is achieved with, for example, a CPU, a ROM, a RAM, and the like. The parameter selection unit 121 selects a parameter N₁ having a predetermined number of bits used as a temporary key in the simultaneous communication. The parameter selection unit 121 transmits the selected parameter to the session information generation unit 125.

The parameter selection unit 121 may associate the selected parameter with, e.g., information representing a date/time when the selection is made, and store the selected parameter, the information representing the date/time, together with history information and the like, to the storage unit 119 and the like.

The member information generation unit 123 is achieved with, for example, a CPU, a ROM, a RAM, and the like. The member information generation unit 123 generates member information U including information about the members Uᵢ (i=2, n) participating in the simultaneous communication. By referring to the member information U, the encrypting apparatus 200 can identify the member Uᵢ participating in the simultaneous communication. The member information generation unit 123 transmits the generated member information U to the session information generation unit 125.

The member information generation unit 123 may associate the generated member information with, e.g., information representing a date/time when the member information is generated, and store the generated member information, the information representing the date/time, together with history information and the like, to the storage unit 119 and the like.

The session information generation unit 125 is achieved with, for example, a CPU, a ROM, a RAM, and the like. The session information generation unit 125 generates session information D having a signature attached thereto, on the basis of various kinds of parameters transmitted from the parameter selection unit 121, the member information U transmitted from the member information generation unit 123, and the published information.

More specifically, first, the session information generation unit 125 generates a message represented by Expression 111 below as the session information D.

[Numerical expression 42]

D=(E(e₂,N₁), . . . , E(eₙ,N₁),h(N₁)) (Expression 111)

As can be seen from Expression 111 above, the session information D includes a set obtained by encrypting the parameter N₁ selected by the parameter selection unit 121 using the published encryption keys eᵢ of the users Uᵢ and a hash value obtained by converting the parameter N₁ using the hash function h, i.e., the published information.

Thereafter, the session information generation unit 125 attaches, to the generated session information D, a signature represented by Expression 112 below using the signature generation function S, i.e., the published information, and the secret signature generation key sₗ of the user U₁.

[Numerical expression 43]

S(s₁,(E(e₂,N₁), . . . , E(eₙ,N₁),h(N₁))) (Expression 112)

When the session information generation unit 125 generates the session information D and the signature attached to the session information D, the session information generation unit 125 requests the communication control unit 117 to broadcast the session information D, the signature attached to the session information D, and the member information U. When the session information generation unit 125 generates the parameter N₁ encrypted so as to be transmitted to each member Uᵢ, the session information generation unit 125 requests the communication control unit 117 to transmit the encrypted parameter N₁.

Further, the session information generation unit 125 transmits the parameter N1 used for generation of the session information to the session key generation unit 129. It should be noted that the parameter N₁ may be directly transmitted from the parameter selection unit 121 to the session key generation unit 129, or the session key generation unit 129 may obtain the parameter N₁ temporarily stored in the storage unit 119 and the like.

The session information obtaining unit 127 is achieved with, for example, a CPU, a ROM, a RAM, and the like. The session information obtaining unit 127 obtains the session information Dᵢ transmitted from all of the key processing apparatuses 200 via the communication control unit 117. The session information D, includes the user information U₁, i.e., information for identifying a user who owns the key processing apparatus 200, and the parameter Nᵢ selected by the key processing apparatus 200.

The session information obtaining unit 127 transmits all the obtained session information Dᵢ to the session key generation unit 129. The session information obtaining unit 127 may associate the obtained session information Dᵢ with, e.g., information representing a date/time when the session information Dᵢ is obtained, and store the obtained session information Dᵢ, the information representing the date/time, together with history information and the like, to the storage unit 119 and the like.

The session key generation unit 129 is achieved with, for example, a CPU, a ROM, a RAM, and the like. The session key generation unit 129 uses the parameter N₁ transmitted from the session information generation unit 125, the parameter Nᵢ transmitted from the session information obtaining unit 127, and the published information to generate session key K_{U} used for a simultaneous communication.

More specifically, the session key generation unit 129 generates the session key K_{U} on the basis of Expression 113 below using the published hash function h and the obtained parameters N₁ to Nₙ.

[Numerical expression 44]

K_{U}=h(N₁∥N₂∥ . . . ∥Nₙ) (Expression 113)

By using the session key K_{U} thus generated, the encrypting apparatus 100 and the plurality of key processing apparatuses 200 can securely perform the simultaneous communication.

The session key generation unit 129 may associate the generated session key K_{U} with, e.g., information representing a date/time when the session key K_{U} is generated, and store the generated session key K, the information representing the date/time, together with history information and the like, to the storage unit 119 and the like.

Examples of the functions of the encrypting apparatus 100 according to the present embodiment have been hereinabove explained. Each of the above constituent elements may be structured using a general-purpose member and a circuit, or may be structured by hardware dedicated to the function of each constituent element. Alternatively, the function of each constituent element may be carried out by a CPU and the like. Therefore, the used configuration may be changed as necessary in accordance with the state of the art at the time when the present embodiment is carried out.

It is possible to make a computer program for realizing the functions of the above-described encrypting apparatus according to the present embodiment, and the computer program can be implemented on a personal computer and the like. Further, a computer-readable recording medium storing such computer program can be provided. Examples of the recording medium include a magnetic disk, an optical disk, a magneto-optical disk, and a flash memory. Further, the above computer program may be distributed by, for example, a network, without using the recording medium.

### <Configuration of Key Processing Apparatus>

Subsequently, a configuration of the key processing apparatus 200 according to the present embodiment will be explained in detail with reference to FIG. 10.

The key processing apparatus 200 according to the present embodiment is an apparatus used by members Uᵢ (i=2, n) other than the user of the encrypting apparatus 100 (member U₁), i.e., the initiator of the simultaneous communication. For example, as shown in FIG. 10, the key processing apparatus 200 according to the present embodiment mainly includes an individual key obtaining unit 201, a group key generation unit 203, a communication control unit 217, and a storage unit 219.

In this case, the individual key obtaining unit 201, the communication control unit 217, and the storage unit 219 according to the present embodiment have the same configurations as the processings units according to the first embodiment of the present invention, and achieve the same effects. Therefore, in the explanation below, the detailed description thereabout is omitted.

The group key generation unit 203 is achieved with, for example, a CPU, a ROM, a RAM, and the like. The group key generation unit 203 as well as the above apparatus generate a group key used for a simultaneous communication by using the individual key stored in the key processing apparatus 200, the public key of the member who performs the simultaneous communication, the published information, and the information obtained from the encrypting apparatus 100 and the other key processing apparatuses 200. For example, as shown in FIG. 10, the group key generation unit 203 further includes a session information obtaining unit 221, a temporary key calculation unit 223, a member verification unit 225, a session information generation unit 227, a parameter selection unit 229, and a session key generation unit 231.

The session information obtaining unit 221 is achieved with, for example, a CPU, a ROM, a RAM, and the like. The session information obtaining unit 221 obtains various kinds of information about the session information D transmitted from the encrypting apparatus 100 and the session information Dᵢ transmitted from the other key processing apparatuses 200 participating in the simultaneous communication, which is different from the session information D transmitted from the encrypting apparatus 100. More specifically, the session information obtaining unit 221 obtains the encrypted parameter N₁ and the session information D having the signature attached thereto transmitted from the encrypting apparatus 100, via the communication control unit 217. Further, the session information Dᵢ obtained by the session information obtaining unit 221 includes the user information Uᵢ, i.e., information for identifying a user who owns another key processing apparatus 200, and the parameter N₁ selected by the key processing apparatus 200.

When the session information obtaining unit 221 receives the encrypted parameter N₁, the session information obtaining unit 221 transmits the encrypted parameter N₁ to the temporary key calculation unit 223. Further, the session information obtaining unit 221 transmits, to the member verification unit 225, the session information D having the signature attached thereto which is broadcast from the encrypting apparatus 100.

When the session information obtaining unit 221 obtains the session information Dᵢ which is broadcast from each of the other key processing apparatuses 200, the session information obtaining unit 221 transmits each of the obtained session information Dᵢ to the session key generation unit 231.

The session information obtaining unit 221 may associate the obtained session information with, e.g., information representing a date/time when the session information is obtained, and store the session information, the information representing the date/time, together with history information and the like, to the storage unit 219 and the like.

The temporary key calculation unit 223 is achieved with, for example, a CPU, a ROM, a RAM, and the like. When the temporary key calculation unit 223 receives the information about the encrypted parameter N₁ from the session information obtaining unit 221, the temporary key calculation unit 223 decrypts the encrypted information and obtains the value of the parameter N₁. Since the encrypted information is encrypted using the published encryption key eᵢ of the user Uᵢ who owns the key processing apparatus 200, each key processing apparatus 200 can decrypt the cipher text using the stored secret decryption key dᵢ. In this case, the parameter N₁ is considered to be a temporary key temporarily used in the simultaneous communication. The temporary key calculation unit 223 transmits the parameter N₁ obtained as a result of the decryption to the member verification unit 225.

The temporary key calculation unit 223 may associate the parameter N₁, i.e., the calculated temporary key with, e.g., information representing a date/time when the parameter N₁ is calculated, and store the parameter N₁, the information representing the date/time, together with history information and the like, to the storage unit 219 and the like.

The member verification unit 225 is achieved with, for example, a CPU, a ROM, a RAM, and the like. The member verification unit 225 verifies the digital signature (attached to the session information D which is broadcast from the encrypting apparatus 100) transmitted from the session information obtaining unit 221. The digital signature can be verified using the published signature verification key v₁ of the initiator Uᵢ stored in the encrypting apparatus 100. This verification processing allows confirming that the digital signature transmitted from the initiator U₁ is the valid digital signature of the user U₁. Further, the member verification unit 225 independently calculates h(N₁) by using the parameter N₁ transmitted from the temporary key calculation unit 223 and the published hash function h. Thereafter, the member verification unit 225 verifies whether the value calculated from h(N₁) is the same as the value h(N₁) included in the session information D transmitted from the session information obtaining unit 221.

When the calculated value is the same as the value included in the session information D, and the digital signature is determined to be valid, the member verification unit 225 determines that the obtained session information is transmitted from the valid member (i.e., the valid initiator). In this case, the member verification unit 225 transmits, to the session information generation unit 227, a verification result indicating that the session information D is transmitted from the valid member.

When the digital signature is determined not to be valid, or the value calculated from h(N₁) is not the same as the value included in the session information D, the member verification unit 225 determines that the obtained session information D is not transmitted from the valid member. As a result, the key processing apparatus 200 finishes the processing for generating session key.

The session information generation unit 227 is achieved with, for example, a CPU, a ROM, a RAM, and the like. When the session information generation unit 227 receives from the member verification unit 225 the notification indicating that the obtained session information has been successfully verified, the session information generation unit 227 requests the parameter selection unit 229 to select a parameter Nᵢ. When the parameter selection unit 229 notifies the parameter Nᵢ, the session information generation unit 227 broadcasts the user information Uᵢ for identifying the user Uᵢ who owns the key processing apparatus 200 and the selected parameter Nᵢ to the other members via the communication control unit 217. The user information U, and the parameter Nᵢ correspond to the session information D, transmitted from the key processing apparatus 200 owned by the user Uᵢ. A member whose user information Uᵢ and parameter Nᵢ are transmitted is identified by referring to the member information U transmitted from the encrypting apparatus 100.

When the session information Dᵢ has been transmitted, the session information generation unit 227 transmits the parameter Nᵢ selected by the parameter selection unit 229 and the parameter N₁ calculated by the temporary key calculation unit 223 to the session key generation unit 231. Alternatively, the parameter Nᵢ may be transmitted to the session key generation unit 231 by the parameter selection unit 229 explained later. Still alternatively, the parameter N₁ may be transmitted to the session key generation unit 231 by the temporary key calculation unit 223.

The parameter selection unit 229 is achieved with, for example, a CPU, a ROM, a RAM, and the like. When the parameter selection unit 229 receives a request from the session information generation unit 227, the parameter selection unit 229 selects a parameter Nᵢ having a predetermined number of bits used as a portion of the session information Dᵢ. The parameter selection unit 229 transmits the selected parameter to the session information generation unit 227.

The parameter selection unit 229 may associate the selected parameters with, e.g., information representing a date/time when the selection is made, and store the selected parameters, the information representing the date/time, together with history information and the like, to the storage unit 219 and the like.

The session key generation unit 231 is achieved with, for example, a CPU, a ROM, a RAM, and the like. The session key generation unit 231 uses the parameters N₁ and Nᵢ, the parameters N₁ transmitted from the other key processing apparatuses 200, and the published information to generate the session key K_{U} used for a simultaneous communication.

More specifically, the session key generation unit 231 generates the session key K_{U} on the basis of Expression 211 below using the published hash function h and the obtained parameters N₁ to Nₙ.

[Numerical expression 45]

K_{U}=h(N₁∥N₂∥ . . . ∥Nₙ) (Expression 211)

By using the session key K_{U} thus generated, the key processing apparatus 200 can securely perform the simultaneous communication with the encrypting apparatus 100 and the other key processing apparatuses 200.

The session key generation unit 231 may associate the generated session key K_{U} with, e.g., information representing a date/time when the session key is generated, and store the generated session key K_{U}, the information representing the date/time, together with history information and the like, to the storage unit 219 and the like.

Examples of the functions of the key processing apparatus 200 according to the present embodiment have been hereinabove explained. Each of the above constituent elements may be structured using a general-purpose member and a circuit, or may be structured by hardware dedicated to the function of each constituent element. Alternatively, the function of each constituent element may be carried out by a CPU and the like. Therefore, the used configuration may be changed as necessary in accordance with the state of the art at the time when the present embodiment is carried out.

It is possible to make a computer program for realizing the functions of the above-described key processing apparatus according to the present embodiment, and the computer program can be implemented on a personal computer and the like. Further, a computer-readable recording medium storing such computer program can be provided. Examples of the recording medium include a magnetic disk, an optical disk, a magneto-optical disk, and a flash memory. Further, the above computer program may be distributed by, for example, a network, without using the recording medium.

It should be noted that the encrypting apparatus 100 may also have the functions of the key processing apparatus 200. Alternatively, the key processing apparatus 200 may also have the functions of the encrypting apparatus 100. In a certain simultaneous communication, the key processing apparatus 200 may also serve as the initiator (i.e., the encrypting apparatus 100) to start the protocol according to the present embodiment. Alternatively, in a certain a simultaneous communication, the encrypting apparatus 100 may also serve as an apparatus used by another participating member to perform the functions of the key processing apparatus 200.

### <Method for Generating Session Key>

Subsequently, a method for generating session key, including the encrypting method performed by the encrypting apparatus 100 according to the present embodiment and the key processing method performed by the key processing apparatus 200, will be explained in detail with reference to FIG. 11. FIG. 11 are flow diagrams illustrating session key generation processing according to the present embodiment.

In the explanation below, it is assumed that one encrypting apparatus 100 and (n−1) key processing apparatuses 200 try to achieve simultaneous communication therebetween. In the method according to the present embodiment, any one of n members U₁, U₂, . . . , Uₙ is a protocol initiator (which may be hereinafter also referred to as an initiator). In the explanation below, the member U₁ is assumed to be the initiator for the sake of brevity.

First, the parameter selection unit 121 of the encrypting apparatus 100 owned by the member U₁, i.e., the initiator, selects a parameter N₁ used as a temporary key (step S201), and transmits the parameter N₁ to the session information generation unit 125.

Subsequently, the member information generation unit 123 of the encrypting apparatus 100 generates the member information U including information about the members Uᵢ (i=2, n) participating in the simultaneous communication (step S203). When the member information generation unit 123 has generated the member information U, the member information generation unit 123 transmits the generated member information U to the session information generation unit 125.

While the session information generation unit 125 refers to the member information U, the session information generation unit 125 uses the published encryption key eᵢ of the user Uᵢ to generate the parameter N₁ (i.e., E(eᵢ, N₁)) encrypted for each member Uᵢ. The session information generation unit 125 generates session information D having a signature attached thereto, on the basis of the parameters transmitted from the parameter selection unit 121, the member information U transmitted from the member information generation unit 123, and the published information (step S205). The session information D having the signature attached thereto is generated based on Expression 111 and Expression 112 explained above.

Subsequently, the session information generation unit 125 broadcasts the member information U and the session information D having the signature attached thereto to the key processing apparatuses 200 via the communication control unit 117 (step S207).

Thereafter, the session information generation unit 125 transmits the encrypted parameter N₁ to the key processing apparatuses 200 via the communication control unit 117 (step S209).

When the session information obtaining unit 221 of each of the key processing apparatuses 200 owned by the members U₂ to Uₙ receive the session information D and the encrypted parameter N₁, the key processing apparatus 200 first verifies the obtained message (session information D) (step S211). The message is verified by the member verification unit 225 by using the parameter N₁ calculated by the temporary key calculation unit 223 and the session information D having the signature attached thereto obtained by the session information obtaining unit 221.

When the result of the verification processing provided by the member verification unit 225 indicates that the message is not determined to be valid, the key processing apparatus 200 stops the processing for generating session key. On the other hand, the result of the verification processing provided by the member verification unit 225 indicates that the message is determined to be valid, the session information generation unit 227 requests the parameter selection unit 229 to select a parameter Nᵢ. As a result, the parameter selection unit 229 randomly selects a parameter Nᵢ (step S213). The parameter selection unit 229 notifies the selected parameter Nᵢ to the session information generation unit 227.

Thereafter, the session information generation unit 227 broadcasts the user information Uᵢ for identifying the user U, who owns the key processing apparatus 200 and the selected parameter Nᵢ to the other members including the encrypting apparatus 100 via the communication control unit 217 (step S215).

The session information obtaining unit of the key processing apparatus 200 and the encrypting apparatus 100 obtains the parameter Nᵢ and the like transmitted from the other key processing apparatuses 200 (step S217). As a result, all the (n−1) key processing apparatuses 200 have broadcast the user information Uᵢ and the parameter N₁, and totally n parameters from N₁ to Nₙ are obtained.

Thereafter, the session key generation unit 129 of the key processing apparatus 200 and the encrypting apparatus 100 calculate the session key K_{U} using the n parameters from N₁ to Nₙ (step S219). According to the above procedure, the apparatuses can share the session key K_{U} used in the simultaneous communication, whereby the plurality of participants can start the simultaneous communication (step S221).

As described above, in the method for generating session key according to the present embodiment, the digital signature based on the secret signature generation key owned by the initiator U₁ is attached to the parameter N₁ selected by the encrypting apparatus 100 owned by the initiator U₁. When the key processing apparatus 200 verifies the message transmitted from the initiator Uᵢ, the key processing apparatus 200 verifies the session information D transmitted from the initiator U₁ using the published signature verification key. This prevents the initiator from transmitting a different value of the parameter N₁ to only a particular member.

### Third Embodiment

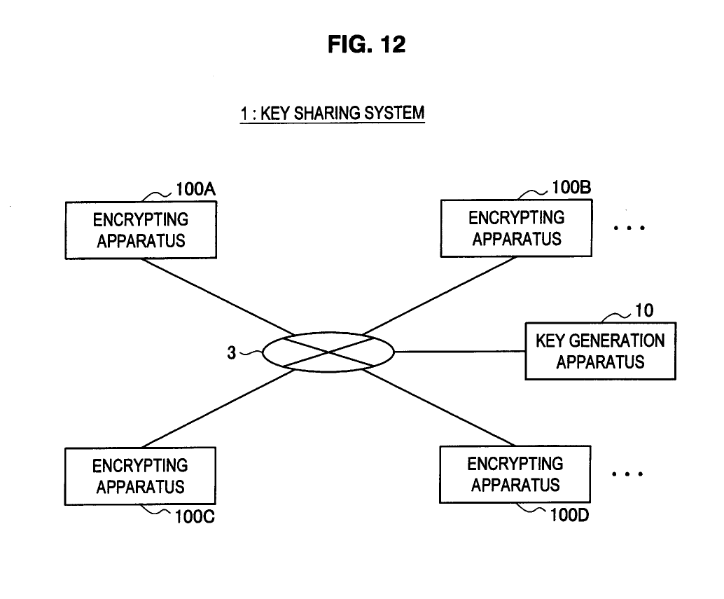

Subsequently, a key sharing system according to the third embodiment of the present invention will be explained in detail with reference to FIGS. 12 to 16.

### <Key Sharing System>

First, the key sharing system according to the present embodiment will be explained in detail with reference to FIG. 12. FIG. 12 is an explanatory diagram illustrating the key sharing system according to the present embodiment.

For example, as shown in FIG. 12, a key sharing system 1 according to the present embodiment mainly includes a key generation apparatus 10 and a plurality of encrypting apparatuses 100A, 100B, 100C, 100D . . . . These apparatuses are connected with each other via a communication network 3.

The communication network 3 is a communication circuit network connecting between the key generation apparatus 10 and the encrypting apparatuses 100, so as to enable bidirectional communication or one way communication. The communication network 3 is the same as the communication network 3 according to the first embodiment of the present invention. Therefore, the detailed description thereabout is omitted.

The key generation apparatus 10 generates a public key and a private key unique to each encrypting apparatus 100. The key generation apparatus 10 publishes the public keys, and distributes the public keys and the private keys to the apparatuses via a secure communication path. Further, the key generation apparatus 10 generates not only the public key and the private key but also a signature generation key and a signature verification key unique to each encrypting apparatus 100, and distributes the signature generation key and the signature verification key to each apparatus via a secure communication path. Further, the key generation apparatus 10 publishes, as system parameters, parameters which can be published and used in the key sharing system 1 according to the present embodiment. It should be noted that the key generation apparatus 10 may be owned by a center and the like that generates and manages the public keys and the private keys.

The encrypting apparatus 100 uses the public keys, the private keys, the signature generation key, the signature verification key, the published system parameters, and the like to encrypt information for generating a session key required in a simultaneous communication performed between the plurality of encrypting apparatuses 100. Further, the encrypting apparatus 100 transmits the encrypted information for generating the session key to the other encrypting apparatuses 100 via the communication network 3. Therefore, the encrypting apparatuses 100 can share the session key needed for the simultaneous communication. This encrypting apparatus 100 may be owned by any third party. Alternatively, the encrypting apparatus 100 may be owned by the owner of the key generation apparatus 10.

The encrypting apparatus 100 may be a computer device (it may be either notebook type or desktop type) such as a personal computer (PC). Alternatively, the encrypting apparatus 100 may be any apparatus as long as it has a communication function by way of a network. Examples of these apparatuses include a PDA (Personal Digital Assistant), a home game machine, a DVD/HDD recorder, an information appliance such as a television receiver, and a tuner and a recorder for television broadcast. Examples of these apparatuses further include a portable device that can be carried by a subscriber, such as a potable game machine, a portable telephone, a portable video/audio player, a PDA, and a PHS.

In FIG. 12, only four encrypting apparatuses 100 are shown. However, in the key sharing system 1 according to the present embodiment, the number of encrypting apparatuses is not limited to the example as shown in FIG. 12.

### <Configuration of Key Generation Apparatus>

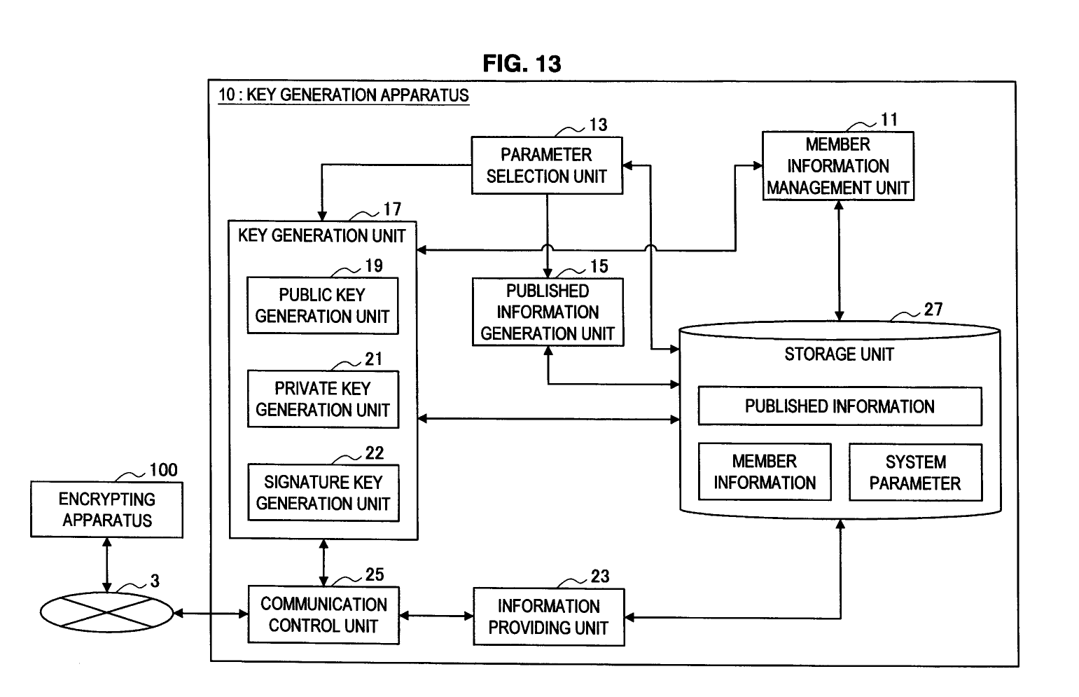

Subsequently, a configuration of the key generation apparatus 10 according to the present embodiment will be explained in detail with reference to FIG. 13. For example, as shown in FIG. 13, the key generation apparatus 10 according to the present embodiment mainly includes a member information management unit 11, a parameter selection unit 13, a published information generation unit 15, a key generation unit 17, an information providing unit 23, a communication control unit 25, and a storage unit 27.

The member information management unit 11 is achieved with, for example, a CPU, a ROM, a RAM, and the like. The member information management unit 11 manages the information about the members for which members' individual keys are generated by the key generation apparatus 10 according to the present embodiment, wherein the member's individual key includes a public key and a private key. For example, the member information is recorded to the storage unit 27.

The parameter selection unit 13 is achieved with, for example, a CPU, a ROM, a RAM, and the like. The parameter selection unit 13 selects an order q, two groups G₁, G₂ of the order q, and a bilinear map e, according to a predetermined method. Subsequently, the parameter selection unit 13 selects a parameter Pε_{R}G₁ and a parameter sε_{R}Z_{q}*, and uses these parameters to calculate P_{pub}=sP. This parameter P is also referred to as a random generator. On the other hand, the parameter s is secretly saved as a master private key.

In addition, the parameter selection unit 13 selects four kinds of hash functions, i.e., H₁, H₂, H₃, H₄.

### H₁: {0, 1}*→G₁

### H₂:G₂→>{0, 1}^{t}

H₃:{0, 1}^{t}→{0, 1}^{t}

### H₄:Z₄*→{0, 1}^{t}

In this case, in the hash function H₄, t denotes an output length of the hash function. For example, t is set to 160 (i.e., output length 160 bits).

The published information generation unit 15 is achieved with, for example, a CPU, a ROM, a RAM, and the like. The published information generation unit 15 selects those that may be published as published information (published system parameters) from among various kinds of parameters and hash functions selected by the parameter selection unit 13, and adopts them as published information. More specifically, the published information generation unit 15 generates a combination of <e, G₁, G₂, q, P, P_{pub}, H₁, H₂, H₃, H₄> as the published information, and stores the published information to the storage unit 27.

The key generation unit 17 is achieved with, for example, a CPU, a ROM, a RAM, and the like. When a member using the key sharing system 1 according to the present embodiment requests the key generation unit 17 to generate a member's individual key including a public key and a private key, the key generation unit 17 generates the individual key. When the key generation unit 17 generates the individual key, the key generation unit 17 generates a signature key which is used by a member to attach and verify a digital signature. When the key generation unit 17 generates the individual key and the signature key, the key generation unit 17 obtains IDs of the requesting member (such as a user ID and a mail address) from the member information management unit 11, and generates the key based on the obtained ID and the system parameters selected by the parameter selection unit 13. For example, as shown in FIG. 13, the key generation unit 17 further includes a public key generation unit 19, a private key generation unit 21, and a signature key generation unit 22.

The public key generation unit 19 is achieved with, for example, a CPU, a ROM, a RAM, and the like. The public key generation unit 19 generates a public key Qᵢ of a member i according to Expression 21 below using the ID (IDᵢ) of the requesting member and the hash functions H serving as the system parameter obtained from the member information management unit 11.

public key Qᵢ=H₁(IDᵢ) (Expression 21)

The public key generation unit 19 can associate the generated public key Qᵢ of the member Uᵢ with the corresponding member information of the member Uᵢ, and store the generated public key Qᵢ and the corresponding member information to the storage unit 27.

The private key generation unit 21 is achieved with, for example, a CPU, a ROM, a RAM, and the like. The private key generation unit 21 generates a private key Sᵢ of the member Uᵢ according to Expression 23 below using the master private key s and the public key Qᵢ generated by the public key generation unit 19.

private key Sᵢ=sQᵢ (Expression 23)

The private key generation unit 21 can associate the generated private key Sᵢ of the member Uᵢ with the corresponding member information of the member Uᵢ, and can store the generated private key Sᵢ and the corresponding member information to the storage unit 27.

As is evident from Expression 21, the public key of the member is generated from the published information and the ID of the member Uᵢ. In the key sharing system 1 according to the present embodiment, the ID of the member Uᵢ is information such as the user ID and the mail address. Therefore, any user can calculate the public key using the published information and the ID of the member Uᵢ. On the other hand, as is evident from Expression 23, the private key of the member Uᵢ is a value calculated using the master private key secretly stored in the key generation apparatus 10. Therefore, only the key generation apparatus 10 can generate the private key of the member Uᵢ.

The signature key generation unit 22 is achieved with, for example, a CPU, a ROM, a RAM, and the like. The signature key generation unit 22 generates a signature generation key skᵢ and a signature verification key vkᵢ unique to the member Uᵢ by using a digital signature technique capable of executing processing on any t-bit value.

The signature key generation unit 22 can associate the signature generation key skᵢ and the signature verification key vkᵢ of the member Uᵢ thus generated with the corresponding member information of the member Uᵢ, and can store the signature generation key skᵢ, the signature verification key vkᵢ, and the corresponding member information to the storage unit 27.

The information providing unit 23 is achieved with, for example, a CPU, a ROM, a RAM, and the like. In response to requests given by the encrypting apparatuses 100 according to the present embodiment, the information providing unit 23 provides these apparatuses with various kinds of information such as the published information and the public key of the member. When the information providing unit 23 provides the information, the information providing unit 23 can refer to various kinds of data stored in the storage unit 27.

The communication control unit 25 is achieved with, for example, a CPU, a ROM, a RAM, a communication device, and the like. The communication control unit 25 controls communication between the key generation apparatus 10 and the encrypting apparatus 100.

The storage unit 27 stores the member information managed by the member information management unit 11, the system parameters selected by the parameter selection unit 13, the published information generated by the published information generation unit 15, the individual keys generated by the key generation unit 17, and the like. The storage unit 27 may store, e.g., various parameters or progress of processing that are needed to be stored while the key generation apparatus 10 according to the present embodiment performs certain processing, and may store various kinds of databases and the like as necessary. The storage unit 27 may be freely read and written by the member information management unit 11, the parameter selection unit 13, the published information generation unit 15, the key generation unit 17, the information providing unit 23, the communication control unit 25, and the like.

Examples of the functions of the key generation apparatus 10 according to the present embodiment have been hereinabove explained. Each of the above constituent elements may be structured using a general-purpose member and a circuit, or may be structured by hardware dedicated to the function of each constituent element. Alternatively, the function of each constituent element may be carried out by a CPU and the like. Therefore, the used configuration may be changed as necessary in accordance with the state of the art at the time when the present embodiment is carried out.

It is possible to make a computer program for realizing the functions of the above-described key generation apparatus according to the present embodiment, and the computer program can be implemented on a personal computer and the like. Further, a computer-readable recording medium storing such computer program can be provided. Examples of the recording medium include a magnetic disk, an optical disk, a magneto-optical disk, and a flash memory. Further, the above computer program may be distributed by, for example, a network, without using the recording medium.

### <Configuration of Encrypting Apparatus>

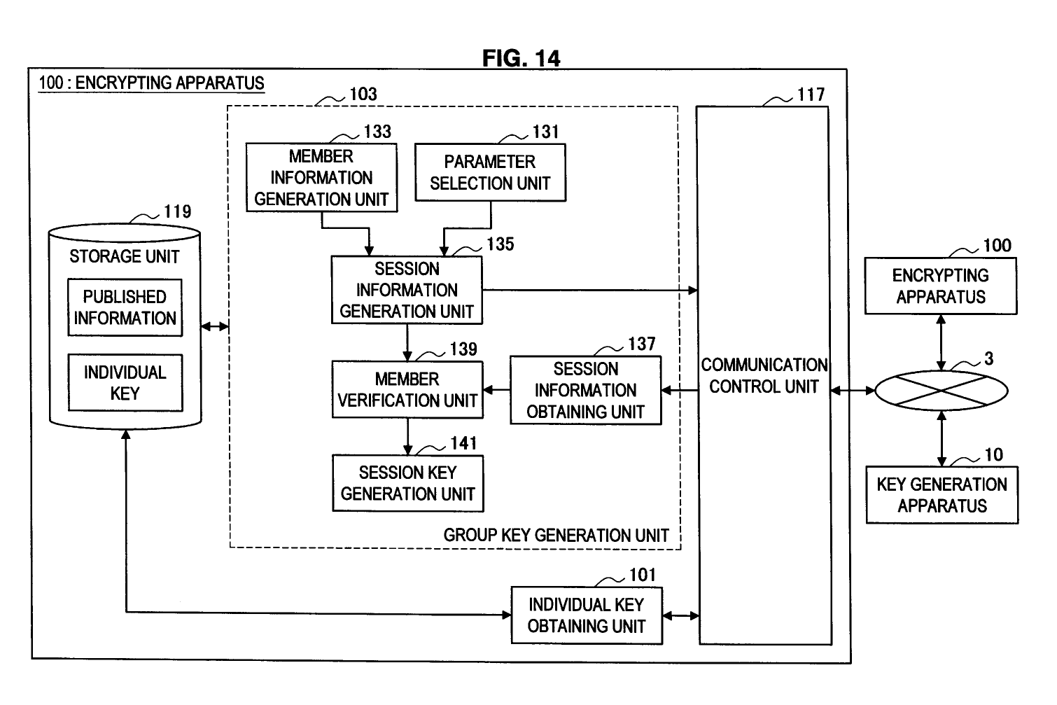

Subsequently, a configuration of the encrypting apparatus 100 according to the present embodiment will be explained in detail with reference to FIG. 14. FIG. 14 is a block diagram illustrating a configuration of the encrypting apparatus according to the present embodiment.

The encrypting apparatus 100 according to the present embodiment is an apparatus operated by a member who participates in a simultaneous communication. For example, as shown in FIG. 14, the encrypting apparatus 100 according to the present embodiment mainly includes an individual key obtaining unit 101, a group key generation unit 103, a communication control unit 117, and a storage unit 119.

The individual key obtaining unit 101 is achieved with, for example, a CPU, a ROM, a RAM, and the like. The individual key obtaining unit 101 obtains an individual key (i.e., a public key and a private key) previously assigned to a member who uses the encrypting apparatus 100 from the key generation apparatus 10 via the communication control unit 117. Further, when the individual key obtaining unit 101 obtains the individual key, the individual key obtaining unit 101 can also obtain the published information (published system parameters) from the key generation apparatus 10. For example, the individual key obtaining unit 101 stores the individual key and the published information thus obtained to the storage unit 119.

The group key generation unit 103 is achieved with, for example, a CPU, a ROM, a RAM, and the like. The group key generation unit 103 as well as the other encrypting apparatuses 100 generate a group key used for a simultaneous communication by using the individual key stored in the encrypting apparatus 100, the public key of the member who performs the simultaneous communication, the published information, and the information obtained from the other encrypting apparatuses 100. For example, as shown in FIG. 14, the group key generation unit 103 further includes a parameter selection unit 131, a member information generation unit 133, and a session information generation unit 135. In addition, the group key generation unit 103 further includes a session information obtaining unit 137, a member verification unit 139, and a session key generation unit 141.

The parameter selection unit 131 is achieved with, for example, a CPU, a ROM, a RAM, and the like. The parameter selection unit 131 selects a parameter δᵢε_{R}Z_{q}* and a parameter kᵢε_{R}Z_{q}* and a parameter rᵢ having t bits used as a temporary key in the simultaneous communication. The parameter selection unit 131 transmits the selected parameters to the member information generation unit 107 and the session information generation unit 135.

The parameter selection unit 131 may associate the selected parameters with, e.g., information representing a date/time when the selection is made, and store the selected parameters, the information representing the date/time, together with history information and the like, to the storage unit 119 and the like.

The member information generation unit 133 is achieved with, for example, a CPU, a ROM, a RAM, and the like. The member information generation unit 133 generates member information Pₜ^{j} as shown in Expression 121 below using the public key Qⱼ of the member Uⱼ(1≦j≦n, j≠i) participating in the simultaneous communication, the private key Sᵢ stored in the encrypting device 100, the temporary key rᵢ selected by the parameter selection unit 131, and the published information.

[Numerical expression 46]

Pᵢ^{j}=H₂(e(Sᵢ,Qⱼ)·δᵢ)⊕rᵢ (Expression 121)

In this case, in the Expression 121, H₂ denotes one of the published hash functions.

Further, the member information generation unit 107 also generates information L representing the order in which the member information Pᵢ^{j} are arranged so as to clarify the correspondence between the generated member information Pᵢ^{j} and the respective (n−1) members participating in the simultaneous communication.

The member information generation unit 133 transmits the generated member information Pᵢ^{j} and the information L representing the correspondence between the member information and the members to the session information generation unit 135.

The member information generation unit 133 may associate the generated member information with, e.g., information representing a date/time when the member information is generated, and store the generated member information, the information representing the date/time, together with history information and the like, to the storage unit 119 and the like.

The session information generation unit 135 is achieved with, for example, a CPU, a ROM, a RAM, and the like. The session information generation unit 135 generates session information Dᵢ of the member Uᵢ, on the basis of various kinds of parameters transmitted from the parameter selection unit 131, the member information Pᵢ^{j}, the information L about the correspondence transmitted from the member information generation unit 133, and the published information.

More specifically, first, the session information generation unit 135 calculates a value Vᵢ represented by Expression 122 below and a value Wᵢ represented by Expression 123 below. Thereafter, the session information generation unit 135 generates the session information D, represented by Expression 124 below using the calculated values and the like. This session information identifies simultaneous communication performed between the plurality of encrypting apparatuses 100, and is information used to generate the session key in the simultaneous communication.

[Numerical expression 47]

Vᵢ=H₃(rᵢ)⊕kᵢ (Expression 122)

Wᵢ=SIGᵢ(H₄(kᵢ)) (Expression 123)

Dᵢ=|δᵢ,Pᵢ¹, . . . , Pᵢⁱ⁻¹,Pᵢⁱ⁺¹, . . . , Pᵢⁿ,Vᵢ,Wᵢ,L [symbol] (Expression 124)

In Expression 123 above, SIGᵢ(x) denotes a digital signature generated for a message x using a signature generation key skᵢ.

The session information generation unit 135 attaches a digital signature to a random number kᵢ selected by the parameter selection unit 131 so as to prevent transmission of a modified random number kᵢ to a particular member. If the random number kᵢ is transmitted as a plain text, those other than the member can obtain the session key generated later. Therefore, the session information generation unit 135 makes a message by inputting kᵢ into the hash function H₄, i.e., the published information, and generates the session information Dᵢ using the signature generation key skᵢ, i.e., the private key unique to the member Uᵢ.

The session information generation unit 135 broadcasts the generated session information Dᵢ to the other encrypting apparatuses 100 via the communication control unit 117. Further, the session information generation unit 135 transmits the generated session information Dᵢ to the member verification unit 139. The session information generation unit 135 associates the generated session information Dᵢ with, e.g., information representing a date/time when the session information Dᵢ is generated, and store the generated session information Dᵢ, the information representing the date/time, together with history information and the like, to the storage unit 119 and the like.

The session information obtaining unit 137 is achieved with, for example, a CPU, a ROM, a RAM, and the like. The session information obtaining unit 137 obtains the session information Dᵢ transmitted from the other encrypting apparatuses 100 via the communication control unit 117.

The session information obtaining unit 137 transmits all of the obtained session information Dᵢ to the member verification unit 139. Further, the session information obtaining unit 137 may associate the obtained session information Dᵢ with, e.g., information representing a date/time when the session information Dᵢ is obtained, and store the obtained session information Dᵢ, the information representing the date/time, together with history information and the like, to the storage unit 119 and the like.

The member verification unit 139 is achieved with, for example, a CPU, a ROM, a RAM, and the like. The member verification unit 139 determines whether a member participating in the simultaneous communication is a valid member or not. More specifically, the member verification unit 139 verifies the member using the individual key of the encrypting apparatus 100, the parameter selected by the encrypting apparatus 100 owned by the member, and the session information Dⱼ obtained from the other encrypting apparatuses 100.

When the member verification unit 139 obtains the session information Dⱼ transmitted from the other encrypting apparatuses 100, the member verification unit 139 refers to the information L included in the obtained session information Dⱼ, and detects the Pⱼⁱ corresponding to the encrypting apparatus 100 from among the session information Dⱼ. Subsequently, the member verification unit 139 calculates a value kⱼ′ represented by Expression 125 below.

[Numerical expression 48]

k′ⱼ=H₃(H₂(e(Qⱼ,Sᵢ)·δⱼ)⊕Pⱼⁱ)|Vⱼ (Expression 125)

Subsequently, the member verification unit 139 calculates H₄(kⱼ′) using the calculated kⱼ′ and the hash function H₄ serving as the published information. Thereafter, the member verification unit 139 uses the signature verification key vkⱼ of the member Uⱼ to determine whether Wⱼ included in the session information Dⱼ is a valid digital signature corresponding to the calculated H₄(kⱼ′).

The member verification unit 139 performs the above member verification processing on all the session information Dⱼ obtained from the other encrypting apparatuses 100.

When the member verification unit 139 successfully verifies the member, the member verification unit 139 transmits the result representing the successful verification as well as the calculated kⱼ′ to the session key generation unit 141. When the member verification unit 139 fails to verify the member, the member verification unit 139 terminates the processing for generating session key.

The member verification unit 139 may associate various calculated values with, e.g., information representing a date/time when the calculation is performed, and store the calculated values, the information representing the date/time, together with history information and the like, to the storage unit 119 and the like.

The session key generation unit 141 is achieved with, for example, a CPU, a ROM, a RAM, and the like. When the member verification unit 139 successfully verifies the member participating in the simultaneous communication, the session key generation unit 141 generates session key K used for the simultaneous communication by using the plurality of values kⱼ′ transmitted from the member verification unit 139. The session key K is generated according to Expression 126 below. [Numerical expression 49]

K=Kᵢ=k₁′⊕k₂′⊕ . . . |kᵢ₋₁ ′αkᵢ⊕kᵢ₊₁′⊕ . . . |k_{n′} (Expression 126)

By using the session key K thus generated, the plurality of encrypting apparatuses 100 can securely perform the simultaneous communication.

The session key generation unit 141 may associate the generated session key K with, e.g., information representing a date/time when the session key K is generated, and store the generated session key K, the information representing the date/time, together with history information and the like, to the storage unit 119 and the like.

The communication control unit 117 is constituted by, for example, a CPU, a ROM, a RAM, a communication device, and the like. The communication control unit 117 controls communication between the encrypting apparatus 100 and the key generation apparatus 10 or the other encrypting apparatuses 100.

The storage unit 119 stores the published information published by the key generation apparatus 10, the individual keys including the public keys and the private keys obtained from the key generation apparatus 10, and the like. The storage unit 119 may store, e.g., various parameters or progress of processing that are needed to be stored while the encrypting apparatus 100 according to the present embodiment performs certain processing, and may store various kinds of databases and the like as necessary. The storage unit 119 may be freely read and written by the individual key obtaining unit 101, the group key generation unit 103, each processing unit included in the group key generation unit 103, and the communication control unit 117, and the like.

Examples of the functions of the encrypting apparatus 100 according to the present embodiment have been hereinabove explained. Each of the above constituent elements may be structured using a general-purpose member and a circuit, or may be structured by hardware dedicated to the function of each constituent element. Alternatively, the function of each constituent element may be carried out by a CPU and the like. Therefore, the used configuration may be changed as necessary in accordance with the state of the art at the time when the present embodiment is carried out.

It is possible to make a computer program for realizing the functions of the above-described encrypting apparatus according to the present embodiment, and the computer program can be implemented on a personal computer and the like.

Further, a computer-readable recording medium storing such computer program can be provided. Examples of the recording medium include a magnetic disk, an optical disk, a magneto-optical disk, and a flash memory. Further, the above computer program may be distributed by, for example, a network, without using the recording medium.

### <Key Generation Processing>

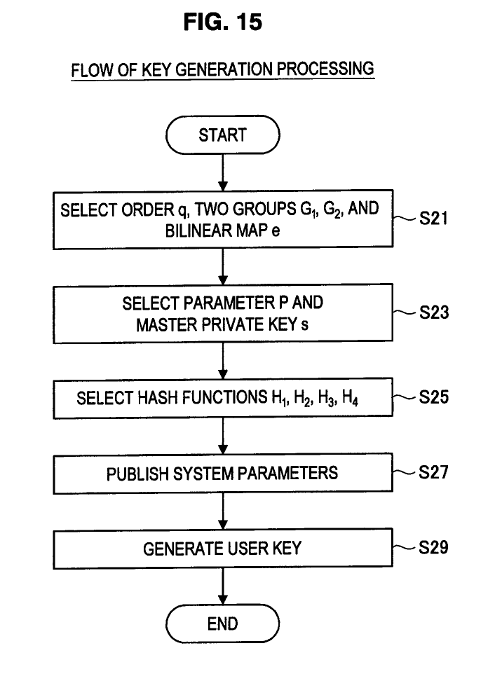

In the key sharing system 1 according to the present embodiment, the key generation apparatus 10 owned by the center generates various kinds of system parameters (i.e., published information) and an individual key (i.e., a user key including a public key, a private key, a signature generation key, and a signature verification key) for each member. Key generation processing performed by the key generation apparatus 10 according to the present embodiment will be hereinafter explained in detail with reference to FIG. 15.

First, the parameter selection unit 13 of the key processing apparatus 10 selects an order q, two groups G₁, G₂ of the order q, and a bilinear map e, according to a predetermined method (step S21).

Subsequently, the parameter selection unit 13 selects a parameter Pε_{R}G₁ and a parameter sε_{R}Z_{q}* (step S23), and uses these parameters to calculate P_{pub}=sP. This parameter P may also be called a random generator. On the other hand, the parameter s is secretly saved as a master private key.

Subsequently, the parameter selection unit 13 selects four kinds of hash functions, i.e., H₁, H₂, H₃, H₄ (step S25). These hash functions respectively have the features explained above.

Subsequently, the published information generation unit 15 publishes, as system parameters (published information), some of various setting values generated in the above step that are allowed to be published (step S27). For example, the published system parameters include <e, G₁, G₂, q, P, P_{pub}, H₁, H₂, H₃, H₄>.

Subsequently, when the member Uᵢ having an ID (IDᵢ) for identifying the user such as a user ID number and a mail address participates in this key sharing system 1, the key generation unit 17 generates a public key Qᵢ and a private key Sᵢ of the user Uᵢ according to the following method (step S29).

More specifically, first, the public key generation unit 19 generates the public key Qᵢ of the member Uᵢ by using the hash function H, i.e., system parameter, and the ID (IDᵢ) of the requesting member obtained from the member information management unit 11.

public key Qᵢ=H₁(IDᵢ)

Subsequently, the private key generation unit 21 generates the private key Sᵢ of the member Uᵢ by using the public key Qᵢ generated by the public key generation unit 19 and the master private key s.

private key Sᵢ=sQᵢ

Further, the signature key generation unit 22 generates the signature generation key skᵢ and the signature verification key vkᵢ unique to the member Uᵢ by using a method according to the used digital signature technique (step S29).

The key generation apparatus 10 transmits the generated individual key (i.e., the public key Qᵢ, the private key Sᵢ, the signature generation key skᵢ and the signature verification key vkᵢ) of the user Uᵢ to the corresponding member Uᵢ. Further, the key generation apparatus 10 may also publish the generated public key Qᵢ of the user Uᵢ.

When apparatuses try to execute simultaneous communication using the key sharing system according to the present embodiment, the apparatuses use the system parameters thus published and the public keys and the private keys of the members to generate and share a session key used for the simultaneous communication according to the following method.

### <Processing for Generating Session Key>

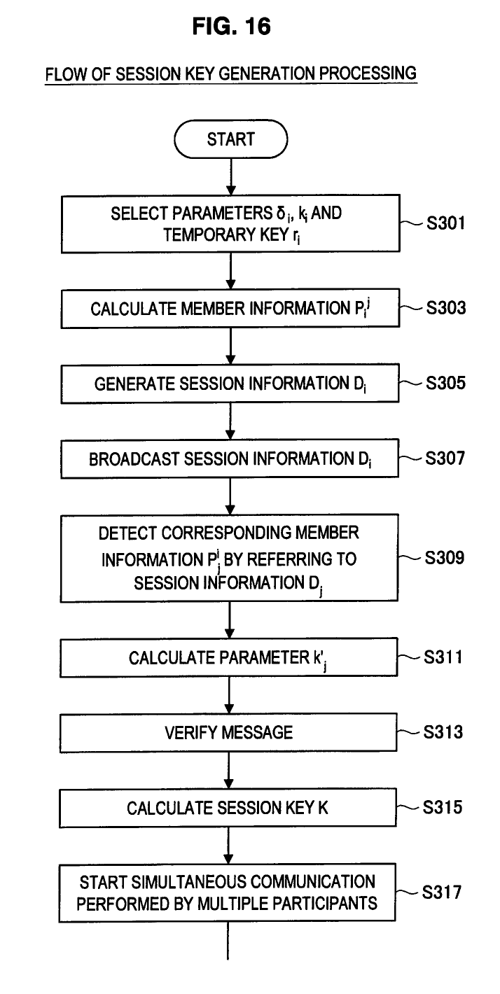

Subsequently, processing for generating session key used in a simultaneous communication performed between the plurality of encrypting apparatuses will be explained in detail with reference to FIG. 16. In the explanation below, it is assumed that totally n sets of encrypting apparatuses try to achieve a simultaneous communication therebetween.

First, the parameter selection unit 131 of the encrypting apparatus 100 owned by each member Uᵢ selects a parameter δᵢε_{R}G₂ and a parameter kᵢεE_{R}Z_{q}* (step S301). In this case, the parameter δᵢ is a parameter used for sharing the session key. On the other hand, the parameter selection unit 131 of the encrypting apparatus 100 owned by each member Uᵢ selects a parameter rᵢε_{R}{0, 1}^{t} (step S301). This parameter rᵢ is selected as a procedure for sharing the session key in the simultaneous communication.

Subsequently, the member information generation unit 133 of the encrypting apparatus 100 owned by each member Uᵢ generates member information Pᵢ^{j} for the members Uⱼ (1≦j≦n, j≠i) other than the member in question participating in the simultaneous communication (step S303). This member information Pᵢ^{j} is information for transmitting parameters used as temporary keys to the apparatuses participating in the simultaneous communication. This member information Pᵢ^{j} is a value represented by the Expression 121 below.

Subsequently, the session information generation unit 135 of the encrypting apparatus 100 owned by each member Uᵢ generates the session information Dᵢ represented by Expression 124 explained above by using the published system parameters and the selected parameters (step S305).

When the session information D₁ has been generated, the session information generation unit 135 of the encrypting apparatus 100 owned by each member Uᵢ broadcasts the generated session information Dᵢ to the encrypting apparatuses 100 via the communication control unit 117 (step S307).

First, when the session information obtaining unit 137 of the encrypting apparatus 100 owned by the member Uᵢ has received the session information Dⱼ (1≦j≦n, j≠i) from another encrypting apparatus 100, the session information obtaining unit 137 transmits the received session information Dⱼ to the member verification unit 139.

First, the member verification unit 139 refers to the information L included in the session information Dⱼ to detect the member information Pⱼⁱ corresponding to the encrypting apparatus 100 owned by the member Uᵢ (step S309).

Subsequently, the member verification unit 139 calculates a parameter kⱼ′ according to Expression 125 explained above by using the member information Pⱼⁱ corresponding to the information processing apparatus owned by the member Uᵢ, the session information Dⱼ, and the public key Qⱼ of the member Uⱼ, and the private key Sᵢ corresponding to the information processing apparatus owned by the member Uᵢ (step S311).

Subsequently, the member verification unit 139 calculates H₄(kⱼ′) using the calculated parameter kᵢ′ and the hash function H₄ serving as the published information. Thereafter, the member verification unit 139 uses the signature verification key vkⱼ of the member Uⱼ to determine whether Wⱼ included in the session information Dᵢ is a valid digital signature corresponding to the calculated H₄(kⱼ′) (step S313).

When the member verification unit 139 successfully verifies the message (i.e., successfully verifies the member), the member verification unit 139 transmits the result indicating the successful verification as well as the calculated kⱼ′ to the session key generation unit 141. When the member verification unit 139 fails to verify the message, the member verification unit 139 terminates the processing for generating session key.

When the member verification unit 139 successfully verifies the message, the session key generation unit 141 of each encrypting apparatus 100 generates the session key K used in the simultaneous communication by using the plurality of values kⱼ′ transmitted from the member verification unit 139 (step S315). The session key K is generated according to Expression 126 explained above.

Each of the encrypting apparatuses 100 calculates the session key K. Therefore, this means that the encrypting apparatuses 100 share the session key K used in the simultaneous communication, whereby the plurality of participants can start the simultaneous communication (step S317).

As described above, the method for generating the session key according to the present embodiment is configured such that, when each member transmits the message, the digital signature is attached to the random number kᵢ selected by the apparatus of the user for making effects on the session key. Therefore, this prevents the parameter kᵢ from being modified and given to a particular member.

By the way, in the above embodiment, the message H₄(kᵢ) is obtained by inputting the parameter kᵢ into the hash function, and the digital signature is attached to this message. There are two types of digital signature methods: a message recovery scheme and an authentication code attaching scheme. In a digital signature according to the authentication code attaching scheme, in order to support a message having any date length, the message is first input to a hash function to generate a signature, and a verification side likewise performs verification processing by using a result obtained by inputting the message into the hash function. As described above, in a digital signature system having a key sharing system including the hash function so that a message is input to the hash function, SIGᵢ(kᵢ) may be used instead of SIGᵢ(H₄(kᵢ) as an element of the session information Dᵢ.

### (Hardware Configuration)

Subsequently, a hardware configuration of the encrypting apparatus 100 according to each embodiment of the present invention will be explained in detail with reference to FIG. 17. FIG. 17 is a block diagram illustrating the hardware configuration of the encrypting apparatus 100 according to each embodiment of the present invention.

The encrypting apparatus 100 mainly includes a CPU 901, a ROM 903, a RAM 905, a host bus 907, a bridge 909, an external bus 911, an interface 913, an input device 915, an output device 917, a storage device 919, a drive 921, a connection port 923, and a communication device 925.

The CPU 901 functions as a calculation processing unit and a control device, so as to control overall operation or a portion thereof in the encrypting apparatus 100 according to various kinds of programs recorded in the ROM 903, the RAM 905, the storage device 919, or the removable recording medium 927. The ROM 903 stores programs used by the CPU 901 and calculation parameters and the like. The RAM 905 temporarily stores programs used during execution of the CPU 901 and parameters and the like which appropriately change during the execution. These are connected with each other by the host bus 907 constituted by an internal bus such as a CPU bus and the like.

The host bus 907 is connected to the external bus 911 such as a PCI (Peripheral Component Interconnect/Interface) bus via the bridge 909.

The input device 915 is operation means operated by a user, such as a mouse, a keyboard, a touch panel, buttons, a switch, and levers. Further, the input device 915 may be remote control means (a so-called remote controller) using infrared light and other radio waves, for example. Alternatively, the input device 915 may be an external connection device 929 such as a portable telephone and a PDA with which the encrypting apparatus 100 can be operated. Further, the input device 915 is constituted by an input control circuit for generating an input signal based on information given by a user with the above operation means and outputting the input signal to the CPU 901, for example. By operating this input device 915, the user of the encrypting apparatus 100 can input various kinds of data to the encrypting apparatus 100 and give instructions for processing operation to the encrypting apparatus 100.

The output device 917 is constituted by a display device such as a CRT display device, a liquid crystal display device, a plasma display device, an EL display device and lamps, an audio output device such as a speaker and a headphone, and a device for visually or auditorily presenting a user with obtained information such as a printer, a portable telephone, and a facsimile, for example. The output device 917 outputs results obtained as a result of performing various kinds of processing performed by the encrypting apparatus 100, for example. More specifically, the display device displays, as a text or an image, a result obtained from the various kinds of processing performed by the encrypting apparatus 100. On the other hand, the audio output device converts an audio signal containing reproduced audio data, acoustic data, and the like into an analog signal and outputs the analog signal.

The storage device 919 is a data storage device configured as an example of a storage unit for the encrypting apparatus 100. The storage device 919 may be constituted by a magnetic storage device such as a hard disk drive (HDD), a semiconductor storage device, an optical storage device, a magneto-optical storage device, or the like. The storage device 919 stores a program to be executed by the CPU 901, various kinds of data, or various kinds of data obtained from the outside, for example.

The drive 921 is a reader/writer for a recording medium, which is built in the encrypting apparatus 100 or attached externally. The drive 921 reads information that is recorded in the removable recording medium 927 such as a magnetic disk, an optical disk, a magneto-optical disk, and a semiconductor memory, which is attached thereto and outputs the information to the RAM 905. Further, the drive 921 can write information into the removable recording medium 927 such as a magnetic disk, an optical disk, a magneto-optical disk, and a semiconductor memory, which is attached thereto. The removable recording medium 927 may be a DVD medium, an HD-DVD medium, a Blu-ray medium, a compact flash (CF) (registered trademark), a memory stick, a secure digital (SD) memory card, and the like. Further, the removable recording medium 927 may be, for example, an integrated circuit (IC) card, an electronic device including a contactless IC chip, and the like.

The connection port 923 is a port for directly connecting equipment to the encrypting apparatus 100, such as a universal serial bus (USB) port, an IEEE 1394 port such as i.Link, a small computer system interface (SCSI) port, an RS-232C port, an optical audio terminal, and a high-definition multimedia interface (HDMI) port. By connecting the external connection device 929 to the connection port 923, the encrypting apparatus 100 can directly obtain various kinds of data from the external connection device 929 and supply various kinds of data to the external connection device 929.

The communication device 925 is a communication interface that is configured by a communication device and the like for establishing a connection with a communication network 931, for example. The communication device 925 may be a communication card for wired or wireless local area network (LAN), Bluetooth, wireless USB (WUSB), and the like, a router for optical communication, a router for asymmetric digital subscriber line (ADSL), and a modem for various kinds of communications, for example. The communication device 925 can transmit and receive a signal and the like to and from the Internet or another communication device in accordance with a prescribed protocol such as TCP/IP, for example. Further, the communication network 931 that is connected to the communication device 925 is constituted by a network and the like connected by wired or wireless means, and it may be the Internet, home LAN, infrared data communication, radio wave communication, satellite communication, and the like.

An example of hardware configuration capable of achieving functions of the encrypting apparatus 100 according to each embodiment of the present invention has been hereinabove explained. Each of the above constituent elements may be structured using a general-purpose member, or may be structured by hardware dedicated to the function of each constituent element. Therefore, the used hardware configuration may be changed as necessary in accordance with the state of the art at the time when the present embodiment is carried out.

The hardware configuration of the key generation apparatus 10 and the key processing apparatus 200 according to each embodiment of the present invention is the same as the configuration of the hardware configuration of the encrypting apparatus 100 according to each embodiment of the present invention. Therefore, the detailed description thereabout is omitted.

### (Summary)

As described above, in the key sharing system according to each embodiment of the present invention, the session information transmitted from each member includes the value dependent on the private key unique to a member, and when each apparatus verifies a member, the apparatus verifies the session information using the public key of the member. Therefore, the other members cannot generate session information that can pass the verification using the public key of Uᵢ, as in the methods described in the fundamental techniques. As a result, the key sharing system according to each embodiment of the present invention prevents attacks from the members, and improves the security.

Further, in the key sharing system according to the first embodiment of the present invention, a summation of Xⱼ, i.e., a portion of the session information, for all the session information Dᵢ (i=1, n) is obtained when the verification parameter z is calculated. Therefore, when the session key is calculated, the number of multiplications in groups, which produces a large calculation load, can be greatly reduced, and the calculation load needed for generating the session key can be suppressed.

In the Group Key Agreement technique, a technique for confirming whether all the members has successfully shared a key or not is known as a concept called

Key Confirmation. In a specific method for achieving this concept, it is required to confirm not only the correctness of a protocol for sharing a group key but also the correctness of the group key derived by each member. In this case, each member may transmit a value calculated based on a group key, and confirm whether the values of the other members are correct. In this method, however, it is necessary to transmit/receive one more message for confirming the group key, which cannot be achieved in one-round Group Key Agreement method. In contrast, in the second and third embodiments of the present invention, the session information includes the value dependent on the private key of a member. Therefore, in the second and third embodiments of the present invention, the Key Confirmation can be achieved even in the one-round Group Key Agreement method.

In relation to the Key Confirmation, there is a concept called completeness. In this concept, “only when all the participants contribute to generation of a group key, all the participants can calculate the same key.” In the past, however, there used to be no method for satisfying the completeness in a fixed number of rounds (in particular, one round). In contrast, the method according to the first embodiment of the present invention uses the above verification processing to confirm that all the members use the same parameter r. Further, since the group keys are all transmitted by broadcast, there is no possibility that a particular user receives a value different from a value received by the other users. Therefore, although this method is a method having a fixed number of rounds, this method satisfies the completeness.

In the Key Confirmation, although all the members can share the same group key, the above method does not confirm that each member actually shares the group key. Therefore, when “weakened Key Confirmation”, i.e., a concept indicating that “each member has obtained information from which the same group key is derived”, is considered, the above method satisfies this concept.

The preferred embodiments of the present invention have been described above with reference to the accompanying drawings, whilst the present invention is not limited to the above examples, of course. A person skilled in the art may find various alternations and modifications within the scope of the appended claims, and it should be understood that they will naturally come under the technical scope of the present invention.

In the second and third embodiments according to the present invention, for example, the digital signature is used as an example of a value calculated using the private key unique to a user. However, the embodiments according to the present invention are not limited to such example. It is possible to use not only the digital signature but also a very value calculated using a private key unique to a user, published parameters, and the like.

1. An encrypting apparatus comprising:
a parameter selection unit for selecting a parameter used for sharing a session key with another information processing apparatus with which a simultaneous communication, in which a message protected with the session key is exchanged, is performed after the session key is shared, wherein the parameter selection unit selects the parameter as a procedure for sharing the session key in the simultaneous communication;
a member information generation unit for generating member information for transmitting the parameter used as a temporary key by a participating apparatus, i.e., an information processing apparatus participating in the simultaneous communication, by using the parameter selected by the parameter selection unit, a published parameter published in advance, a private key assigned to the encrypting apparatus in advance, and a public key assigned to the participating apparatus in advance;
a session information generation unit for generating session information used for identifying the simultaneous communication and generating the session key for the simultaneous communication, by using the member information, the parameter selected by the parameter selection unit, the published parameter, and the private key;
a session information obtaining unit for respectively obtaining other session information generated by the participating apparatus from the participating apparatus; and
a session key generation unit for generating the session key by using the session information generated by the encrypting apparatus and the session information generated by the participating apparatus.

2. The encrypting apparatus according to claim 1, wherein the parameter selection unit selects a parameter δε_{R}Z_{q}*, a parameter k₁ε_{R}Z_{q}*, and a parameter r having a predetermined number of bits.

3. The encrypting apparatus according to claim 2, wherein the published parameter includes two groups G₁, G₂ of an order q which are different from each other, a bilinear map e for mapping a combination of elements in the group G₁ to the group G₂, a plurality of different hash functions, and two parameters P, P_{pub}, and
the member information generation unit respectively generates member information Pᵢ each corresponding to the participating apparatus according to Expression 1 below:
[Numerical expression 1]
Pᵢ=r⊕H_{A}(e(S₁,δQᵢ)) (Expression 1),
wherein, in Expression 1, H_{A} denotes one of the published hash functions, S₁ denotes the private key assigned to the encrypting apparatus, Qᵢ denotes a public key each assigned to the participating apparatus in advance, and i denotes an integer from 2 to n.

4. The encrypting apparatus according to claim 3, wherein the session information generation unit calculates a value X₁ represented by Expression 2 below and a value Y₁ represented by Expression 3, and generates session information D₁ represented by Expression 4 below:
[Numerical expression 2]
X₁=H_{B}(r∥L)·k₁P (Expression 2),
Y₁=k₁P_{pub}H_{B}(r∥L)·S₁ (Expression 3),
D₁= [symbol] δ,P₂, . . . Pₙ,X₁,Y₁,L [symbol] (Expression 4),
wherein, in Expression 2 and Expression 3, H_{B} denotes one of the published hash functions, and wherein, in Expression 4, P₂ to Pₙ denote the member information corresponding to each participating apparatus, and L denotes information about correspondence between the member information P₂ to Pₙ and the participating apparatuses.

5. The encrypting apparatus according to claim 4, further comprising:
a member verification unit for verifying validity of an apparatus participating in the simultaneous communication by using the session information generated by the encrypting apparatus and each of the session information Dᵢ (i=2, . . . , n), represented by Expression 5, obtained from the participating apparatus,
wherein the member verification unit calculates a verification parameter z represented by Expression 6 below, and verifies validity of the apparatus participating in the simultaneous communication based on whether Expression 7 below holds or not:
$$\begin{matrix}[ Numerical expression 3 ] & \\ \begin{matrix}{D}_{i} = 〈 {X}_{i} , {Y}_{i} 〉 \\ = 〈 {H}_{B} ( r \vert \vert L ) \cdot {k}_{i} P , {k}_{i} {P}_{pub} + {H}_{B} ( r \vert \vert L ) \cdot {S}_{i} 〉 ,\end{matrix} & ( E xpression 5 ) \\ z = {{H}_{B} ( r \vert \vert L )}^{- 1} \cdot {\sum }_{j = 1}^{n} {X}_{j} = {\sum }_{j = 1}^{n} {k}_{j} P , & ( E xpression 6 ) \\ e ( P , {\sum }_{j = 1}^{n} {Y}_{j} ) = e ( {P}_{pub} , z + {H}_{B} ( r \vert \vert L ) \cdot {\sum }_{j = 1}^{n} {Q}_{j} ) . & ( E xpression 7 )\end{matrix}$$

6. The encrypting apparatus according to claim 5, wherein when Expression 7 holds, the member verification unit determines that the participating apparatus is constituted by a valid apparatus, and accordingly, the session key generation unit calculates session key K based on Expression 8 below:
[Numerical expression 4]
K=H_{C}(z) (Expression 8),
wherein, in Expression 8, H_{C} denotes one of the published hash functions.

7. The encrypting apparatus according to claim 1, wherein the published parameter includes two groups G₁, G₂ of an order q which are different from each other, a bilinear map e for mapping a combination of elements in the group G₁ to the group G₂, a plurality of different hash functions, and two parameters P, P_{pub},
the parameter selection unit selects a parameter δᵢε_{R}Z_{q}* and a parameter kᵢε_{R}Z_{q}*, and a parameter rᵢ having a predetermined number of bits, and
the member information generation unit respectively generates the member information Pᵢ each corresponding to the participating apparatus according to Expression 9 below:
[Numerical expression 5]
Pᵢ^{j}=H₂(e(Sᵢ,Qⱼ)·δᵢ)⊕rᵢ (Expression 9)
wherein, in Expression 9, H₂ denotes one of the published hash functions, Sᵢ denotes the private key assigned to the encrypting apparatus, and Qⱼ denotes a public key each assigned to the participating apparatus in advance.

8. The encrypting apparatus according to claim 7, wherein the session information generation unit calculates a value Vᵢ represented by Expression 10 below and a value Wᵢ represented by Expression 11 below, and generates session information Dᵢ represented by Expression 12 below:
[Numerical expression 6]
Vᵢ=H₃(rᵢ)⊕kᵢ (Expression 10),
Wᵢ=SIGᵢ(H₄(kᵢ)) (Expression 11),
Dᵢ=|δᵢ,Pᵢ¹, . . . , Pᵢⁱ⁻¹,Pᵢⁱ⁺¹, . . . , Pᵢⁿ,Vᵢ,Wᵢ,L [symbol] (Expression 12),
wherein, each of H₃ in Expression 10 above and H₄ in Expression 11 above denotes one of the published hash functions, wherein in Expression 11 below, SIGᵢ(x) denotes a digital signature generated for information x using a predetermined signature generation key, and wherein in Expression 12 above, P₂ to Pₙ denote the member information corresponding to each participating apparatus, and L denotes information about correspondence between the member information and the participating apparatuses.

9. The encrypting apparatus according to claim 8 further comprising:
a member verification unit for verifying validity of an apparatus participating in the simultaneous communication by using the session information Dᵢ generated by the encrypting apparatus and each of the session information Dᵢ obtained from the participating apparatus, which are represented by Expression 12, wherein the member verification unit calculates a parameter kⱼ′(j=1, . . . , n, j≠i) represented by Expression 13 below, and verifies validity of the apparatus participating in the simultaneous communication based on the calculated parameter kⱼ′ and the session information Dᵢ:
[Numerical expression 7]
k′ⱼ=H₃(H₂(e(Qⱼ,Sᵢ)·δⱼ)⊕Pⱼⁱ)⊕Vⱼ (Expression 13).

10. The encrypting apparatus according to claim 9, wherein when the member verification unit successfully verifies the validity of the apparatus, the session key generation unit calculates session key K based on Expression 14 below:
[Numerical expression 8]
K=Kᵢ=k₁′⊕k₂′⊕ . . . ⊕kᵢ₋₁′|kᵢ|kᵢ₊₁′⊕ . . . ⊕kₙ′ (Expression 14).

11. The encrypting apparatus according to claim 1, wherein the published parameter includes an encryption function E for encrypting predetermined information, a decryption function D for decrypting encrypted information, a signature generation function S for attaching a digital signature to predetermined information, a signature verification function V for verifying the digital signature, and hash functions,
the parameter selection unit selects a parameter Nᵢ having a predetermined number of bits, and
the session information generation unit generates a message D having a digital signature represented by Expression 15 below and a cipher text E (eᵢ, N₁) (i=2, . . . , n):
[Numerical expression 9]
S(s₁,(E(e₂,N₁), . . . , E(eₙ,Nᵢ),h(N₁))) (Expression 15),
wherein in Expression 15 above, S(s, x) denotes a digital signature generated for information x using a predetermined signature generation key s, and E(e, x) denotes a cipher text obtained by encrypting the information x using the public key e.

12. The encrypting apparatus according to claim 11, wherein the session key generation unit calculates session key K_{U} based on Expression 16 below, by using a parameter N₁ having a predetermined number of bits obtained from another participating apparatus and a parameter N₁ selected by the parameter selection unit:
[Numerical expression 10]
K_{U}=h(N₁∥N₂∥ . . . ∥Nₙ) (Expression 16).

13. A key processing apparatus comprising:
a session information obtaining unit for obtaining session information transmitted from an encrypting apparatus for transmitting a parameter used as a temporary key by a participating apparatus participating in a simultaneous communication, wherein the session information is used for generating a session key for the simultaneous communication and identifying the simultaneous communication which is performed with the encrypting apparatus after the session key is shared and in which a message protected with the session key is exchanged, and wherein the session information obtaining unit also obtains session information transmitted from another participating apparatus participating in the simultaneous communication, which is different from the session information transmitted from the encrypting apparatus;
a temporary key calculation unit for calculating a temporary key by using the session information transmitted from the encrypting apparatus, a public key assigned to the encrypting apparatus in advance, and a private key assigned to the key processing apparatus in advance, and a published parameter published in advance, wherein the temporary key is set by the encrypting apparatus to be used in the simultaneous communication;
a parameter selection unit for selecting a parameter used for calculating the session information generated by the key processing apparatus to be transmitted to the encrypting apparatus;
a session information generation unit for generating the session information transmitted to the encrypting apparatus and the another participating apparatus, by using the parameter selected by the parameter selection unit, the published parameter, the private key, and the session information transmitted from the encrypting apparatus; and
a session key generation unit for generating the session key by using the session information generated by the key processing apparatus, the session information transmitted from the encrypting apparatus, and the session information transmitted from the another participating apparatus.

14. The key processing apparatus according to claim 13, wherein the published parameter includes two groups G₁, G₂ of an order q which are different from each other, a bilinear map e for mapping a combination of elements in the group G₁ to the group G₂, a plurality of different hash functions, and two parameters P, P_{pub},
the session key obtaining unit obtains the session information D₁ represented by Expression 17 below from the encrypting apparatus, and
the temporary key calculation unit calculates a temporary key r′ based on Expression 18 below, by using member information P, and a parameter δ corresponding to the encrypting apparatus included in the session information D₁ transmitted from the encrypting apparatus, the private key, and the public key assigned to the encrypting apparatus in advance, and the published parameter:
[Numerical expression 11]
D₁= [symbol] δ,P₂, . . . , Pₙ,H_{B}(r∥L)·k₁P,k₁P_{pub}+H_{B}(r∥L)·S₁,L) (Expression 17)
r′=H_{A}(e(Sᵢ,δQ₁)⊕Pᵢ=r (Expression 18),
wherein each of H_{B} in Expression 17 and H_{A} in Expression 10 denotes one of the published hash functions.

15. The key processing apparatus according to claim 14, wherein the session key generation unit generates the session information Dᵢ represented by Expression 19 below:
$$\begin{matrix}[ Numerical expression 12 ] & \\ \begin{matrix}{D}_{i} = 〈 {X}_{i} , {Y}_{i} 〉 \\ = 〈 {H}_{B} ( r \vert \vert L ) \cdot {k}_{i} P , {k}_{i} {P}_{pub} + {H}_{B} ( r \vert \vert L ) \cdot {S}_{i} 〉 ,\end{matrix} & ( E xpression 19 )\end{matrix}$$
wherein in Expression 19, kᵢ represents a parameter used for calculating the session information.

16. The key processing apparatus according to claim 15, wherein the session information obtaining unit obtains the session information represented by Expression 19 from the another participating apparatus participating in the simultaneous communication,
the key processing apparatus further includes a member verification unit for verifying validity of an apparatus participating in the simultaneous communication by using the session information generated by the key processing apparatus, the session information D₁ represented by Expression 17 obtained from the encrypting apparatus, and the session information obtained from the another participating apparatus, and
the member verification unit calculates a verification parameter z represented by Expression 20 below, and verifies validity of the apparatus participating in the simultaneous communication based on whether Expression 21 below holds or not:
$$\begin{matrix}[ Numerical expression 13 ] & \\ z = {{H}_{B} ( r \vert \vert L )}^{- 1} \cdot {\sum }_{j = 1}^{n} {X}_{j} = {\sum }_{j = 1}^{n} {k}_{j} P & ( E xpression 20 ) \\ e ( P , {\sum }_{j = 1}^{n} {Y}_{j} ) = e ( {P}_{pub} , z + {H}_{B} ( r \vert \vert L ) \cdot {\sum }_{j = 1}^{n} {Q}_{j} ) , & ( E xpression 21 )\end{matrix}$$
wherein in Expression 20 and Expression 21, a variable n represents a summation of the number of encrypting apparatuses, the number of key processing apparatuses, and the number of other participating apparatuses.

17. The key processing apparatus according to claim 16, wherein when Expression 21 holds, the member verification unit determines that the apparatus participating in the simultaneous communication is constituted by a valid apparatus, and accordingly, the session key generation unit calculates session key K based on Expression 22 below:
[Numerical expression 14]
K=H_{C}(z) (Expression 22),
wherein, in Expression 22, H_{C} denotes one of the published hash functions.

18. The key processing apparatus according to claim 13, wherein the published parameter includes an encryption function E for encrypting predetermined information, a decryption function D for decrypting encrypted information, a signature generation function S for attaching a digital signature to predetermined information, a signature verification function V for verifying the digital signature, and hash functions,
the key processing apparatus further includes a member verification unit for verifying validity of the encrypting apparatus by using the session information represented by Expression 23 below obtained from the encrypting apparatus and the temporary key calculated by the temporary key calculation unit,
the temporary key calculation unit uses the private key held in the key processing apparatus to decrypt a cipher text E (eᵢ, N₁) transmitted from the encrypting apparatus, and calculates a parameter N₁ as the temporary key, and
the member verification unit verifies the encrypting apparatus based on a verification result of the digital signature attached to the session information represented by Expression 23 below and h(N₁) calculated using the hash functions and the parameter N₁:
[Numerical expression 15]
S(s₁,(E(e₂,N₁), . . . , E(eₙ,N₁),h(N₁))) (Expression 23),
wherein in Expression 23, S(s, x) denotes a digital signature generated for information x using a predetermined signature generation key s, and E(e, x) denotes a cipher text obtained by encrypting the information x using the public key e.

19. The key processing apparatus according to claim 18, wherein when the member verification unit successfully verifies the validity of the apparatus, the parameter selection unit selects a parameter Nᵢ having a predetermined number of bits, and the session information generation unit adopts the parameter Nᵢ selected by the parameter selection unit as the session information, and transmits the session information to the encrypting apparatus and the another participating apparatus.

20. The key processing apparatus according to claim 19, wherein the session key generation unit calculates session key K_{U} based on Expression 24 below, by using the parameter N₁ calculated by the temporary key calculation unit, the parameter Nᵢ selected by the parameter selection unit, and the parameter Nᵢ obtained from the another participating apparatus:
[Numerical expression 16]
K_{U}=h(N₁∥N₂∥ . . . ∥Nₙ) (Expression 24).

21. An encrypting method comprising the steps of:
selecting a parameter used for sharing a session key with another information processing apparatus with which a simultaneous communication, in which a message protected with the session key is exchanged, is performed after the session key is shared, wherein the parameter is selected as a procedure for sharing the session key in the simultaneous communication;
generating member information for transmitting the parameter used as a temporary key by a participating apparatus, i.e., an information processing apparatus participating in the simultaneous communication, by using the parameter selected by the parameter selection unit, a published parameter published in advance, a private key assigned to an apparatus carrying out the encrypting method in advance, and a public key assigned to the participating apparatus in advance;
generating session information used for identifying the simultaneous communication and generating the session key for the simultaneous communication, by using the member information, the parameter selected by the parameter selection unit, the published parameter, and the private key;
obtaining other session information generated by the participating apparatus from the participating apparatus; and
generating the session key by using the session information generated by the apparatus carrying out the encrypting method and the session information generated by the participating apparatus.

22. A key processing method comprising the steps of:
obtaining session information transmitted from an encrypting apparatus for transmitting a parameter used as a temporary key by a participating apparatus participating in a simultaneous communication, wherein the session information is used for generating a session key for the simultaneous communication, and identifying the simultaneous communication, in which a message protected with the session key is exchanged, performed with the encrypting apparatus after the session key is shared;
calculating a temporary key by using the session information transmitted from the encrypting apparatus, a public key assigned to the encrypting apparatus in advance, and a private key assigned to an apparatus carrying out the key processing method in advance, and a published parameter published in advance, wherein the temporary key is set by the encrypting apparatus to be used in the simultaneous communication;
selecting a parameter used for calculating the session information generated by the apparatus carrying out the key processing method to be transmitted to the encrypting apparatus;
session information generation step for generating the session information transmitted to the encrypting apparatus and the another participating apparatus, by using the selected parameter, the published parameter, the private key, and the session information transmitted from the encrypting apparatus;
obtaining session information transmitted from another participating apparatus participating in the simultaneous communication, which is different from the session information transmitted from the encrypting apparatus; and
generating the session key by using the session information generated by the apparatus carrying out the key processing method, the session information transmitted from the encrypting apparatus, and the session information transmitted from the another participating apparatus.

23. A program for a computer capable of performing a simultaneous communication, in which a message protected with a session key is exchanged, with another information processing apparatus after the session key is shared, wherein the program causes the computer to achieve:
a parameter selection function for selecting a parameter used for sharing the session key, wherein parameter selection function selects the parameter as a procedure for sharing the session key in the simultaneous communication;
a member information generation function for generating member information for transmitting the parameter used as a temporary key by a participating apparatus, i.e., the information processing apparatus participating in the simultaneous communication, by using the parameter selected by the parameter selection unit, a published parameter published in advance, a private key assigned to the computer in advance, and a public key assigned to the participating apparatus in advance;
a session information generation function for generating session information used for identifying the simultaneous communication and generating the session key for the simultaneous communication, by using the member information, the parameter selected by the parameter selection unit, the published parameter, and the private key;
a session information obtaining function for respectively obtaining other session information generated by the participating apparatus from the participating apparatus; and
a session key generation function for generating the session key by using the session information generated by the program and the session information generated by the participating apparatus.

24. A program for a computer capable of performing a simultaneous communication, in which a message protected with a session key is exchanged, with an encrypting apparatus and another information processing apparatus after the session key is shared, wherein the program causes the computer to achieve:
a session information obtaining function for obtaining session information transmitted from an encrypting apparatus for transmitting the parameter used as a temporary key by a participating apparatus participating in a simultaneous communication, wherein the session information is used for generating a session key for the simultaneous communication and identifying the simultaneous communication which is performed with the encrypting apparatus, and wherein the session information obtaining unit also obtains session information transmitted from another participating apparatus participating in the simultaneous communication, which is different from the session information transmitted from the encrypting apparatus;
a temporary key calculation function for calculating a temporary key by using the session information transmitted from the encrypting apparatus, a public key assigned to the encrypting apparatus in advance, and a private key assigned in advance, and a published parameter published in advance, wherein the temporary key is set by the encrypting apparatus to be used in the simultaneous communication;
a parameter selection function for selecting a parameter used for calculating the session information generated by the computer to be transmitted to the encrypting apparatus;
a session information generation function for generating the session information transmitted to the encrypting apparatus and the another participating apparatus, by using the selected parameter, the published parameter, the private key, and the session information transmitted from the encrypting apparatus; and
a session key generation function for generating the session key by using the session information generated by the computer, the session information transmitted from the encrypting apparatus, and the session information transmitted from the another participating apparatus.

25. A key sharing system comprising:
an encrypting apparatus including:
a parameter selection unit for selecting a parameter used for sharing a session key with another information processing apparatus with which a simultaneous communication, in which a message protected with the session key is exchanged, is performed after the session key is shared, wherein parameter selection unit selects the parameter as a procedure for sharing the session key in the simultaneous communication;
a member information generation unit for generating member information for transmitting the parameter used as a temporary key by a participating apparatus, i.e., an information processing apparatus participating in the simultaneous communication, by using the parameter selected by the parameter selection unit, a published parameter published in advance, a private key assigned to the encrypting apparatus in advance, and a public key assigned to the participating apparatus in advance;
a session information generation unit for generating session information used for identifying the simultaneous communication and generating the session key for the simultaneous communication, by using the member information, the parameter selected by the parameter selection unit, the published parameter, and the private key;
a session information obtaining unit for respectively obtaining other session information generated by the participating apparatus from the participating apparatus; and
a session key generation unit for generating the session key by using the session information generated by the encrypting apparatus and the session information generated by the participating apparatus, and
a key processing apparatus including:
a session information obtaining unit for obtaining session information transmitted from the encrypting apparatus and also obtaining session information transmitted from another participating apparatus participating in the simultaneous communication, which is different from the session information transmitted from the encrypting apparatus;
a temporary key calculation unit for calculating a temporary key by using the session information transmitted from the encrypting apparatus, a public key assigned to the encrypting apparatus in advance, and a private key assigned to the key processing apparatus in advance, and a published parameter published in advance, wherein the temporary key is set by the encrypting apparatus to be used in the simultaneous communication;
a parameter selection unit for selecting a parameter used for calculating the session information generated by the key processing apparatus to be transmitted to the encrypting apparatus;
a session information generation unit for generating the session information transmitted to the encrypting apparatus and the another participating apparatus, by using the parameter selected by the parameter selection unit, the published parameter, the private key, and the session information transmitted from the encrypting apparatus; and
a session key generation unit for generating the session key by using the session information generated by the key processing apparatus, the session information transmitted from the encrypting apparatus, and the session information transmitted from the another participating apparatus.
